(19) United States
(12) Patent Application Publication
(10) Pub. No.: US 2026/0358601 A1
(43) Pub. Date: Nov. 12, 2026

(54) OPTICAL PHOTOGRAPHING SYSTEM, IMAGE CAPTURING UNIT AND ELECTRONIC DEVICE

(71) Applicant: LARGAN PRECISION CO., LTD., Taichung City (TW)

(72) Inventors: Huan You LIN, Taichung City (TW); Kuo-Jui WANG, Taichung City (TW)

(73) Assignee: LARGAN PRECISION CO., LTD., Taichung City (TW)

(21) Appl. No.: 19/353,782

(22) Filed: Oct. 9, 2025

(30) Foreign Application Priority Data
May 12, 2025 (TW) 114117748

(51) Int. Cl. G02B 13/00; G02B 9/62

(52) U.S. Cl. CPC G02B 13/0045; G02B 9/62

(57) ABSTRACT

An optical photographing system includes six lens elements which are, in order from an object side to an image side along an optical path: a first lens element, a second lens element, a third lens element, a fourth lens element, a fifth lens element and a sixth lens element. The first lens element has negative refractive power. The second lens element has positive refractive power. The third lens element has positive refractive power. The fourth lens element has negative refractive power. At least one of an object-side surface and an image-side surface of the fourth lens element has at least one inflection point. The sixth lens element has an object-side surface being convex in a paraxial region thereof and having at least one inflection point and an image-side surface being concave in a paraxial region thereof and having at least one critical point in an off-axis region thereof.

### RELATED APPLICATIONS

This application claims priority to Taiwan Application 114117748, filed on May 12, 2025, which is incorporated by reference herein in its entirety.

### BACKGROUND

### Technical Field

The present disclosure relates to an optical photographing system, an image capturing unit and an electronic device, more particularly to an optical photographing system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an optical photographing system includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has negative refractive power. Preferably, the second lens element has positive refractive power. Preferably, the third lens element has positive refractive power. Preferably, the fourth lens element has negative refractive power. Preferably, the object-side surface of the sixth lens element is convex in a paraxial region thereof. Preferably, the image-side surface of the sixth lens element is concave in a paraxial region thereof. Preferably, at least one of the object-side surface and the image-side surface of the fourth lens element has at least one inflection point. Preferably, the object-side surface of the sixth lens element has at least one inflection point. Preferably, the image-side surface of the sixth lens element has at least one critical point in an off-axis region thereof.

When a central thickness of the first lens element is CT1, a central thickness of the second lens element is CT2, a central thickness of the third lens element is CT3, a central thickness of the fourth lens element is CT4, a central thickness of the fifth lens element is CT5, an axial distance between the fourth lens element and the fifth lens element is T45, an axial distance between the fifth lens element and the sixth lens element is T56, a focal length of the optical photographing system is f, half of a maximum field of view of the optical photographing system is HFOV, and a composite focal length of the second lens element and the third lens element is f23, the following conditions are preferably satisfied:

1.20<(CT1+CT2)/(CT3+CT4)<2.00;

0.10<CT5/(T45+T56)<0.45; and

0.50<f×tan(HFOV)/f23<2.50.

According to another aspect of the present disclosure, an optical photographing system includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has negative refractive power. Preferably, the second lens element has positive refractive power. Preferably, the third lens element has positive refractive power. Preferably, the fourth lens element has negative refractive power. Preferably, the object-side surface of the sixth lens element is convex in a paraxial region thereof. Preferably, the image-side surface of the sixth lens element is concave in a paraxial region thereof. Preferably, at least one of the object-side surface and the image-side surface of the fourth lens element has at least one inflection point. Preferably, the object-side surface of the sixth lens element has at least one inflection point. Preferably, the image-side surface of the sixth lens element has at least one critical point in an off-axis region thereof.

When a central thickness of the first lens element is CT1, a central thickness of the second lens element is CT2, a central thickness of the third lens element is

CT3, a central thickness of the fourth lens element is CT4, a central thickness of the fifth lens element is CT5, a central thickness of the sixth lens element is CT6, an axial distance between the fourth lens element and the fifth lens element is T45, an axial distance between the fifth lens element and the sixth lens element is T56, a focal length of the optical photographing system is f, half of a maximum field of view of the optical photographing system is HFOV, a composite focal length of the second lens element and the third lens element is f23, an Abbe number of the second lens element is V2, and an Abbe number of the third lens element is V3, the following conditions are preferably satisfied:

1.20<(CT1+CT2)/(CT3+CT4)<2.00;

0.50<(CT4+CT5+CT6)/(T45+T56)<1.95;

0.80<f×tan(HFOV)/f23<2.50; and

100.0<V2+V3<165.0.

According to another aspect of the present disclosure, an optical photographing system includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has negative refractive power. Preferably, the second lens element has positive refractive power. Preferably, the third lens element has positive refractive power. Preferably, the fourth lens element has negative refractive power. Preferably, the image-side surface of the fourth lens element is concave in a paraxial region thereof. Preferably, the object-side surface of the sixth lens element is convex in a paraxial region thereof. Preferably, the image-side surface of the sixth lens element is concave in a paraxial region thereof. Preferably, at least one of the object-side surface and the image-side surface of the fourth lens element has at least one inflection point. Preferably, the object-side surface of the sixth lens element has at least one inflection point. Preferably, the image-side surface of the sixth lens element has at least one critical point in an off-axis region thereof.

When a central thickness of the first lens element is CT1, a central thickness of the second lens element is CT2, a central thickness of the third lens element is CT3, a central thickness of the fourth lens element is CT4, a central thickness of the fifth lens element is CT5, a central thickness of the sixth lens element is CT6, an axial distance between the fourth lens element and the fifth lens element is T45, an axial distance between the fifth lens element and the sixth lens element is T56, an focal length of the optical photographing system is f, a focal length of the second lens element is f2, a focal length of the third lens element is f3, and a sum of axial distances between each of all adjacent lens elements of the optical photographing system is EAT, the following conditions are preferably satisfied:

1.05<(CT1+CT2)/(CT3+CT4)<2.00;

0.63<(CT5+CT6)/(T45+T56)<1.80;

0.10<f2/f3<2.30; and

0.45<ΣAT/f<1.05.

According to another aspect of the present disclosure, an image capturing unit includes one of the aforementioned optical photographing systems and an image sensor, wherein the image sensor is disposed on an image surface of the optical photographing system.

According to another aspect of the present disclosure, an electronic device includes an image capturing unit, wherein the image capturing unit includes one of the aforementioned optical photographing systems and an image sensor, and the image sensor is disposed on an image surface of the optical photographing system.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves and a distortion curve of the image capturing unit according to the 10th embodiment;

FIG. 21 is a schematic view of an image capturing unit according to the 11th embodiment of the present disclosure;

FIG. 22 shows spherical aberration curves, astigmatic field curves and a distortion curve of the image capturing unit according to the 11th embodiment;

FIG. 23 is a schematic view of an image capturing unit according to the 12th embodiment of the present disclosure;

FIG. 24 shows spherical aberration curves, astigmatic field curves and a distortion curve of the image capturing unit according to the 12th embodiment;

FIG. 25 is a schematic view of an image capturing unit according to the 13th embodiment of the present disclosure;

FIG. 26 shows spherical aberration curves, astigmatic field curves and a distortion curve of the image capturing unit according to the 13th embodiment;

FIG. 27 is a perspective view of an image capturing unit according to the 14th embodiment of the present disclosure;

FIG. 28 is a perspective view of an electronic device according to the 15th embodiment of the present disclosure;

FIG. 29 is another perspective view of the electronic device in FIG. 28;

FIG. 30 is a perspective view of an electronic device according to the 16th embodiment of the present disclosure;

FIG. 31 is another perspective view of the electronic device in FIG. 30;

FIG. 32 is a block diagram of the electronic device in FIG. 30;

FIG. 33 is a perspective view of an electronic device according to the 17th embodiment of the present disclosure;

FIG. 34 is a perspective view of an electronic device according to the 18th embodiment of the present disclosure;

FIG. 35 is a perspective view of an electronic device according to the 19th embodiment of the present disclosure;

FIG. 36 is another perspective view of the electronic device in FIG. 35;

FIG. 37 is a schematic view of an electronic device according to the 20th embodiment of the present disclosure;

FIG. 38 is a perspective view of an electronic device according to the 21st embodiment of the present disclosure;

FIG. 39 is a side view of the electronic device in FIG. 38;

FIG. 40 is a top view of the electronic device in FIG. 38;

FIG. 41 is a partial view of an inner side of a vehicle device according to the 22nd embodiment of the present disclosure;

FIG. 42 is a schematic view showing the image captured by the image capturing unit of the vehicle device in FIG. 41 when processing its detection function;

FIG. 43 is a partial view of an inner side of a vehicle device according to the 23rd embodiment of the present disclosure;

FIG. 44 is a schematic view showing the image captured by the image capturing unit of the vehicle device in FIG. 43 when processing its detection function;

FIG. 45 is a schematic view of an electronic device according to the 24th embodiment of the present disclosure;

FIG. 46 is a schematic view of an electronic device according to the 25th embodiment of the present disclosure;

FIG. 47 shows a schematic view of inflection points on lens surfaces and critical points on lens surfaces according to the 1st embodiment of the present disclosure;

FIG. 48 shows a schematic view of a configuration of a light-folding element in an optical photographing system according to one embodiment of the present disclosure;

FIG. 49 shows a schematic view of another configuration of a light-folding element in an optical photographing system according to one embodiment of the present disclosure; and

FIG. 50 shows a schematic view of a configuration of two light-folding elements in an optical photographing system according to one embodiment of the present disclosure.

### DETAILED DESCRIPTION

An optical photographing system includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

The first lens element has negative refractive power. Therefore, it is favorable for increasing the viewing angle, thereby collaborating with the second lens element to correct chromatic aberration. The object-side surface of the first lens element is convex in a paraxial region thereof. Therefore, it is favorable for arranging the first lens element as a glass spherical lens element to reduce the impact of environmental conditions on the quality of the optical photographing system. The object-side surface of the first lens element is concave in the paraxial region thereof. Therefore, it is favorable for arranging the first lens element as an aspheric lens element to improve image quality and correct aberrations. The image-side surface of the first lens element is convex in a paraxial region thereof. Therefore, it is favorable for balancing the refractive power of the first lens element to correct aberrations. The image-side surface of the first lens element is concave in the paraxial region thereof. Therefore, it is favorable for reducing ghosting or flare generated between the image-side surface of the first lens element and object-side surface of the second lens element.

The second lens element has positive refractive power. Therefore, it is favorable for assisting in light convergence and collaborating with the first lens element to correct chromatic aberration. The object-side surface of the second lens element is convex in a paraxial region thereof. Therefore, it is favorable for increasing the refractive power of the second lens element, thereby enhancing convergence ability. The object-side surface of the second lens element is concave in the paraxial region thereof. Therefore, it is favorable for controlling the incident angle of peripheral optical path entering the second lens element to prevent total reflection caused by excessively large incident angles. The image-side surface of the second lens element is convex in a paraxial region thereof. Therefore, it is favorable for collaborating with the object-side surface of the third lens element to balance the refractive powers on both sides of the aperture stop, thereby improving image quality. The image-side surface of the second lens element is concave in the paraxial region thereof. Therefore, it is favorable for collaborating with the object-side surface of the third lens element to balance the refractive powers on both sides of the aperture stop, thereby enlarging the aperture.

The third lens element has positive refractive power. Therefore, it is favorable for reducing the overall size, thereby collaborating with the fourth lens element to correct chromatic aberration. The object-side surface of the third lens element is convex in a paraxial region thereof. Therefore, it is favorable for collaborating with the image-side surface of the second lens element to balance the refractive powers on both sides of the aperture stop, thereby improving image quality. The object-side surface of the third lens element is concave in the paraxial region thereof. Therefore, it is favorable for collaborating with the image-side surface of the second lens element to balance the refractive powers on both sides of the aperture stop, thereby correcting aberrations. The image-side surface of the third lens element is convex in a paraxial region thereof. Therefore, it is favorable for increasing the refractive power of the third lens element, thereby correcting chromatic aberration. The image-side surface of the third lens element is concave in the paraxial region thereof. Therefore, it is favorable for balancing the refractive power of the third lens element, thereby reducing ghosting or flare.

The fourth lens element has negative refractive power. Therefore, it is favorable for correcting aberration and collaborating with the third lens element to correct chromatic aberration. The object-side surface of the fourth lens element is convex in a paraxial region thereof. Therefore, it is favorable for correcting axial chromatic aberration. The object-side surface of the fourth lens element is concave in the paraxial region thereof. Therefore, it is favorable for correcting distortion. The image-side surface of the fourth lens element is convex in a paraxial region thereof. Therefore, it is favorable for correcting axial chromatic aberration and distortion. The image-side surface of the fourth lens element is concave in the paraxial region thereof. Therefore, it is favorable for correcting aberration and chromatic aberration.

The fifth lens element has positive refractive power. Therefore, it is favorable for balancing the refractive power of the optical photographing system, thereby correcting aberrations. The fifth lens element also has negative refractive power. Therefore, it is favorable for balancing the refractive power of the optical photographing system, thereby correcting chromatic aberration. The object-side surface of the fifth lens element is convex in a paraxial region thereof. Therefore, it is favorable for collaborating with critical points on the same surface to reduce the overall size. The object-side surface of the fifth lens element is concave in the paraxial region thereof. Therefore, it is favorable for increasing illuminance. The image-side surface of the fifth lens element is convex in a paraxial region thereof. Therefore, it is favorable for reducing ghosting or flare generated between the image-side surface of the fifth lens element and object-side surface of the sixth lens element. The image-side surface of the fifth lens element is concave in the paraxial region thereof. Therefore, it is favorable for collaborating with critical points on the same surface to reduce the overall size and correcting aberrations.

The sixth lens element has positive refractive power. Therefore, it is favorable for balancing the refractive power of the optical photographing system, thereby reducing astigmatism. The sixth lens element also has negative refractive power. Therefore, it is favorable for balancing the refractive power of the optical photographing system, thereby increasing illuminance. The object-side surface of the sixth lens element is convex in a paraxial region thereof. Therefore, it is favorable for correcting aberrations such as spherical aberration. The image-side surface of the sixth lens element is concave in a paraxial region thereof. Therefore, it is favorable for reducing the overall size and controlling illuminance.

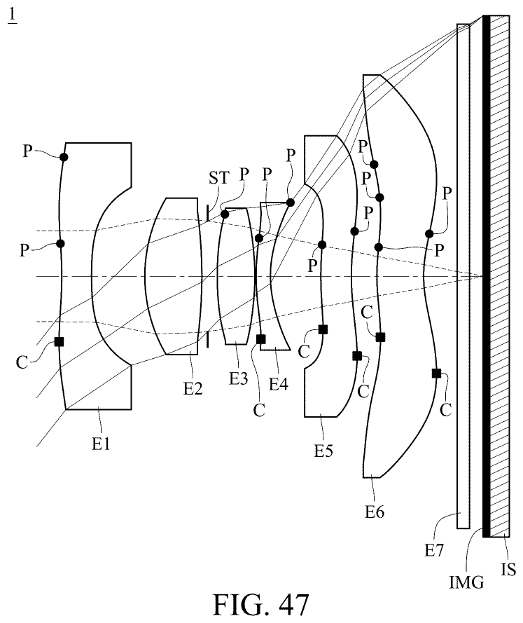

According to the present disclosure, at least one of the object-side surface and the image-side surface of the fourth lens element can have at least one inflection point. Therefore, it is favorable for controlling the optical path from the first lens element through the fourth lens element and correcting distortion. Moreover, the object-side surface of the sixth lens element can have at least one inflection point. Therefore, it is favorable for correcting aberrations at the image periphery. Please refer to FIG. 47, which shows a schematic view of inflection points P on the object-side surface of the fourth lens element E4, the image-side surface of the fourth lens element E4 and the object-side surface of the sixth lens element E6 according to the 1st embodiment of the present disclosure. The abovementioned inflection points P on the object-side surface of the fourth lens element E4, the image-side surface of the fourth lens element E4 and the object-side surface of the sixth lens element E6, as well as inflection points P on the object-side surface of the first lens element E1, the object-side surface of the third lens element E3, the object-side surface of the fifth lens element E5, the image-side surface of the fifth lens element E5 and the image-side surface of the sixth lens element E6 in FIG. 47 are exemplary. Each of lens surfaces in various embodiments of the present disclosure may also have one or more inflection points.

According to the present disclosure, the image-side surface of the sixth lens element can have at least one critical point in an off-axis region thereof. Therefore, it is favorable for collaborating with inflection points on the same surface, thereby enhancing the correction of aberrations at the image periphery while further reducing the overall size. Please refer to FIG. 47, which shows a schematic view of a critical point C on the image-side surface of the sixth lens element E6 according to the 1st embodiment of the present disclosure. The abovementioned critical point C on the image-side surface of the sixth lens element E6, as well as critical points C on the object-side surface of the first lens element E1, the object-side surface of the fourth lens element E4, the object-side surface of the fifth lens element E5, the image-side surface of the fifth lens element E5 and the object-side surface of the sixth lens element E6 in FIG. 47 are exemplary. Each of lens surfaces in various embodiments of the present disclosure may also have one or more critical points in an off-axis region thereof.

An axial distance between the first lens element and the second lens element can be greater than a central thickness of the second lens element. Therefore, it is favorable for controlling the composite focal length of the first lens element and the second lens element.

An axial distance between the fifth lens element and the sixth lens element can be greater than a central thickness of the fifth lens element. Therefore, it is favorable for reducing ghosting or flare.

The refractive power of the fifth lens element has a different sign from the refractive power of the sixth lens element. Therefore, it is favorable for achieving miniaturization of the optical photographing system and reducing the distance between the fifth lens element and an image surface. The refractive power of the fifth lens element has a same sign as the refractive power of the sixth lens element. Therefore, it is favorable for correcting aberrations such as astigmatism.

At least one of the first lens element, the second lens element and the third lens element can be made of glass. Therefore, it is favorable for increasing the environmental tolerance of the optical photographing system.

According to the present disclosure, the optical photographing system can further include an aperture stop and the aperture stop can be disposed between the second lens element and the third lens element. Therefore, it is favorable for balancing the light incident amount and the size of the optical photographing system.

When a central thickness of the first lens element is CT1, the central thickness of the second lens element is CT2, a central thickness of the third lens element is CT3, and a central thickness of the fourth lens element is CT4, the following condition can be satisfied: 1.05<(CT1+CT2)/(CT3+CT4)<2.00. Therefore, it is favorable for controlling the central thicknesses of the first lens element through the fourth lens element, thereby improving image quality. Moreover, the following condition can also be satisfied: 1.05<(CT1+CT2)/(CT3+CT4)<1.95. Moreover, the following condition can also be satisfied: 1.10<(CT1+CT2)/(CT3+CT4)<1.90. Moreover, the following condition can also be satisfied: 1.13≤(CT1+CT2)/(CT3+CT4)≤1.89. Moreover, the following condition can also be satisfied: 1.20<(CT1+CT2)/(CT3+CT4)<2.00. Moreover, the following condition can also be satisfied: 1.25< (CT1+CT2)/(CT3+CT4)<1.90. Moreover, the following condition can also be satisfied: 1.25<(CT1+CT2)/(CT3+CT4)<1.70. Moreover, the following condition can also be satisfied: 1.30<(CT1+CT2)/(CT3+CT4)<1.80.

When the central thickness of the fifth lens element is CT5, an axial distance between the fourth lens element and the fifth lens element is T45, and the axial distance between the fifth lens element and the sixth lens element is T56, the following condition can be satisfied: 0.10<CT5/(T45+T56)<0.45. Therefore, it is favorable for correcting aberrations and controlling the overall size. Moreover, the following condition can also be satisfied: 0.20<CT5/(T45+T56)<0.45. Moreover, the following condition can also be satisfied: 0.24≤CT5/(T45+T56)≤0.82.

When a focal length of the optical photographing system is f, half of a maximum field of view of the optical photographing system is HFOV, and a composite focal length of the second lens element and the third lens element is f23, the following condition can be satisfied: 0.50<f×tan(HFOV)/f23<2.50. Therefore, it is favorable for controlling the field of view and balancing the composite focal length of the second lens element and the third lens element, thereby improving image quality. Moreover, the following condition can also be satisfied: 0.70<f×tan(HFOV)/f23<2.40. Moreover, the following condition can also be satisfied: 0.80<f×tan(HFOV)/f23<2.50. Moreover, the following condition can also be satisfied: 1.00<f×tan(HFOV)/f23<2.30. Moreover, the following condition can also be satisfied: 1.29≤f×tan(HFOV)/f23≤2.13.

When the central thickness of the fourth lens element is CT4, the central thickness of the fifth lens element is CT5, a central thickness of the sixth lens element is CT6, the axial distance between the fourth lens element and the fifth lens element is T45, and the axial distance between the fifth lens element and the sixth lens element is T56, the following condition can be satisfied: 0.50< (CT4+CT5+CT6)/(T45+T56)<1.95. Therefore, it is favorable for correcting aberrations and controlling the overall size. Moreover, the following condition can also be satisfied: 0.60<(CT4+CT5+CT6)/(T45+T56)<1.92. Moreover, the following condition can also be satisfied: 0.70<(CT4+CT5+CT6)/(T45+T56)<1.70. Moreover, the following condition can also be satisfied: 0.77≤(CT4+CT5+CT6)/(T45+T56)≤1.89.

When an Abbe number of the second lens element is V2, and an Abbe number of the third lens element is V3, the following condition can be satisfied: 100.0<V2+V3<165.0. Therefore, it is favorable for controlling the degree of chromatic dispersion of light within the second lens element and the third lens element, thereby collaborating with the first lens element or the fourth lens element to correct chromatic aberration. Moreover, the following condition can also be satisfied: 110.0<V2+V3<165.0. Moreover, the following condition can also be satisfied: 110.0<V2+V3<130.0. Moreover, the following condition can also be satisfied: 112.0≤V2+V3≤163.1.

When the central thickness of the fifth lens element is CT5, the central thickness of the sixth lens element is CT6, the axial distance between the fourth lens element and the fifth lens element is T45, and the axial distance between the fifth lens element and the sixth lens element is T56, the following condition can be satisfied: 0.63<(CT5+CT6)/(T45+T56)<1.80. Therefore, it is favorable for correcting aberration and controlling the overall size. Moreover, the following condition can also be satisfied: 0.60<(CT5+CT6)/(T45+T56)<1.50. Moreover, the following condition can also be satisfied: 0.64≤(CT5+CT6)/(T45+T56)≤1.66. Moreover, the following condition can also be satisfied: 0.65<(CT5+CT6)/(T45+T56)<1.70.

When a focal length of the second lens element is f2, and a focal length of the third lens element is f3, the following condition can be satisfied: 0.10<f2/f3<2.30. Therefore, it is favorable for balancing the refractive powers of the second lens element and the third lens element, thereby correcting aberrations. Moreover, the following condition can also be satisfied: 0.10<f2/f3<2.00. Moreover, the following condition can also be satisfied: 0.15<f2/f3<1.80. Moreover, the following condition can also be satisfied: 0.19≤f2/f3≤1.68. Moreover, the following condition can also be satisfied: 0.50<f2/f3<1.30.

When a sum of axial distances between each of all adjacent lens elements of the optical photographing system is EAT, and the focal length of the optical photographing system is f, the following condition can be satisfied: 0.45<ΣAT/f<1.05. Therefore, it is favorable for balancing the lens spacing within the optical photographing system so as to increase illuminance. Moreover, the following condition can also be satisfied: 0.50<ΣAT/f<1.00. Moreover, the following condition can also be satisfied: 0.51≤ΣAT/f≤0.95.

When the composite focal length of the second lens element and the third lens element is f23, and a composite focal length of the fifth lens element and the sixth lens element is f56, the following condition can be satisfied: −0.35<f23/f56<0.35. Therefore, it is favorable for obtaining a proper balance between image quality and miniaturization. Moreover, the following condition can also be satisfied: −0.30<f23/f56<0.30.

When the focal length of the optical photographing system is f, half of the maximum field of view of the optical photographing system is HFOV, and a maximum image height of the optical photographing system (which can be half of a diagonal length of an effective photosensitive area of the image sensor) is ImgH, the following condition can be satisfied: 0.50<f×sin(HFOV)/ImgH<0.75. Therefore, it is favorable for maintaining illuminance while meeting the viewing angle requirement of the application device. Moreover, the following condition can also be satisfied: 0.55<f×sin(HFOV)/ImgH<0.70.

When the focal length of the optical photographing system is f, and the composite focal length of the second lens element and the third lens element is f23, the following condition can be satisfied: 1.20<f/f23<1.90. Therefore, it is favorable for improving image quality, thereby correcting aberration. Moreover, the following condition can also be satisfied: 1.20<f/f23<1.80. Moreover, the following condition can also be satisfied: 1.30<f/f23<1.80. Moreover, the following condition can also be satisfied: 1.30<f/f23<1.70.

When the focal length of the optical photographing system is f, and the composite focal length of the fifth lens element and the sixth lens element is f56, the following condition can be satisfied: |f/f56|<0.80. Therefore, it is favorable for controlling the overall size and the back focal length. Moreover, the following condition can also be satisfied: |f/f56|<0.75.

When an axial distance between the object-side surface of the third lens element and the image-side surface of the fourth lens element is Dr5r8, and the focal length of the third lens element is f3, the following condition can be satisfied: 0.01<Dr5r8/f3<0.40. Therefore, it is favorable for reducing astigmatism, thereby improving image quality. Moreover, the following condition can also be satisfied: 0.05<Dr5r8/f3<0.35.

When half of the maximum field of view of the optical photographing system is HFOV, the following condition can be satisfied: 42.5 degrees<HFOV<57.5 degrees. Therefore, it is favorable for having a proper imaging range of the optical photographing system so as to meet the viewing angle requirement of the application device. Moreover, the following condition can also be satisfied: 45.0 degrees<HFOV<57.0 degrees.

When the focal length of the optical photographing system is f, and the maximum image height of the optical photographing system is ImgH, the following condition can be satisfied: 0.70<f/ImgH<1.00. Therefore, it is favorable for balancing the viewing angle and illuminance. Moreover, the following condition can also be satisfied: 0.75<f/ImgH<0.98.

When an axial distance between the object-side surface of the first lens element and the image surface is TL, and the maximum image height of the optical photographing system is ImgH, the following condition can be satisfied: 1.30<TL/ImgH<2.20. Therefore, it is favorable for controlling the ratio of the total track length of the optical photographing system to the image height within a proper range, such that sufficient brightness of the image can be maintained while meeting the miniaturization requirement of the optical photographing system. Moreover, the following condition can also be satisfied: 1.35<TL/ImgH<2.00.

When the axial distance between the object-side surface of the first lens element and the image surface is TL, the focal length of the optical photographing system is f, the following condition can be satisfied: 1.20<TL/f<2.30. Therefore, it is favorable for obtaining a proper balance between the total track length and the viewing angle of the optical photographing system. Moreover, the following condition can also be satisfied: 1.40<TL/f<2.20.

When the focal length of the second lens element is f2, the central thickness of the second lens element is CT2, the following condition can be satisfied: 2.80<f2/CT2<6.00. Therefore, it is favorable for controlling the refractive power of the second lens element, thereby correcting chromatic aberration. Moreover, the following condition can also be satisfied: 2.90<f2/CT2<5.60.

When a sum of central thicknesses of all lens elements of the optical photographing system is ECT, and the focal length of the optical photographing system is f, the following condition can be satisfied: 0.80<ECT/f<1.40. Therefore, it is favorable for balancing the configuration of the central thicknesses of the lens elements of the optical photographing system so as to improve light convergence quality. Moreover, the following condition can also be satisfied: 0.85<ECT/f<1.40.

When the focal length of the third lens element is f3, and a curvature radius of the object-side surface of the third lens element is R5, the following condition can be satisfied: |f3/R5|<3.00. Therefore, it is favorable for adjusting the light incident angle on the object-side surface of the third lens element, increasing viewing angle and reducing the overall size. Moreover, the following condition can also be satisfied: |f3/R5|<2.80.

According to the present disclosure, the aforementioned features and conditions can be utilized in numerous combinations so as to achieve corresponding effects.

According to the present disclosure, the lens elements of the optical photographing system can be made of either glass or plastic material. When the lens elements are made of glass material, the refractive power distribution of the optical photographing system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the optical photographing system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof. The focal length of a single lens element is calculated based on the lensmaker's formula, assuming air as the medium on both of the object side and the image side of the lens element; the composite focal length of multiple lens elements is calculated by assuming air as the medium on both of the object side and the image side of the optical assembly.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, an axial distance between two adjacent lens elements is a distance in a paraxial region between two adjacent surfaces of the two adjacent lens elements.

According to the present disclosure, the maximum image height (ImgH) can be half of a diagonal length of an effective photosensitive area of an image sensor.

According to the present disclosure, the image surface of the optical photographing system, based on the corresponding image sensor, can be flat or curved, especially a curved surface being concave facing towards the object side of the optical photographing system.

According to the present disclosure, an image correction unit, such as a field flattener, can be optionally disposed between the lens element closest to the image side of the optical photographing system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

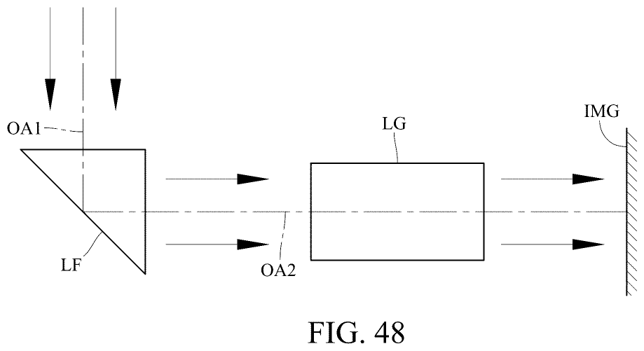

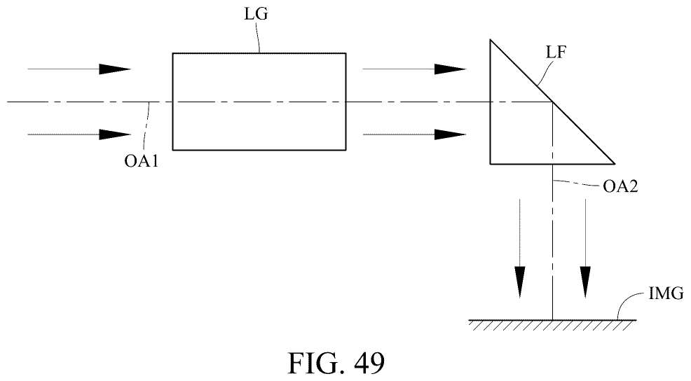

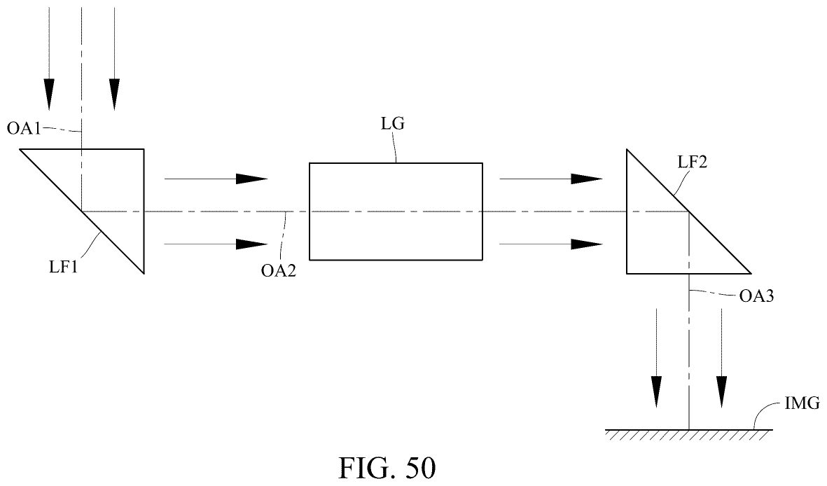

According to the present disclosure, at least one light-folding element, such as a prism or a mirror which can have a surface being planar, spherical, aspheric or in free-form, can be optionally disposed between an imaged object and the image surface on the imaging optical path, such that the optical photographing system can be more flexible in space arrangement, and therefore the dimensions of an electronic device is not restricted by the total track length of the optical photographing system. Specifically, please refer to FIG. 48 and FIG. 49. FIG. 48 shows a schematic view of a configuration of a light-folding element in an optical photographing system according to one embodiment of the present disclosure, and FIG. 49 shows a schematic view of another configuration of a light-folding element in an optical photographing system according to one embodiment of the present disclosure. In FIG. 48 and FIG. 49, the optical photographing system can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the optical photographing system as shown in FIG. 48 or disposed between a lens group LG of the optical photographing system and the image surface IMG as shown in FIG. 49. Furthermore, please refer to FIG. 50, which shows a schematic view of a configuration of two light-folding elements in an optical photographing system according to one embodiment of the present disclosure. In FIG. 50, the optical photographing system can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the optical photographing system, the second light-folding element LF2 is disposed between the lens group LG of the optical photographing system and the image surface IMG, and the travelling direction of light on the first optical axis OA1 can be the same direction as the travelling direction of light on the third optical axis OA3 as shown in FIG. 50. The optical photographing system can be optionally provided with three or more light-folding elements, and the present disclosure is not limited to the type, amount and position of the light-folding elements of the embodiments disclosed in the aforementioned figures.

According to the present disclosure, the optical photographing system can include at least one stop, such as an aperture stop, a glare stop or a field stop. Said glare stop or said field stop can be disposed between an imaged object and the first lens element, between adjacent lens elements, or between the last lens element and the image surface, and is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the optical photographing system and the image surface to produce a telecentric effect, and thereby improves the image-sensing efficiency of an image sensor (for example, CCD or CMOS). A middle stop disposed between the first lens element and the image surface is favorable for enlarging the viewing angle of the optical photographing system and thereby provides a wider field of view for the same.

According to the present disclosure, the optical photographing system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the optical photographing system can include one or more optical elements for limiting the form of light passing through the optical photographing system. Each optical element can be, but not limited to, a filter, a polarizer, etc., and each optical element can be, but not limited to, a single-piece element, a composite component, a thin film, etc. The optical element can be located at the object side or the image side of the optical photographing system or between any two adjacent lens elements so as to allow light in a specific form to pass through, thereby meeting application requirements.

According to the present disclosure, the optical photographing system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the optical photographing system can further include a light-blocking element. The light-blocking element can have a non-circular opening, and the non-circular opening can have different effective radii in different directions which are perpendicular to the optical axis. Therefore, it is favorable for coordinating with the shape of non-circular lens elements or aperture stop so as to effectively save the space and make full use of the light passing through said non-circular lens elements or aperture stop, thereby reducing stray light. Moreover, the light-blocking element can be provided with a wavy structure or a jagged structure at a periphery of an inner hole portion thereof.

According to the above description of the present disclosure, the following specific embodiments are provided for further explanation.

### 1st Embodiment

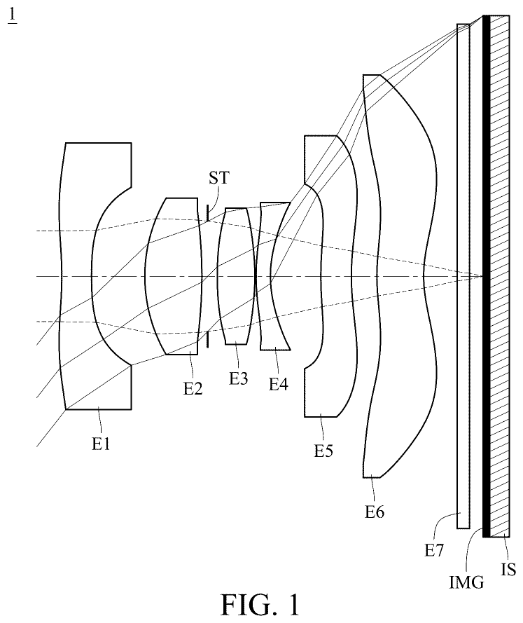

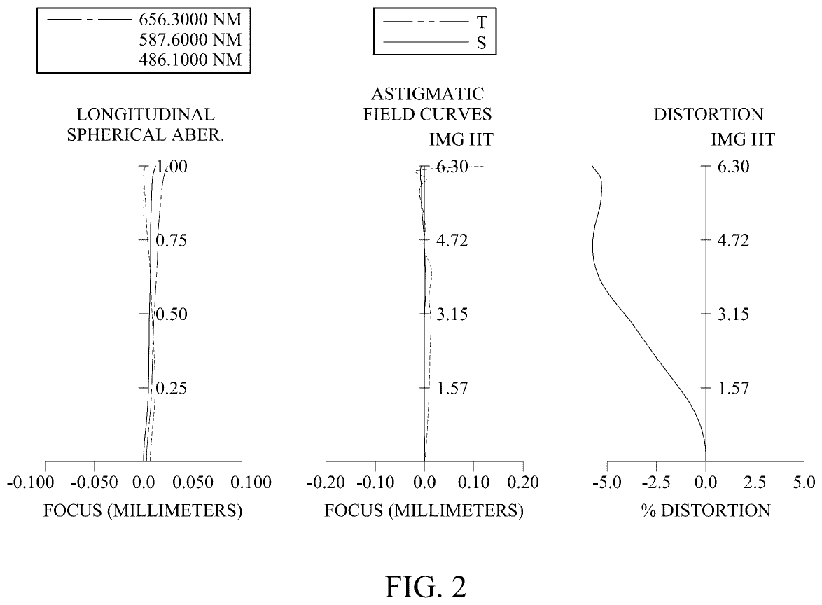

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The object-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26, 28 and 30.

In the optical photographing system of the image capturing unit 1 according to the 1st embodiment, when a focal length of the optical photographing system is f, an f-number of the optical photographing system is Fno, and half of a maximum field of view of the optical photographing system is HFOV, these parameters have the following values: f=5.18 millimeters (mm), Fno=2.39, and HFOV=51.9 degrees (deg.).

When an Abbe number of the second lens element E2 is V2, and an Abbe number of the third lens element E3 is V3, the following condition is satisfied: V2+V3=124.3.

When a central thickness of the first lens element E1 is CT1, a central thickness of the second lens element E2 is CT2, a central thickness of the third lens element E3 is CT3, and a central thickness of the fourth lens element is E4 CT4, the following condition is satisfied: (CT1+CT2)/(CT3+CT4)=1.67.

When a central thickness of the fifth lens element E5 is CT5, an axial distance between the fourth lens element E4 and the fifth lens element E5 is T45, and an axial distance between the fifth lens element E5 and the sixth lens element E6 is T56, the following condition is satisfied: CT5/(T45+T56)=0.40. In this embodiment, an axial distance between two adjacent lens elements is a distance in a paraxial region between two adjacent lens surfaces of the two adjacent lens elements.

When the central thickness of the fifth lens element E5 is CT5, a central thickness of the sixth lens element E6 is CT6, the axial distance between the fourth lens element E4 and the fifth lens element E5 is T45, and the axial distance between the fifth lens element E5 and the sixth lens element E6 is T56, the following condition is satisfied: (CT5+CT6)/(T45+T56)=1.02.

When the central thickness of the fourth lens element E4 is CT4, the central thickness of the fifth lens element E5 is CT5, the central thickness of the sixth lens element E6 is CT6, the axial distance between the fourth lens element E4 and the fifth lens element E5 is T45, and the axial distance between the fifth lens element E5 and the sixth lens element E6 is T56, the following condition is satisfied: (CT4+CT5+CT6)/(T45+T56)=1.21.

When a focal length of the third lens element E3 is f3, and a curvature radius of the object-side surface of the third lens element E3 is R5, the following condition is satisfied: |f3/R5|=0.83.

When an axial distance between the object-side surface of the third lens element E3 and the image-side surface of the fourth lens element E4 is Dr5r8, and the focal length of the third lens element E3 is f3, the following condition is satisfied: Dr5r8/f3=0.21.

When a focal length of the second lens element E2 is f2, the central thickness of the second lens element E2 is CT2, the following condition is satisfied: f2/CT2=3.57.

When a sum of axial distances between each of all adjacent lens elements of the optical photographing system is EAT, and the focal length of the optical photographing system is f, the following condition is satisfied: EAT/f=0.67. In this embodiment, ΣAT is a sum of an axial distance between the first lens element E1 and the second lens element E2, an axial distance between the second lens element E2 and the third lens element E3, an axial distance between the third lens element E3 and the fourth lens element E4, the axial distance between the fourth lens element E4 and the fifth lens element E5, and the axial distance between the fifth lens element E5 and the sixth lens element E6.

When a sum of central thicknesses of all lens elements of the optical photographing system is ΣCT, and the focal length of the optical photographing system is f, the following condition is satisfied: ΣCT/f=1.00. In this embodiment, ΣCT is a sum of central thicknesses of the first lens element E1, the second lens element E2, the third lens element E3, the fourth lens element E4, the fifth lens element E5, and the sixth lens element E6.

When a composite focal length of the second lens element E2 and the third lens element E3 is f23, and a composite focal length of the fifth lens element E5 and the sixth lens element E6 is f56, the following condition is satisfied: f23/f56=−0.23.

When the focal length of the second lens element E2 is f2, and the focal length of the third lens element E3 is f3, the following condition is satisfied: f2/f3=0.79.

When the focal length of the optical photographing system is f, and the composite focal length of the second lens element E2 and the third lens element E3 is f23, the following condition is satisfied: f/f23=1.67.

When the focal length of the optical photographing system is f, and the composite focal length of the fifth lens element E5 and the sixth lens element E6 is f56, the following condition is satisfied: |f/f56|=0.39.

When the focal length of the optical photographing system is f, half of the maximum field of view of the optical photographing system is HFOV, and the composite focal length of the second lens element E2 and the third lens element E3 is f23, the following condition is satisfied: f×tan(HFOV)/f23=2.13.

When the focal length of the optical photographing system is f, half of the maximum field of view of the optical photographing system is HFOV, and a maximum image height of the optical photographing system is ImgH, the following condition is satisfied: f×sin(HFOV)/ImgH=0.65.

When the focal length of the optical photographing system is f, and the maximum image height of the optical photographing system is ImgH, the following condition is satisfied: f/ImgH=0.83.

When an axial distance between the object-side surface of the first lens element E1 and the image surface IMG is TL, and the maximum image height of the optical photographing system is ImgH, the following condition is satisfied: TL/ImgH=1.62.

When the axial distance between the object-side surface of the first lens element E1 and the image surface IMG is TL, the focal length of the optical photographing system is f, the following condition is satisfied: TL/f=1.94.

The detailed optical data of the 1st embodiment are shown in Table 1A and the aspheric surface data are shown in Table 1B below.

TABLE 1A
1st Embodiment
f = 5.18 mm, Fno = 2.39, HFOV = 51.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −7.7347 | (ASP) | 0.711 | Plastic | 1.545 | 56.1 | −7.51 |
| 2 | | 8.9757 | (ASP) | 1.275 | | | | |
| 3 | Lens 2 | 3.6853 | (SPH) | 1.364 | Glass | 1.593 | 68.3 | 4.87 |
| 4 | | −11.4671 | (SPH) | 0.139 | | | | |
| 5 | Ape. Stop | Plano | | 0.229 | | | | |
| 6 | Lens 3 | 7.4419 | (ASP) | 0.899 | Plastic | 1.544 | 56.0 | 6.14 |
| 7 | | −5.8042 | (ASP) | 0.030 | | | | |
| 8 | Lens 4 | 4.9401 | (ASP) | 0.342 | Plastic | 1.686 | 18.4 | −8.67 |
| 9 | | 2.6222 | (ASP) | 1.206 | | | | |
| 10 | Lens 5 | 7.6628 | (ASP) | 0.730 | Plastic | 1.544 | 56.0 | −43.29 |
| 11 | | 5.5875 | (ASP) | 0.610 | | | | |
| 12 | Lens 6 | 4.6243 | (ASP) | 1.118 | Plastic | 1.534 | 56.0 | −19.80 |
| 13 | | 2.9468 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.322 | | | | |
| 16 | Image | Plano | — | | | | |

Note:
Reference wavelength is 587.6 nm (d-line).

TABLE 1B
Aspheric Coefficients

| Surface # | 1 | 2 | 6 | 7 |
|---|---|---|---|---|
| k= | −9.00000E+01 | 4.27774E+00 | 7.45324E+00 | −4.47014E+00 |
| A4= | 1.113364110E−05 | 3.382435414E−02 | 4.208687931E−03 | −2.777410840E−03 |
| A6= | 9.988412052E−03 | −7.539256767E−03 | 6.778611527E−03 | 8.429162885E−02 |
| A8= | −7.849047873E−03 | 1.445643763E−02 | −4.466468487E−02 | −2.961562376E−01 |
| A10= | 4.123041428E−03 | −2.209608631E−02 | 1.783479360E−01 | 6.710763219E−01 |
| A12= | −1.609315763E−03 | 2.264366066E−02 | −4.712474874E−01 | −1.113620459E+00 |
| A14= | 4.749430882E−04 | −1.581797749E−02 | 8.574737669E−01 | 1.379825840E+00 |
| A16= | −1.063726390E−04 | 7.731218774E−03 | −1.104220548E+00 | −1.281217305E+00 |
| A18= | 1.802717776E−05 | −2.649281425E−03 | 1.021551631E+00 | 8.909555397E−01 |
| A20= | −2.289658771E−06 | 6.202871978E−04 | −6.815920263E−01 | −4.613494366E−01 |
| A22= | 2.139795373E−07 | −9.179583638E−05 | 3.252886988E−01 | 1.753999771E−01 |
| A24= | −1.425036639E−08 | 6.549591680E−06 | −1.083620501E−01 | −4.760888965E−02 |
| A26= | 6.391037687E−10 | 2.077096739E−07 | 2.394481092E−02 | 8.746949610E−03 |
| A28= | −1.728281646E−11 | −7.414647302E−08 | −3.155284062E−03 | −9.762102304E−04 |
| A30= | 2.127637829E−13 | 3.998459741E−09 | 1.877381432E−04 | 5.003142945E−05 |

| Surface # | 8 | 9 | 10 | 11 |
|---|---|---|---|---|
| k= | 2.12040E+00 | −5.69567E−01 | −9.00000E+01 | −2.19599E+01 |
| A4= | −4.812493674E−02 | −4.614342863E−02 | 1.655245677E−03 | −1.551017993E−02 |
| A6= | 1.057066896E−01 | 4.191828717E−02 | −1.182578475E−02 | 9.713779431E−03 |
| A8= | −3.039461606E−01 | −3.854350848E−02 | 9.090461880E−03 | −4.255700010E−03 |
| A10= | 6.692020504E−01 | 1.334436173E−02 | −4.317202235E−03 | 6.184868792E−04 |
| A12= | −1.124167896E+00 | 4.061568851E−02 | −4.165178176E−03 | 2.217410737E−04 |
| A14= | 1.419693907E+00 | −1.016855674E−01 | 9.967408723E−03 | −1.431769058E−04 |
| A16= | −1.341184605E+00 | 1.289152780E−01 | −9.614637358E−03 | 3.871861542E−05 |
| A18= | 9.449821311E−01 | −1.066061052E−01 | 5.774261967E−03 | −6.438527089E−06 |
| A20= | −4.932245179E−01 | 6.073685323E−02 | −2.350843324E−03 | 7.080391759E−07 |
| A22= | 1.878379321E−01 | −2.406197372E−02 | 6.610947041E−04 | −5.170189910E−08 |
| A24= | −5.069348996E−02 | 6.518980465E−03 | −1.267259669E−04 | 2.405493183E−09 |
| A26= | 9.180730004E−03 | −1.152578152E−03 | 1.582175166E−05 | −6.368672726E−11 |
| A28= | −1.000273190E−03 | 1.198639476E−04 | −1.160206340E−06 | 6.747450100E−13 |
| A30= | 4.953087467E−05 | −5.561725722E−06 | 3.791091601E−08 | 2.281444404E−15 |

| Surface # | 12 | 13 |
|---|---|---|
| k= | −2.51741E+00 | −1.59255E+00 |
| A4= | −4.753081207E−02 | −4.004823925E−02 |
| A6= | 1.075326311E−02 | 6.646344698E−03 |
| A8= | −7.030760415E−04 | 1.503863270E−04 |
| A10= | −5.072054014E−04 | −5.216872008E−04 |
| A12= | 2.104995952E−04 | 1.766468357E−04 |
| A14= | −4.357113492E−05 | −3.461129659E−05 |
| A16= | 5.890674484E−06 | 4.535264510E−06 |
| A18= | −5.600848372E−07 | −4.144815838E−07 |
| A20= | 3.833413878E−08 | 2.673327046E−08 |
| A22= | −1.884717497E−09 | −1.209567506E−09 |
| A24= | 6.503269578E−11 | 3.746867992E−11 |
| A26= | −1.495746804E−12 | −7.544357692E−13 |
| A28= | 2.059372154E−14 | 8.861371338E−15 |
| A30= | −1.283803612E−16 | −4.584886198E−17 |

In Table 1A, the curvature radius, the thickness and the focal length are shown in millimeters (mm). Surface numbers 0-16 represent the surfaces sequentially arranged from the object side to the image side along the optical axis. In Table 1B, k represents the conic coefficient of the equation of the aspheric surface profiles. A4-A30 represent the aspheric coefficients ranging from the 4th order to the 30th order. The tables presented below for each embodiment are the corresponding schematic parameter and aberration curves, and the definitions of the tables are the same as those of Table 1A and Table 1B of the 1st embodiment. Therefore, an explanation in this regard will not be provided again.

### 2nd Embodiment

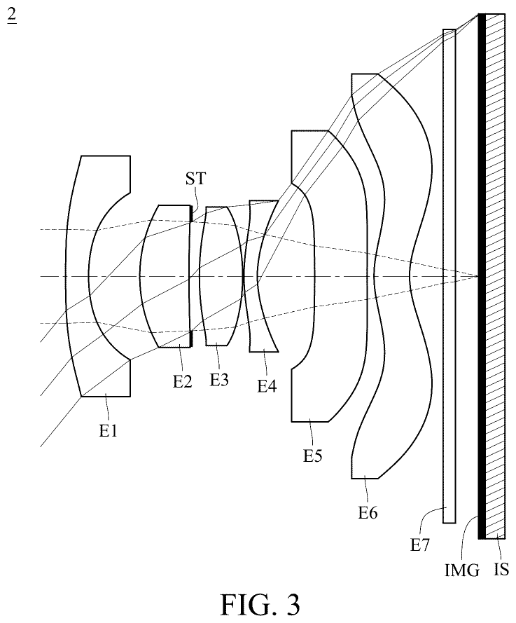

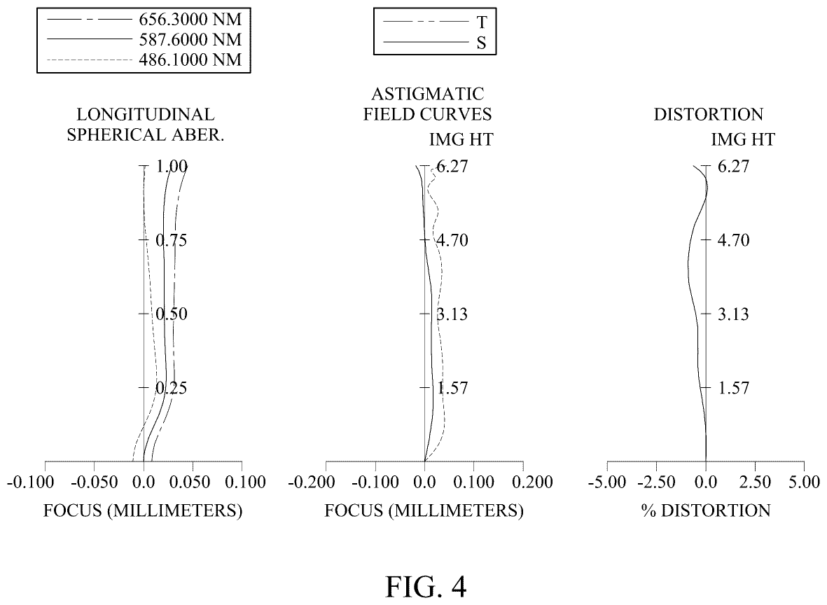

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has two inflection points.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 2nd embodiment are shown in Table 2A and the aspheric surface data are shown in Table 2B below.

TABLE 2A
2nd Embodiment
f = 5.13 mm, Fno = 2.29, HFOV = 50.8 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 31.7259 | (ASP) | 0.550 | Glass | 1.516 | 64.0 | −8.02 |
| 2 | | 3.6396 | (ASP) | 1.223 | | | | |
| 3 | Lens 2 | 3.4022 | (SPH) | 1.177 | Glass | 1.593 | 68.3 | 6.28 |
| 4 | | 34.2325 | (SPH) | 0.066 | | | | |
| 5 | Ape. Stop | Plano | | 0.184 | | | | |
| 6 | Lens 3 | 6.5906 | (ASP) | 1.036 | Plastic | 1.544 | 56.0 | 4.90 |
| 7 | | −4.2350 | (ASP) | 0.030 | | | | |
| 8 | Lens 4 | 4.0896 | (ASP) | 0.320 | Plastic | 1.686 | 18.4 | −10.30 |
| 9 | | 2.5084 | (ASP) | 1.369 | | | | |
| 10 | Lens 5 | −42.0433 | (ASP) | 1.255 | Plastic | 1.544 | 56.0 | −34.30 |
| 11 | | 33.9012 | (ASP) | 0.165 | | | | |
| 12 | Lens 6 | 2.4012 | (ASP) | 0.851 | Plastic | 1.544 | 56.0 | −65.82 |
| 13 | | 1.9693 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.551 | | | | |
| 16 | Image | Plano | — | | | | |

Note:
Reference wavelength is 587.6 nm (d-line).

TABLE 2B
Aspheric Coefficients

| Surface # | 1 | 2 | 6 | 7 |
|---|---|---|---|---|
| k= | −9.00000E+01 | −1.13536E+00 | −4.06334E+00 | 5.75251E−01 |
| A4= | 9.922554051E−03 | 2.468227496E−02 | 3.379289375E−03 | −1.242683580E−02 |
| A6= | 3.067623961E−03 | −7.862973748E−03 | 1.875925553E−02 | 1.142307659E−01 |
| A8= | −6.225356250E−03 | 3.720581242E−02 | −1.280023789E−01 | −3.215864223E−01 |
| A10= | 5.070431024E−03 | −9.006154347E−02 | 4.841804131E−01 | 5.356600377E−01 |
| A12= | −2.712457379E−03 | 1.313065120E−01 | −1.206831494E+00 | −5.524461617E−01 |
| A14= | 1.026125722E−03 | −1.260615704E−01 | 2.077651219E+00 | 2.824453734E−01 |
| A16= | −2.820285164E−04 | 8.348935611E−02 | −2.540193498E+00 | 8.304750412E−02 |
| A18= | 5.683821780E−05 | −3.888779858E−02 | 2.237241955E+00 | −2.770906122E−01 |
| A20= | −8.372144020E−06 | 1.274045041E−02 | −1.423575884E+00 | 2.465736806E−01 |
| A22= | 8.871838457E−07 | −2.880837156E−03 | 6.483977861E−01 | −1.288488700E−01 |
| A24= | −6.548194861E−08 | 4.296396012E−04 | −2.060971464E−01 | 4.327792503E−02 |
| A26= | 3.171609276E−09 | −3.841156420E−05 | 4.341187060E−02 | −9.221983346E−03 |
| A28= | −8.969912592E−11 | 1.630795783E−06 | −5.444802185E−03 | 1.139372512E−03 |
| A30= | 1.106091826E−12 | −1.016813619E−08 | 3.077797687E−04 | −6.231853585E−05 |

| Surface # | 8 | 9 | 10 | 11 |
|---|---|---|---|---|
| k= | 7.64173E−01 | −7.92306E−01 | 9.00000E+01 | −6.48607E+01 |
| A4= | −6.967502499E−02 | −5.278570462E−02 | 3.161011096E−03 | −2.690428427E−02 |
| A6= | 1.817051752E−01 | 5.325907947E−02 | 6.048006056E−03 | 2.685210048E−02 |
| A8= | −5.162782435E−01 | −5.570912777E−02 | −3.911520618E−02 | −1.793580877E−02 |
| A10= | 1.076351399E+00 | 3.416299871E−02 | 7.162180976E−02 | 8.241335385E−03 |
| A12= | −1.648340594E+00 | 1.895825208E−02 | −8.599005476E−02 | −2.901841595E−03 |
| A14= | 1.853737951E+00 | −7.922761839E−02 | 7.279583005E−02 | 8.011069897E−04 |
| A16= | −1.531330157E+00 | 1.063102397E−01 | −4.440718205E−02 | −1.723440729E−04 |
| A18= | 9.263049222E−01 | −8.771123290E−02 | 1.967387387E−02 | 2.846096756E−05 |
| A20= | −4.064975968E−01 | 4.895381723E−02 | −6.322964225E−03 | −3.539649081E−06 |
| A22= | 1.269527036E−01 | −1.885612180E−02 | 1.457237998E−03 | 3.234762481E−07 |
| A24= | −2.724078519E−02 | 4.949831112E−03 | −2.345330279E−04 | −2.096129051E−08 |
| A26= | 3.767557158E−03 | −8.466638520E−04 | 2.501975939E−05 | 9.084566682E−10 |
| A28= | −2.962301225E−04 | 8.514195232E−05 | −1.589599024E−06 | −2.355745809E−11 |
| A30= | 9.675733033E−06 | −3.820430111E−06 | 4.553789645E−08 | 2.758566313E−13 |

| Surface # | 12 | 13 |
|---|---|---|
| k= | −7.55086E+00 | −2.20013E+00 |
| A4= | −2.770500056E−02 | −4.793165420E−02 |
| A6= | 6.622432162E−03 | 1.341589613E−02 |
| A8= | −1.337862642E−03 | −2.696221006E−03 |
| A10= | 1.183825732E−04 | 3.215985604E−04 |
| A12= | −5.157849573E−06 | −1.001153947E−05 |
| A14= | 2.949519268E−06 | −3.857695365E−06 |
| A16= | −9.504674029E−07 | 8.126372269E−07 |
| A18= | 1.468316725E−07 | −8.658656747E−08 |
| A20= | −1.354226361E−08 | 5.922870826E−09 |
| A22= | 8.066358739E−10 | −2.732334927E−10 |
| A24= | −3.151946152E−11 | 8.474926251E−12 |
| A26= | 7.840148729E−13 | −1.696086571E−13 |
| A28= | −1.129339361E−14 | 1.979148452E−15 |
| A30= | 7.184718160E−17 | −1.022801084E−17 |

In the 2nd embodiment, the equation of the aspheric surface profiles of the aforementioned lens elements is the same as the equation of the 1st embodiment. Also, the definitions of these parameters shown in Table 2C are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
Schematic Parameters

| | | | |
|---|---|---|---|
| f [mm] | 5.13 | ΣAT/f | 0.59 |
| Fno | 2.29 | ΣCT/f | 1.01 |
| HFOV [deg.] | 50.8 | f23/f56 | −0.16 |
| V2 + V3 | 124.3 | f2/f3 | 1.28 |
| (CT1 + CT2)/(CT3 + CT4) | 1.27 | f/f23 | 1.62 |
| CT5/(T45 + T56) | 0.82 | \|f/f56\| | 0.25 |
| (CT5 + CT6)/(T45 + T56) | 1.37 | f × tan(HFOV)/f23 | 1.98 |
| (CT4 + CT5 + CT6)/(T45 + | 1.58 | f × sin(HFOV)/ImgH | 0.63 |
| T56) | | | |
| \|f3/R5\| | 0.74 | f/ImgH | 0.82 |
| Dr5r8/f3 | 0.28 | TL/ImgH | 1.58 |
| f2/CT2 | 5.34 | TL/f | 1.92 |

### 3rd Embodiment

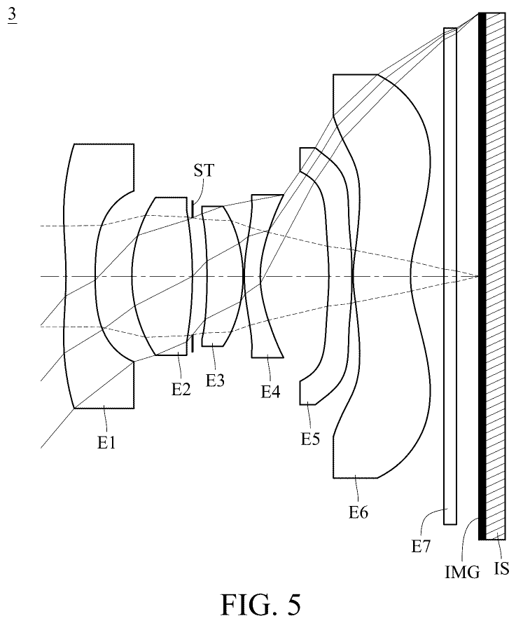

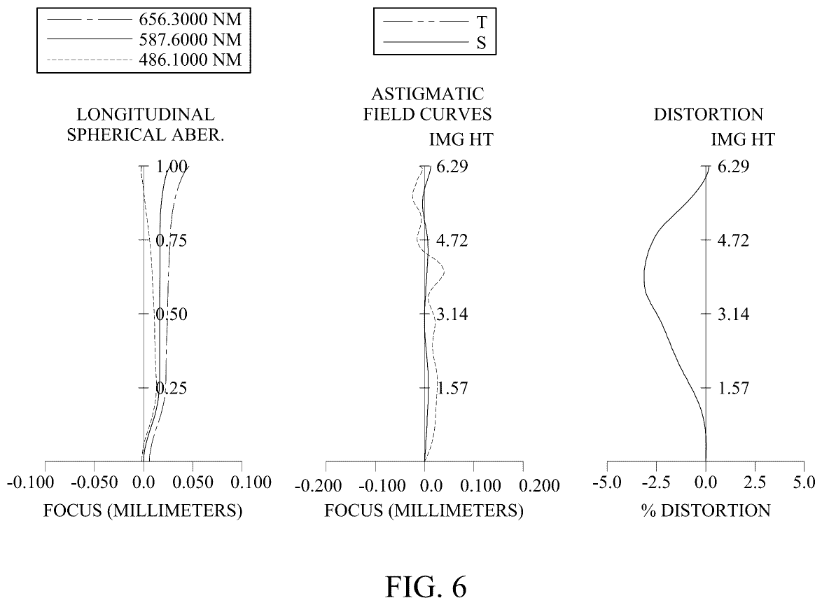

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of glass material and has the object-side surface and the image-side surface being both spherical.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 3rd embodiment are shown in Table 3A and the aspheric surface data are shown in Table 3B below.

TABLE 3A
3rd Embodiment
f = 5.28 mm, Fno = 2.19, HFOV = 49.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −8.3181 | (ASP) | 0.698 | Plastic | 1.545 | 56.1 | −7.72 |
| 2 | | 8.7730 | (ASP) | 0.876 | | | | |
| 3 | Lens 2 | 3.4149 | (SPH) | 1.449 | Glass | 1.593 | 68.3 | 4.38 |
| 4 | | −9.0868 | (SPH) | 0.002 | | | | |
| 5 | Ape. Stop | Plano | | 0.349 | | | | |
| 6 | Lens 3 | −11.8099 | (ASP) | 0.861 | Plastic | 1.544 | 56.0 | 7.42 |
| 7 | | −3.0842 | (ASP) | 0.030 | | | | |
| 8 | Lens 4 | 3.8715 | (ASP) | 0.381 | Plastic | 1.686 | 18.4 | −10.34 |
| 9 | | 2.4042 | (ASP) | 1.641 | | | | |
| 10 | Lens 5 | −5.6307 | (ASP) | 0.550 | Plastic | 1.544 | 56.0 | −15.44 |
| 11 | | −17.6757 | (ASP) | 0.030 | | | | |
| 12 | Lens 6 | 2.6641 | (ASP) | 1.371 | Plastic | 1.544 | 56.0 | 48.28 |
| 13 | | 2.4272 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.537 | | | | |
| 16 | Image | Plano | — | | | | |

Note:
Reference wavelength is 587.6 nm (d-line).

TABLE 3B
Aspheric Coefficients

| Surface # | 1 | 2 | 6 | 7 |
|---|---|---|---|---|
| k= | −9.00000E+01 | 4.91184E+00 | 3.35303E+01 | −3.79549E−01 |
| A4= | 4.664340168E−03 | 3.459697325E−02 | 3.636203485E−03 | 2.428754117E−02 |
| A6= | 5.662438559E−03 | −9.293384744E−03 | 1.508484197E−02 | −5.932338533E−02 |
| A8= | −5.068796930E−03 | 1.748773025E−02 | −1.220741726E−01 | 1.837461226E−01 |
| A10= | 2.975356147E−03 | −2.667316806E−02 | 4.764490315E−01 | −5.062609341E−01 |
| A12= | −1.328177002E−03 | 2.686623592E−02 | −1.200576760E+00 | 1.005832585E+00 |
| A14= | 4.518314645E−04 | −1.619167050E−02 | 2.074725176E+00 | −1.414229165E+00 |
| A16= | −1.160709838E−04 | 4.105641869E−03 | −2.539441687E+00 | 1.423715804E+00 |
| A18= | 2.232147106E−05 | 1.735262223E−03 | 2.237160983E+00 | −1.036159585E+00 |
| A20= | −3.178888037E−06 | −2.110384605E−03 | −1.423575884E+00 | 5.456834133E−01 |
| A22= | 3.294242127E−07 | 9.658578658E−04 | 6.483977861E−01 | −2.057887294E−01 |
| A24= | −2.409370280E−08 | −2.577199047E−04 | −2.060971464E−01 | 5.413548410E−02 |
| A26= | 1.177090992E−09 | 4.181933143E−05 | 4.341187060E−02 | −9.427372679E−03 |
| A28= | −3.443747181E−11 | −3.842366669E−06 | −5.444802185E−03 | 9.760767830E−04 |
| A30= | 4.559650132E−13 | 1.539889184E−07 | 3.077797687E−04 | −4.546565872E−05 |

| Surface # | 8 | 9 | 10 | 11 |
|---|---|---|---|---|
| k= | 9.97637E−01 | 0.00000E+00 | −4.41448E+01 | 1.29087E+01 |
| A4= | −3.405300865E−02 | −5.580465123E−02 | 4.952225022E−02 | −4.722630745E−02 |
| A6= | 1.185414167E−02 | 3.232640817E−02 | −9.278779623E−02 | 9.930954037E−03 |
| A8= | −2.529496073E−02 | −3.133904618E−02 | 1.364643449E−01 | 5.813153928E−02 |
| A10= | 4.067883918E−02 | 2.501308619E−02 | −1.361409773E−01 | −6.936303154E−02 |
| A12= | −4.342781425E−02 | −1.447739959E−02 | 9.489770138E−02 | 4.172652563E−02 |
| A14= | 3.149180813E−02 | 5.810419162E−03 | −4.860488597E−02 | −1.623628847E−02 |
| A16= | −1.568024157E−02 | −1.566907897E−03 | 1.881235979E−02 | 4.423729466E−03 |
| A18= | 5.283175501E−03 | 2.694145989E−04 | −5.548151520E−03 | −8.717244214E−04 |
| A20= | −1.150875650E−03 | −2.653791977E−05 | 1.236704949E−03 | 1.253872667E−04 |
| A22= | 1.462189453E−04 | 1.129592447E−06 | −2.038133824E−04 | −1.305810092E−05 |
| A24= | −8.228404082E−06 | — | 2.393154140E−05 | 9.586890615E−07 |
| A26= | — | — | −1.883702772E−06 | −4.700641519E−08 |
| A28= | — | — | 8.870538967E−08 | 1.379406340E−09 |
| A30= | — | — | −1.882388954E−09 | −1.829116770E−11 |

| Surface # | 12 | 13 |
|---|---|---|
| k= | −1.00000E+00 | −1.90328E+00 |
| A4= | −1.512878653E−01 | −4.043874840E−02 |
| A6= | 9.500919700E−02 | 4.700521439E−03 |
| A8= | −4.092098684E−02 | 2.618279145E−03 |
| A10= | 1.178997826E−02 | −1.673391498E−03 |
| A12= | −2.314072706E−03 | 4.908868609E−04 |
| A14= | 3.132053576E−04 | −9.125847080E−05 |
| A16= | −2.941813543E−05 | 1.164706681E−05 |
| A18= | 1.911054724E−06 | −1.051801021E−06 |
| A20= | −8.422050155E−08 | 6.781543794E−08 |
| A22= | 2.403638164E−09 | −3.101723307E−09 |
| A24= | −4.008581050E−11 | 9.827408946E−11 |
| A26= | 2.966537440E−13 | −2.050450396E−12 |
| A28= | — | 2.533469114E−14 |
| A30= | — | −1.403956575E−16 |

In the 3rd embodiment, the equation of the aspheric surface profiles of the aforementioned lens elements is the same as the equation of the 1st embodiment. Also, the definitions of these parameters shown in Table 3C are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Schematic Parameters

| | | | |
|---|---|---|---|
| f [mm] | 5.28 | ΣAT/f | 0.55 |
| Fno | 2.19 | ΣCT/f | 1.01 |
| HFOV [deg.] | 49.9 | f23/f56 | −0.18 |
| V2 + V3 | 124.3 | f2/f3 | 0.59 |
| (CT1 + CT2)/(CT3 + CT4) | 1.73 | f/f23 | 1.63 |
| CT5/(T45 + T56) | 0.33 | \|f/f56\| | 0.30 |
| (CT5 + CT6)/(T45 + T56) | 1.15 | f × tan(HFOV)/f23 | 1.94 |
| (CT4 + CT5 + CT6)/(T45 + | 1.38 | f × sin(HFOV)/ImgH | 0.64 |
| T56) | | | |
| \|f3/R5\| | 0.63 | f/ImgH | 0.84 |
| Dr5r8/f3 | 0.17 | TL/ImgH | 1.57 |
| f2/CT2 | 3.02 | TL/f | 1.87 |

### 4th Embodiment

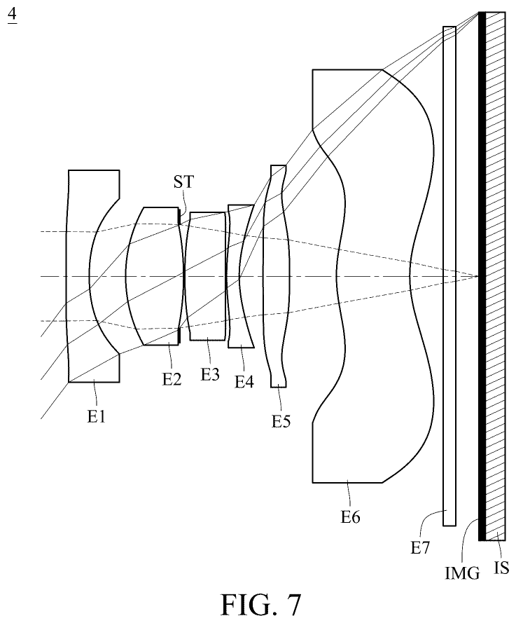

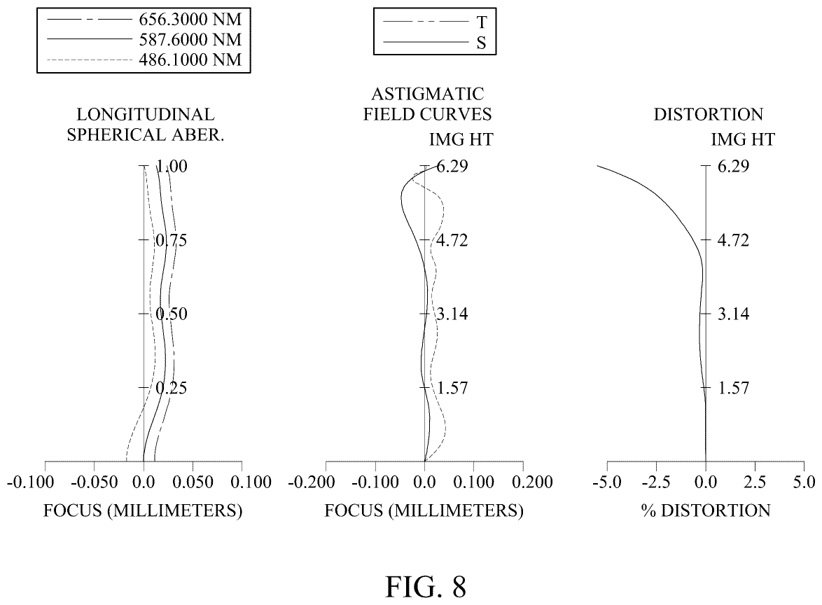

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The object-side surface of the first lens element E1 has two critical points in an off-axis region thereof.

The second lens element E2 with positive refractive power has an object-side surface being convex in a paraxial region thereof and an image-side surface being convex in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has three inflection points. The image-side surface of the third lens element E3 has three critical points in an off-axis region thereof.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The object-side surface of the fourth lens element E4 has one critical point in an off-axis region thereof.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has two inflection points.

The object-side surface of the fifth lens element E5 has one critical point in an off-axis region thereof. The image-side surface of the fifth lens element E5 has two critical points in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 4th embodiment are shown in Table 4A and the aspheric surface data are shown in Table 4B below.

TABLE 4A
4th Embodiment
f = 5.00 mm, Fno = 2.34, HFOV = 53.1 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −85.8477 | (ASP) | 0.554 | Plastic | 1.545 | 56.1 | −6.63 |
| 2 | | 3.7817 | (ASP) | 0.869 | | | | |
| 3 | Lens 2 | 3.3385 | (SPH) | 1.387 | Glass | 1.569 | 56.0 | 4.06 |
| 4 | | −6.3790 | (SPH) | −0.091 | | | | |
| 5 | Ape. Stop | Plano | | 0.121 | | | | |
| 6 | Lens 3 | 8.8199 | (ASP) | 0.970 | Plastic | 1.534 | 56.0 | 21.06 |
| 7 | | 39.2680 | (ASP) | 0.030 | | | | |
| 8 | Lens 4 | 4.7482 | (ASP) | 0.302 | Plastic | 1.686 | 18.4 | −11.62 |
| 9 | | 2.8987 | (ASP) | 0.569 | | | | |
| 10 | Lens 5 | 24.1838 | (ASP) | 0.636 | Plastic | 1.534 | 56.0 | 22.71 |
| 11 | | −24.1255 | (ASP) | 1.120 | | | | |
| 12 | Lens 6 | 3.1678 | (ASP) | 1.753 | Plastic | 1.544 | 56.0 | 45.65 |
| 13 | | 2.9230 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.552 | | | | |
| 16 | Image | Plano | — | | | | |

Note:
Reference wavelength is 587.6 nm (d-line).

TABLE 4B
Aspheric Coefficients

| Surface # | 1 | 2 | 6 | 7 |
|---|---|---|---|---|
| k= | −9.00000E+01 | −4.61964E+00 | −1.22745E+01 | 9.00000E+01 |
| A4= | 1.416003680E−02 | 5.373604005E−02 | 6.260007707E−03 | −1.006231481E−01 |
| A6= | −9.366863717E−04 | −1.040371079E−01 | 2.708963111E−02 | 4.868465350E−01 |
| A8= | −5.168229936E−03 | 3.574695191E−01 | −1.452479639E−01 | −1.486421183E+00 |
| A10= | 5.867529882E−03 | −8.101731009E−01 | 5.111194838E−01 | 3.094865208E+00 |
| A12= | −3.846643828E−03 | 1.237505799E+00 | −1.231757662E+00 | −4.315159031E+00 |
| A14= | 1.697178658E−03 | −1.320210428E+00 | 2.091061557E+00 | 3.786490686E+00 |
| A16= | −5.320430325E−04 | 1.006896093E+00 | −2.544026085E+00 | −1.613132384E+00 |
| A18= | 1.221700398E−04 | −5.558038527E−01 | 2.237692679E+00 | −4.762172210E−01 |
| A20= | −2.086577769E−05 | 2.224441473E−01 | −1.423575884E+00 | 1.195080712E+00 |
| A22= | 2.647621876E−06 | −6.389844418E−02 | 6.483977859E−01 | −8.509942505E−01 |
| A24= | −2.438630640E−07 | 1.283485789E−02 | −2.060971464E−01 | 3.447844841E−01 |
| A26= | 1.541783723E−08 | −1.710621529E−03 | 4.341187060E−02 | −8.453086286E−02 |
| A28= | −5.959536987E−10 | 1.358294033E−04 | −5.444802185E−03 | 1.172098042E−02 |
| A30= | 1.055008509E−11 | −4.859883979E−06 | 3.077797686E−04 | −7.083433652E−04 |

| Surface # | 8 | 9 | 10 | 11 |
|---|---|---|---|---|
| k= | −3.72566E+00 | 0.00000E+00 | 7.43884E+01 | 4.48277E+01 |
| A4= | −1.164285592E−01 | −5.794329556E−02 | −3.261454949E−02 | −5.885442091E−02 |
| A6= | 3.385137931E−01 | 5.522764952E−02 | 3.203061816E−02 | 5.498983142E−02 |
| A8= | −8.413938724E−01 | −6.174342022E−02 | −2.123557435E−02 | −5.398277762E−02 |
| A10= | 1.496439285E+00 | 5.096029846E−02 | 1.170255001E−02 | 4.540181250E−02 |
| A12= | −1.900839890E+00 | −2.934297246E−02 | −5.407519022E−03 | −2.758073133E−02 |
| A14= | 1.720931496E+00 | 1.137433116E−02 | 2.093349961E−03 | 1.183960343E−02 |
| A16= | −1.108084424E+00 | −2.799260964E−03 | −6.313692557E−04 | −3.603028854E−03 |
| A18= | 5.020914683E−01 | 3.924966349E−04 | 1.351774230E−04 | 7.821113851E−04 |
| A20= | −1.560652163E−01 | −2.373483311E−05 | −1.882168113E−05 | −1.211759876E−04 |
| A22= | 3.159470067E−02 | — | 1.513171442E−06 | 1.327016304E−05 |
| A24= | −3.740348764E−03 | — | −5.313715838E−08 | −1.001593827E−06 |
| A26= | 1.956208960E−04 | — | — | 4.949973200E−08 |
| A28= | — | — | — | −1.440195014E−09 |
| A30= | — | — | — | 1.868591842E−11 |

| Surface # | 12 | 13 |
|---|---|---|
| k= | −1.00000E+00 | −1.85562E+00 |
| A4= | −3.984038384E−02 | −8.709790974E−03 |
| A6= | 5.121141803E−03 | −7.317642836E−03 |
| A8= | −7.713302749E−04 | 4.661649656E−03 |
| A10= | 1.218390197E−04 | −1.604688843E−03 |
| A12= | −5.195832148E−05 | 3.693694054E−04 |
| A14= | 2.220692352E−05 | −5.995544484E−05 |
| A16= | −5.626694622E−06 | 7.015484883E−06 |
| A18= | 8.613889960E−07 | −5.971534170E−07 |
| A20= | −8.248042171E−08 | 3.694524360E−08 |
| A22= | 4.974625606E−09 | −1.642048019E−09 |
| A24= | −1.836626949E−10 | 5.103609461E−11 |
| A26= | 3.792518707E−12 | −1.052326565E−12 |
| A28= | −3.356251186E−14 | 1.292592619E−14 |
| A30= | — | −7.155947957E−17 |

In the 4th embodiment, the equation of the aspheric surface profiles of the aforementioned lens elements is the same as the equation of the 1st embodiment. Also, the definitions of these parameters shown in Table 4C are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
Schematic Parameters

| | | | |
|---|---|---|---|
| f [mm] | 5.00 | ΣAT/f | 0.52 |
| Fno | 2.34 | ΣCT/f | 1.12 |
| HFOV [deg.] | 53.1 | f23/f56 | 0.26 |
| V2 + V3 | 112.0 | f2/f3 | 0.19 |
| (CT1 + CT2)/(CT3 + CT4) | 1.53 | f/f23 | 1.44 |
| CT5/(T45 + T56) | 0.38 | \|f/f56\| | 0.37 |
| (CT5 + CT6)/(T45 + T56) | 1.41 | f × tan(HFOV)/f23 | 1.91 |
| (CT4 + CT5 + CT6)/(T45 + | 1.59 | f × sin(HFOV)/ImgH | 0.63 |
| T56) | | | |
| \|f3/R5\| | 2.39 | f/ImgH | 0.79 |
| Dr5r8/f3 | 0.06 | TL/ImgH | 1.57 |
| f2/CT2 | 2.93 | TL/f | 1.98 |

### 5th Embodiment

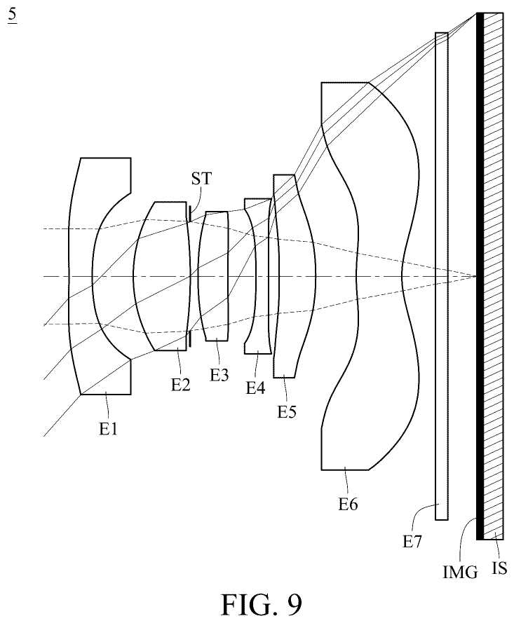

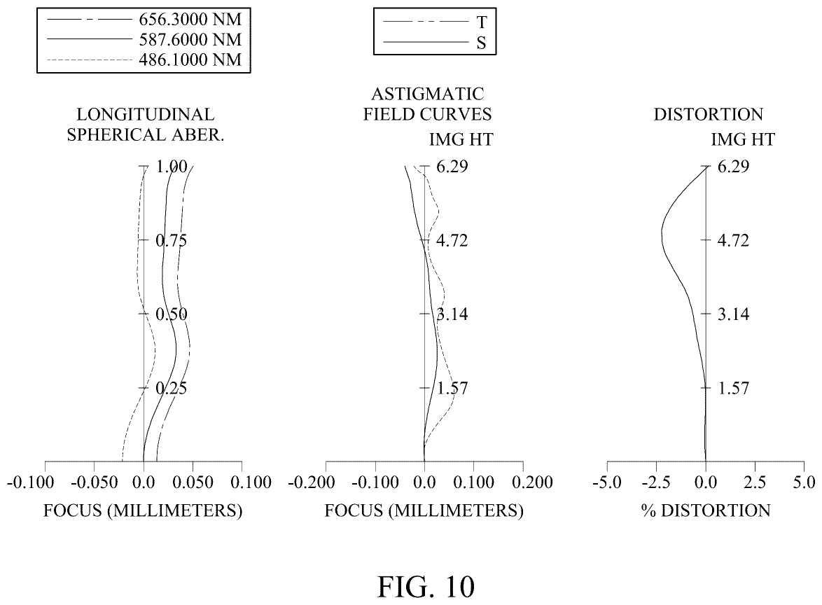

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The object-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has one inflection point. The image-side surface of the third lens element E3 has one critical point in an off-axis region thereof.

The fourth lens element E4 with negative refractive power has an object-side surface being concave in a paraxial region thereof and an image-side surface being concave in a paraxial region thereof. The fourth lens element E4 is made of plastic material and has the object-side surface and the image-side surface being both aspheric. The image-side surface of the fourth lens element E4 has two inflection points. The image-side surface of the fourth lens element E4 has two critical points in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 5th embodiment are shown in Table 5A and the aspheric surface data are shown in Table 5B below.

TABLE 5A
5th Embodiment
f = 5.55 mm, Fno = 2.44, HFOV = 48.5 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −18.2118 | (ASP) | 0.556 | Plastic | 1.545 | 56.1 | −7.85 |
| 2 | | 5.6550 | (ASP) | 0.978 | | | | |
| 3 | Lens 2 | 3.3223 | (SPH) | 1.362 | Glass | 1.593 | 68.3 | 4.40 |
| 4 | | −10.3235 | (SPH) | −0.004 | | | | |
| 5 | Ape. Stop | Plano | | 0.189 | | | | |
| 6 | Lens 3 | 7.3425 | (ASP) | 0.713 | Plastic | 1.544 | 56.0 | 19.05 |
| 7 | | 24.3245 | (ASP) | 0.672 | | | | |
| 8 | Lens 4 | −28.2557 | (ASP) | 0.300 | Plastic | 1.686 | 18.4 | −17.06 |
| 9 | | 20.0653 | (ASP) | 0.255 | | | | |
| 10 | Lens 5 | −33.3894 | (ASP) | 0.871 | Plastic | 1.544 | 56.0 | 12.38 |
| 11 | | −5.6566 | (ASP) | 0.968 | | | | |
| 12 | Lens 6 | 4.6326 | (ASP) | 1.088 | Plastic | 1.534 | 56.0 | −9.01 |
| 13 | | 2.1679 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.690 | | | | |
| 16 | Image | Plano | — | | | | |

Note:
Reference wavelength is 587.6 nm (d-line).

TABLE 5B
Aspheric Coefficients

| Surface # | 1 | 2 | 6 | 7 |
|---|---|---|---|---|
| k= | −9.00000E+01 | −1.47234E+00 | 1.68597E+00 | −2.49259E+01 |
| A4= | 2.267942967E−02 | 3.267695662E−02 | 5.488744153E−03 | −2.208702239E−02 |
| A6= | −5.094443035E−03 | 1.880687762E−02 | 1.921175389E−02 | 1.082517576E−01 |
| A8= | 1.925022091E−03 | −4.360326092E−02 | −1.232177433E−01 | −5.180497471E−01 |
| A10= | −2.044837182E−03 | 5.509046929E−02 | 4.774269778E−01 | 1.620362535E+00 |
| A12= | 1.825297726E−03 | −4.678586360E−02 | −1.200896784E+00 | −3.477113361E+00 |
| A14= | −1.052950893E−03 | 2.976535914E−02 | 2.074602331E+00 | 5.279043721E+00 |
| A16= | 4.076113965E−04 | −1.547995274E−02 | −2.539317013E+00 | −5.781537612E+00 |
| A18= | −1.097766402E−04 | 6.928522317E−03 | 2.237133675E+00 | 4.610855952E+00 |
| A20= | 2.090333400E−05 | −2.612053896E−03 | −1.423575884E+00 | −2.676912174E+00 |
| A22= | −2.809496158E−06 | 7.719709556E−04 | 6.483977859E−01 | 1.118422821E+00 |
| A24= | 2.610172410E−07 | −1.653323076E−04 | −2.060971464E−01 | −3.273470735E−01 |
| A26= | −1.596118299E−08 | 2.365760189E−05 | 4.341187060E−02 | 6.366805474E−02 |
| A28= | 5.782272421E−10 | −2.006295492E−06 | −5.444802185E−03 | −7.388608375E−03 |
| A30= | −9.403834148E−12 | 7.598853156E−08 | 3.077797686E−04 | 3.870402440E−04 |

| Surface # | 8 | 9 | 10 | 11 |
|---|---|---|---|---|
| k= | −3.72566E+00 | 0.00000E+00 | 9.00000E+01 | 3.02220E+00 |
| A4= | −1.164285592E−01 | −8.697264627E−02 | −2.972445123E−02 | −2.336854645E−02 |
| A6= | 3.385137931E−01 | 1.276733006E−01 | −5.300612447E−02 | 4.794321431E−03 |
| A8= | −8.413938724E−01 | −1.110014118E−01 | 1.758626077E−01 | 6.989501822E−03 |
| A10= | 1.496439285E+00 | 6.388273268E−02 | −2.257384283E−01 | −5.616440501E−03 |
| A12= | −1.900839890E+00 | −2.390049448E−02 | 1.741358806E−01 | 1.949164612E−03 |
| A14= | 1.720931496E+00 | 5.572829232E−03 | −8.848484665E−02 | −3.381871972E−04 |
| A16= | −1.108084424E+00 | −7.321746146E−04 | 3.037953186E−02 | 2.271247558E−05 |
| A18= | 5.020914683E−01 | 4.126392761E−05 | −6.990194741E−03 | 1.503312678E−06 |
| A20= | −1.560652163E−01 | — | 1.033222242E−03 | −3.752890152E−07 |
| A22= | 3.159470067E−02 | — | −8.861337629E−05 | 2.480922486E−08 |
| A24= | −3.740348764E−03 | — | 3.346471585E−06 | −5.805332316E−10 |
| A26= | 1.956208960E−04 | — | — | — |

| Surface # | 12 | 13 |
|---|---|---|
| k= | −1.00000E+00 | −6.93819E+00 |
| A4= | −7.121765309E−02 | −6.290312938E−03 |
| A6= | 1.785986779E−02 | −6.441837646E−03 |
| A8= | −5.854642281E−03 | 3.692585235E−03 |
| A10= | 2.452285144E−03 | −1.094470586E−03 |
| A12= | −8.401612236E−04 | 2.090513059E−04 |
| A14= | 1.955172408E−04 | −2.705293923E−05 |
| A16= | −3.038595277E−05 | 2.360019858E−06 |
| A18= | 3.198254101E−06 | −1.300599464E−07 |
| A20= | −2.292367497E−07 | 3.369478919E−09 |
| A22= | 1.103408277E−08 | 7.848157276E−11 |
| A24= | −3.413980125E−10 | −1.040061132E−11 |
| A26= | 6.133639912E−12 | 4.016065215E−13 |
| A28= | −4.861093132E−14 | −7.581483191E−15 |
| A30= | — | 5.897272668E−17 |

In the 5th embodiment, the equation of the aspheric surface profiles of the aforementioned lens elements is the same as the equation of the 1st embodiment. Also, the definitions of these parameters shown in Table 5C are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Schematic Parameters

| | | | |
|---|---|---|---|
| f [mm] | 5.55 | ΣAT/f | 0.55 |
| Fno | 2.44 | ΣCT/f | 0.88 |
| HFOV [deg.] | 48.5 | f23/f56 | −0.03 |
| V2 + V3 | 124.3 | f2/f3 | 0.23 |
| (CT1 + CT2)/(CT3 + CT4) | 1.89 | f/f23 | 1.51 |
| CT5/(T45 + T56) | 0.71 | \|f/f56\| | 0.05 |
| (CT5 + CT6)/(T45 + T56) | 1.60 | f × tan(HFOV)/f23 | 1.70 |
| (CT4 + CT5 + CT6)/(T45 + | 1.85 | f × sin(HFOV)/ImgH | 0.66 |
| T56) | | | |
| \|f3/R5\| | 2.59 | f/ImgH | 0.88 |
| Dr5r8/f3 | 0.09 | TL/ImgH | 1.55 |
| f2/CT2 | 3.23 | TL/f | 1.76 |

### 6th Embodiment

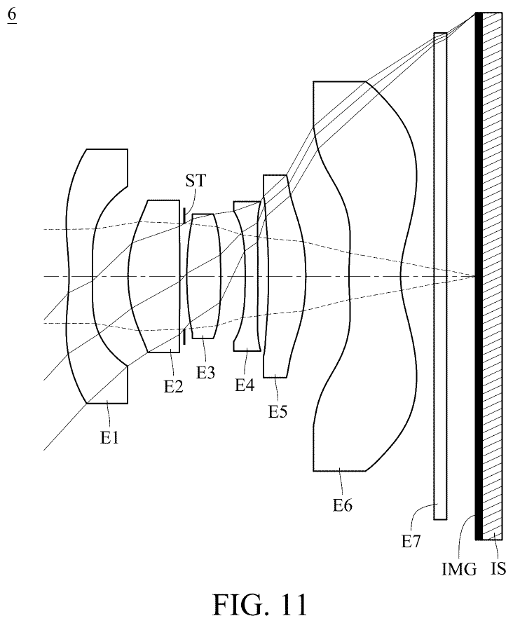

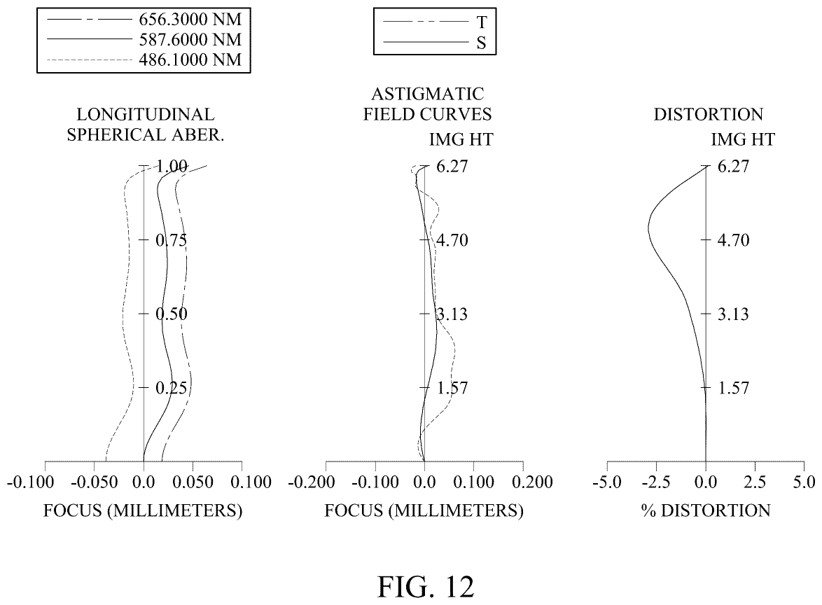

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The image-side surface of the first lens element E1 has one inflection point. The object-side surface of the first lens element E1 has one critical point in an off-axis region thereof. The image-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has two inflection points. The image-side surface of the second lens element E2 has one inflection point. The image-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric.

The fourth lens element E4 with negative refractive power has an object-side surface being concave in a paraxial region thereof and an image-side surface being concave in a paraxial region thereof. The fourth lens element E4 is made of plastic material and has the object-side surface and the image-side surface being both aspheric. The image-side surface of the fourth lens element E4 has two inflection points. The image-side surface of the fourth lens element E4 has two critical points in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 6th embodiment are shown in Table 6A and the aspheric surface data are shown in Table 6B below.

TABLE 6A
6th Embodiment
f = 5.70 mm, Fno = 2.54, HFOV = 47.6 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −4.7519 | (ASP) | 0.558 | Plastic | 1.545 | 56.1 | −10.05 |
| 2 | | −37.3487 | (ASP) | 0.852 | | | | |
| 3 | Lens 2 | 3.3249 | (ASP) | 1.238 | Plastic | 1.544 | 56.0 | 5.62 |
| 4 | | −32.8906 | (ASP) | 0.105 | | | | |
| 5 | Ape. Stop | Plano | | 0.061 | | | | |
| 6 | Lens 3 | 9.0498 | (ASP) | 0.809 | Plastic | 1.544 | 56.0 | 11.17 |
| 7 | | −17.9304 | (ASP) | 0.586 | | | | |
| 8 | Lens 4 | −17.1584 | (ASP) | 0.300 | Plastic | 1.686 | 18.4 | −16.93 |
| 9 | | 36.1930 | (ASP) | 0.253 | | | | |
| 10 | Lens 5 | −91.9755 | (ASP) | 0.894 | Plastic | 1.544 | 56.0 | 12.33 |
| 11 | | −6.2736 | (ASP) | 1.031 | | | | |
| 12 | Lens 6 | 6.0460 | (ASP) | 1.233 | Plastic | 1.534 | 56.0 | −7.83 |
| 13 | | 2.2963 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.695 | | | | |
| 16 | Image | Plano | — | | | | |

Note:
Reference wavelength is 587.6 nm (d-line).

TABLE 6B
Aspheric Coefficients

| Surface # | 1 | 2 | 3 | 4 |
|---|---|---|---|---|
| k= | −9.00000E+01 | 9.00000E+01 | −4.75126E−01 | −1.65495E+01 |
| A4= | −1.805034297E−02 | 1.016315803E−01 | 8.015697068E−03 | 9.696181029E−03 |
| A6= | 5.360257533E−02 | −1.607453692E−01 | −5.818353975E−03 | −5.365149345E−03 |
| A8= | −5.042670146E−02 | 3.810842218E−01 | 3.078032393E−03 | 4.237265483E−03 |
| A10= | 3.172580334E−02 | −6.357944490E−01 | −1.799423388E−03 | −5.193693019E−03 |
| A12= | −1.435202939E−02 | 7.326654499E−01 | 6.628147055E−04 | 4.038988660E−03 |
| A14= | 4.774852766E−03 | −5.976050514E−01 | −1.624284801E−04 | −1.589854469E−03 |
| A16= | −1.180539981E−03 | 3.517449988E−01 | 1.796775363E−05 | 2.583230788E−04 |
| A18= | 2.175429641E−04 | −1.508883147E−01 | — | — |
| A20= | −2.973428528E−05 | 4.717718112E−02 | — | — |
| A22= | 2.970662516E−06 | −1.063080846E−02 | — | — |
| A24= | −2.106999984E−07 | 1.680816689E−03 | — | — |
| A26= | 1.004733645E−08 | −1.768844512E−04 | — | — |
| A28= | −2.888537759E−10 | 1.112460730E−05 | — | — |
| A30= | 3.783833556E−12 | −3.163108778E−07 | — | — |

| Surface # | 6 | 7 | 8 | 9 |
|---|---|---|---|---|
| k= | 1.72068E+00 | 8.93279E+01 | 1.03869E+01 | 0.00000E+00 |
| A4= | 1.181188313E−02 | −1.629708250E−02 | −5.720454793E−02 | −6.371287103E−02 |
| A6= | 1.527165589E−02 | −2.448073588E−02 | 3.230337119E−02 | 8.285376953E−02 |
| A8= | −1.222799978E−01 | 1.233384159E−01 | 5.612120787E−02 | −6.523656149E−02 |
| A10= | 4.684074088E−01 | −3.960748482E−01 | −2.823569173E−01 | 3.776976284E−02 |
| A12= | −1.193300971E+00 | 8.106464941E−01 | 5.500900114E−01 | −1.501962401E−02 |
| A14= | 2.132101830E+00 | −1.114454747E+00 | −6.606350817E−01 | 3.836904480E−03 |
| A16= | −2.738075805E+00 | 1.057204293E+00 | 5.318638215E−01 | −5.613557960E−04 |
| A18= | 2.556228570E+00 | −6.952260330E−01 | −2.924743819E−01 | 3.544406787E−05 |
| A20= | −1.735927408E+00 | 3.106552278E−01 | 1.085379443E−01 | — |
| A22= | 8.483548866E−01 | −8.848351522E−02 | −2.600476840E−02 | — |
| A24= | −2.906437876E−01 | 1.311436997E−02 | 3.630584278E−03 | — |
| A26= | 6.625203583E−02 | 7.090884387E−05 | −2.242533445E−04 | — |
| A28= | −9.024405314E−03 | −3.276923442E−04 | — | — |
| A30= | 5.556583385E−04 | 3.460675749E−05 | — | — |
| Surface # | 10 | 11 | 12 | 13 |
| k= | 9.00000E+01 | 4.41365E+00 | −1.00000E+00 | −7.39323E+00 |
| A4= | −4.909820935E−02 | −2.528811809E−02 | −6.799975082E−02 | −6.678618493E−03 |
| A6= | 2.443622866E−02 | 5.555417808E−03 | 1.645071062E−02 | −5.623086262E−03 |
| A8= | 2.624262901E−02 | 1.194915632E−02 | −5.648156704E−03 | 3.268881739E−03 |
| A10= | −6.061524269E−02 | −1.713150431E−02 | 2.494693099E−03 | −9.701325399E−04 |
| A12= | 5.940703006E−02 | 1.331944642E−02 | −8.741428916E−04 | 1.838390223E−04 |
| A14= | −3.575542214E−02 | −6.877527663E−03 | 2.076869113E−04 | −2.327007931E−05 |
| A16= | 1.405959238E−02 | 2.476680702E−03 | −3.297953805E−05 | 1.939818285E−06 |
| A18= | −3.618793059E−03 | −6.287356833E−04 | 3.541052509E−06 | −9.661821905E−08 |
| A20= | 5.867423166E−04 | 1.121928258E−04 | −2.581595075E−07 | 1.566078386E−09 |
| A22= | −5.426572425E−05 | −1.390696522E−05 | 1.259904442E−08 | 1.373754474E−10 |
| A24= | 2.177487122E−06 | 1.167986292E−06 | −3.940611288E−10 | −1.115543271E−11 |
| A26= | — | −6.324628537E−08 | 7.138414261E−12 | 3.840022916E−13 |
| A28= | — | 1.989627137E−09 | −5.692137246E−14 | −6.793364678E−15 |
| A30= | — | −2.760379363E−11 | — | 5.036869902E−17 |

In the 6th embodiment, the equation of the aspheric surface profiles of the aforementioned lens elements is the same as the equation of the 1st embodiment. Also, the definitions of these parameters shown in Table 6C are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Schematic Parameters

| | | | |
|---|---|---|---|
| f [mm] | 5.70 | ΣAT/f | 0.51 |
| Fno | 2.54 | ΣCT/f | 0.88 |
| HFOV [deg.] | 47.6 | f23/f56 | −0.08 |
| V2 + V3 | 112.0 | f2/f3 | 0.50 |
| (CT1 + CT2)/(CT3 + CT4) | 1.62 | f/f23 | 1.43 |
| CT5/(T45 + T56) | 0.70 | \|f/f56\| | 0.12 |
| (CT5 + CT6)/(T45 + T56) | 1.66 | f × tan(HFOV)/f23 | 1.56 |
| (CT4 + CT5 + CT6)/ | 1.89 | f × sin(HFOV)/ImgH | 0.67 |
| (T45 + T56) | | | |
| \|f3/R5\| | 1.23 | f/ImgH | 0.91 |
| Dr5r8/f3 | 0.15 | TL/ImgH | 1.55 |
| f2/CT2 | 4.54 | TL/f | 1.71 |

### 7th Embodiment

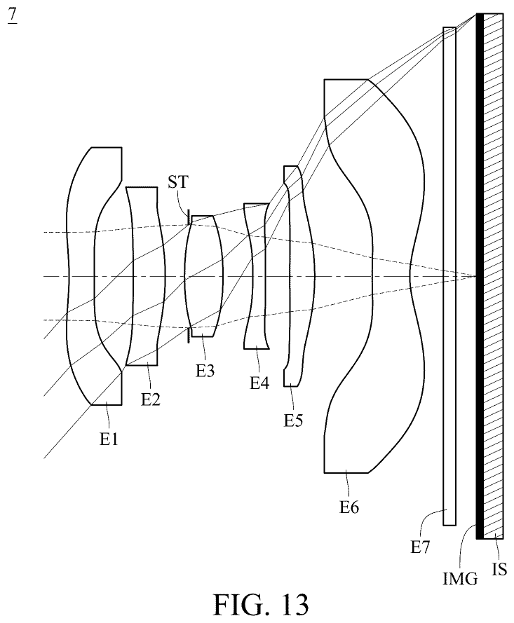

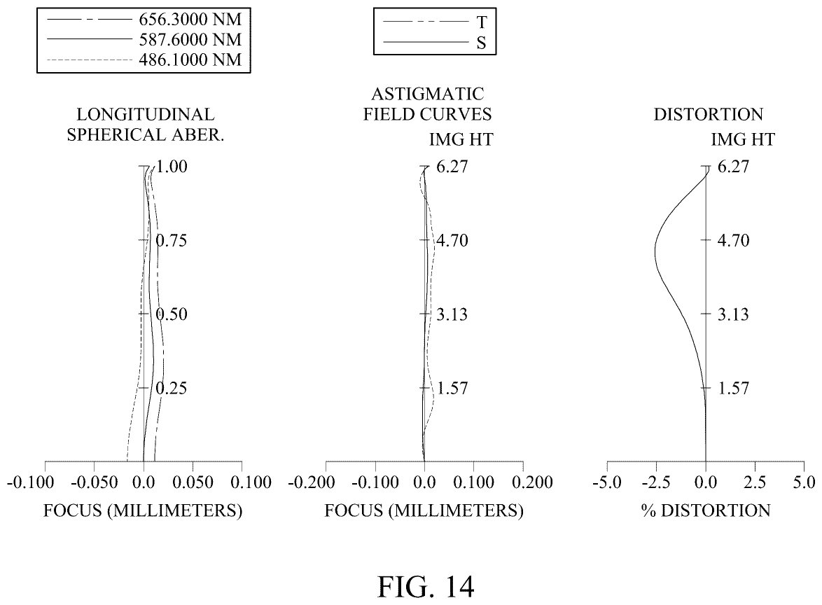

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The image-side surface of the first lens element E1 has three inflection points. The object-side surface of the first lens element E1 has one critical point in an off-axis region thereof. The image-side surface of the first lens element E1 has one critical point in an off-axis region thereof.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The image-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric.

The fourth lens element E4 with negative refractive power has an object-side surface being concave in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has two inflection points. The image-side surface of the fourth lens element E4 has two critical points in an off-axis region thereof.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has two inflection points. The object-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 7th embodiment are shown in Table 7A and the aspheric surface data are shown in Table 7B below.

TABLE 7A
7th Embodiment
f = 5.54 mm, Fno = 2.64, HFOV = 48.5 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −6.2440 | (ASP) | 0.607 | Plastic | 1.545 | 56.1 | −15.57 |
| 2 | | −24.4749 | (ASP) | 0.926 | | | | |
| 3 | Lens 2 | −44.6688 | (ASP) | 0.765 | Plastic | 1.544 | 56.0 | 10.63 |
| 4 | | −5.1494 | (ASP) | 0.555 | | | | |
| 5 | Ape. Stop | Plano | | −0.094 | | | | |
| 6 | Lens 3 | 6.2863 | (ASP) | 0.918 | Glass | 1.497 | 81.6 | 6.31 |
| 7 | | −5.9581 | (ASP) | 0.712 | | | | |
| 8 | Lens 4 | −9.3125 | (ASP) | 0.300 | Plastic | 1.660 | 20.4 | −10.69 |
| 9 | | 29.4255 | (ASP) | 0.581 | | | | |
| 10 | Lens 5 | 40.3265 | (ASP) | 0.596 | Plastic | 1.566 | 37.4 | 8.28 |
| 11 | | −5.2744 | (ASP) | 1.372 | | | | |
| 12 | Lens 6 | 10.0304 | (ASP) | 0.899 | Plastic | 1.534 | 56.0 | −5.62 |
| 13 | | 2.2392 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.497 | | | | |
| 16 | Image | Plano | — | | | | |

Note:
Reference wavelength is 587.6 nm (d-line).

TABLE 7B
Aspheric Coefficients

| Surface # | 1 | 2 | 3 | 4 |
|---|---|---|---|---|
| k= | −9.00000E+01 | 6.59748E+01 | −2.04202E+00 | 4.48347E+00 |
| A4= | −6.519202344E−03 | 5.031701144E−02 | −6.208737805E−04 | 1.863421769E−02 |
| A6= | 2.535778050E−02 | −2.627427893E−02 | −5.542674323E−03 | −1.013436391E−02 |
| A8= | −2.049887655E−02 | 4.769680743E−02 | 5.761627360E−03 | 1.580876194E−02 |
| A10= | 1.147710918E−02 | −6.708070361E−02 | −5.070825348E−03 | −1.993244341E−02 |
| A12= | −4.696782410E−03 | 6.610191575E−02 | 3.453793153E−03 | 1.842044408E−02 |
| A14= | 1.416893476E−03 | −4.592876899E−02 | −1.883182219E−03 | −1.144562738E−02 |
| A16= | −3.151441144E−04 | 2.277201005E−02 | 8.129609267E−04 | 4.350392315E−03 |
| A18= | 5.135580102E−05 | −8.074085228E−03 | −2.688012525E−04 | −7.047422298E−04 |
| A20= | −6.038913136E−06 | 2.026739071E−03 | 6.363837165E−05 | −1.510951631E−04 |
| A22= | 4.975635911E−07 | −3.508578372E−04 | −9.825092822E−06 | 1.028674058E−04 |
| A24= | −2.719901403E−08 | 3.973611296E−05 | 8.684017134E−07 | −2.074078080E−05 |
| A26= | 8.844246964E−10 | −2.642962348E−06 | −3.303452701E−08 | 1.560413151E−06 |
| A28= | −1.292520217E−11 | 7.810927222E−08 | — | — |

| Surface # | 6 | 7 | 8 | 9 |
|---|---|---|---|---|
| k= | 8.36545E+00 | −1.06485E+00 | −6.99367E+01 | 0.00000E+00 |
| A4= | 1.642223941E−02 | −2.314608165E−02 | −8.389408294E−02 | −6.035077886E−02 |
| A6= | −6.634668771E−03 | 1.389358425E−02 | 4.424821136E−02 | 3.615830001E−02 |
| A8= | 1.407354144E−02 | −4.606404624E−02 | −1.512418890E−02 | −5.758992566E−03 |
| A10= | −7.321113219E−02 | 1.138425629E−01 | −1.246733865E−03 | −1.132845096E−02 |
| A12= | 2.209584842E−01 | −1.847826765E−01 | 2.379099881E−02 | 2.440140797E−02 |
| A14= | −4.202067462E−01 | 2.005342741E−01 | −3.355286304E−02 | −2.455785570E−02 |
| A16= | 5.283793704E−01 | −1.451984763E−01 | 2.464974901E−02 | 1.515678372E−02 |
| A18= | −4.451619455E−01 | 6.895381798E−02 | −1.101498929E−02 | −6.171655689E−03 |
| A20= | 2.483825706E−01 | −2.053010749E−02 | 3.024651260E−03 | 1.677394260E−03 |
| A22= | −8.794038099E−02 | 3.457039752E−03 | −4.714360617E−04 | −2.942252802E−04 |
| A24= | 1.785581700E−02 | −2.494741342E−04 | 3.201331288E−05 | 3.018121002E−05 |
| A26= | −1.579392857E−03 | — | — | −1.375382592E−06 |
| Surface # | 10 | 11 | 12 | 13 |
| k= | 8.53844E+01 | 1.32845E+00 | −1.00000E+00 | −5.78191E+00 |
| A4= | −1.142949891E−02 | −4.219445457E−04 | −6.727012180E−02 | −2.629909840E−02 |
| A6= | 1.042380898E−02 | 9.759235334E−03 | 1.643268322E−02 | 5.559345695E−03 |
| A8= | −2.060746430E−02 | −1.247431781E−02 | −4.786184304E−03 | −9.250664948E−04 |
| A10= | 2.642153947E−02 | 1.051441606E−02 | 1.575235986E−03 | 1.054278081E−04 |
| A12= | −2.216222458E−02 | −5.450340925E−03 | −4.605592051E−04 | −6.839603541E−06 |
| A14= | 1.271211464E−02 | 1.605211541E−03 | 9.964696870E−05 | −1.273427518E−07 |
| A16= | −5.036626336E−03 | −1.404972630E−04 | −1.465270960E−05 | 9.136962393E−08 |
| A18= | 1.378592485E−03 | −7.319129116E−05 | 1.432025517E−06 | −1.184061549E−08 |
| A20= | −2.571200673E−04 | 3.093558224E−05 | −9.165145814E−08 | 9.043132177E−10 |
| A22= | 3.133574278E−05 | −5.699912443E−06 | 3.698195727E−09 | −4.487871469E−11 |
| A24= | −2.257606537E−06 | 5.846606483E−07 | −8.553087127E−11 | 1.420458015E−12 |
| A26= | 7.303400700E−08 | −3.247102476E−08 | 8.660050433E−13 | −2.602867016E−14 |
| A28= | — | 7.648082028E−10 | — | 2.096276431E−16 |

In the 7th embodiment, the equation of the aspheric surface profiles of the aforementioned lens elements is the same as the equation of the 1st embodiment. Also, the definitions of these parameters shown in Table 7C are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
Schematic Parameters

| | | | |
|---|---|---|---|
| f [mm] | 5.54 | ΣAT/f | 0.73 |
| Fno | 2.64 | ΣCT/f | 0.74 |
| HFOV [deg.] | 48.5 | f23/f56 | −0.04 |
| V2 + V3 | 137.5 | f2/f3 | 1.68 |
| (CT1 + CT2)/(CT3 + CT4) | 1.13 | f/f23 | 1.34 |
| CT5/(T45 + T56) | 0.31 | \|f/f56\| | 0.05 |
| (CT5 + CT6)/(T45 + T56) | 0.77 | f × tan(HFOV)/f23 | 1.51 |
| (CT4 + CT5 + CT6)/ | 0.92 | f × sin(HFOV)/ImgH | 0.66 |
| (T45 + T56) | | | |
| \|f3/R5\| | 1.00 | f/ImgH | 0.88 |
| Dr5r8/f3 | 0.31 | TL/ImgH | 1.55 |
| f2/CT2 | 13.89 | TL/f | 1.76 |

### 8th Embodiment

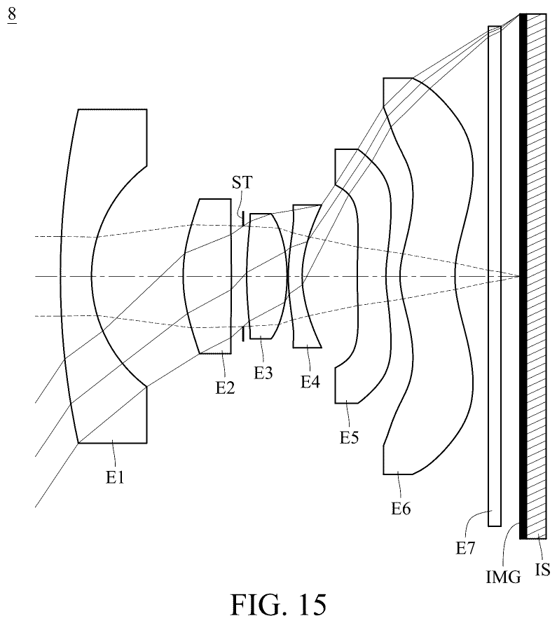

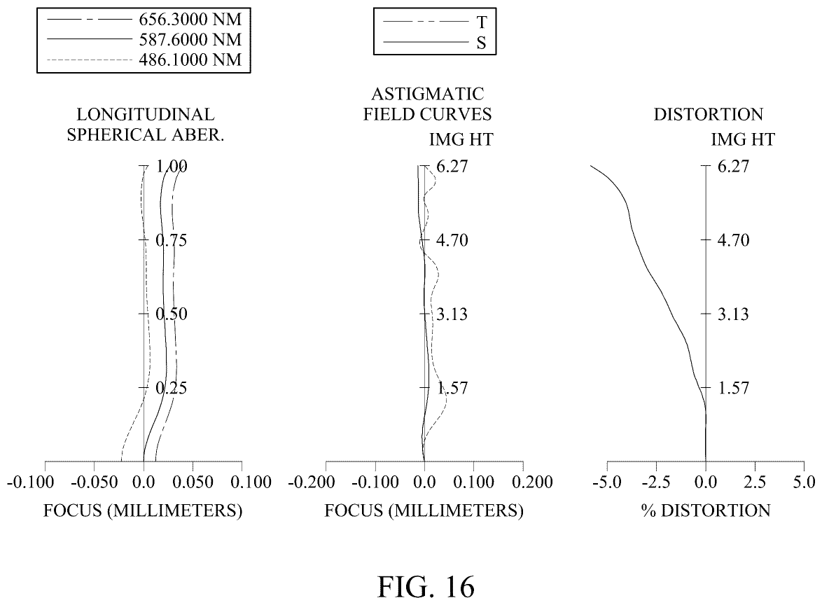

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The image-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has four inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 8th embodiment are shown in Table 8A and the aspheric surface data are shown in Table 8B below.

TABLE 8A
8th Embodiment
f = 4.46 mm, Fno = 2.34, HFOV = 56.2 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 18.7749 | (SPH) | 0.743 | Glass | 1.517 | 64.2 | −7.86 |
| 2 | | 3.2946 | (SPH) | 2.190 | | | | |
| 3 | Lens 2 | 3.5455 | (ASP) | 1.153 | Plastic | 1.544 | 56.0 | 6.29 |
| 4 | | −87.5092 | (ASP) | 0.284 | | | | |
| 5 | Ape. Stop | Plano | | 0.082 | | | | |
| 6 | Lens 3 | 8.7417 | (ASP) | 0.965 | Plastic | 1.544 | 56.0 | 5.10 |
| 7 | | −3.9030 | (ASP) | 0.030 | | | | |
| 8 | Lens 4 | 4.0081 | (ASP) | 0.330 | Plastic | 1.686 | 18.4 | −9.87 |
| 9 | | 2.4335 | (ASP) | 1.317 | | | | |
| 10 | Lens 5 | 10.1028 | (ASP) | 0.684 | Plastic | 1.544 | 56.0 | −6.72 |
| 11 | | 2.6199 | (ASP) | 0.338 | | | | |
| 12 | Lens 6 | 1.8201 | (ASP) | 1.313 | Plastic | 1.544 | 56.0 | 6.78 |
| 13 | | 2.6801 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.452 | | | | |
| 16 | Image | Plano | — | | | | |

Note:
Reference wavelength is 587.6 nm (d-line).

TABLE 8B
Aspheric Coefficients

| Surface # | 3 | 4 | 6 | 7 |
|---|---|---|---|---|
| k= | −1.35544E+00 | 9.00000E+01 | −3.63311E+00 | 1.35137E+00 |
| A4= | −4.289948300E−03 | −3.755131661E−03 | −8.407840397E−03 | −6.676640065E−02 |
| A6= | −1.783153107E−04 | −2.969632867E−03 | 4.183724857E−02 | 2.950274263E−01 |
| A8= | −1.307455709E−03 | 7.530147021E−03 | −2.521221592E−01 | −8.763813385E−01 |
| A10= | 9.380507417E−04 | −7.186422078E−03 | 9.597331314E−01 | 1.807723358E+00 |
| A12= | −3.694090975E−04 | 4.192342659E−03 | −2.478404785E+00 | −2.655134022E+00 |
| A14= | 8.239872455E−05 | −1.269057422E−03 | 4.538628743E+00 | 2.777260857E+00 |
| A16= | −7.482611981E−06 | 1.616169763E−04 | −6.043337162E+00 | −2.042253545E+00 |
| A18= | — | — | 5.914875823E+00 | 1.017298832E+00 |
| A20= | — | — | −4.250317021E+00 | −3.093221897E−01 |
| A22= | — | — | 2.211988790E+00 | 3.465894496E−02 |
| A24= | — | — | −8.094378985E−01 | 1.212169693E−02 |
| A26= | — | — | 1.970272222E−01 | −5.775052463E−03 |
| A28= | — | — | −2.857424318E−02 | 9.685099994E−04 |
| A30= | — | — | 1.864245679E−03 | −6.130728215E−05 |
| Surface # | 8 | 9 | 10 | 11 |
| k= | −3.58847E−01 | −7.39410E−01 | −8.39508E+01 | −2.13671E+01 |
| A4= | −1.006269012E−01 | −4.679815127E−02 | −4.234323169E−02 | −6.552508006E−02 |
| A6= | 2.745211849E−01 | 1.184264390E−02 | 4.579302254E−03 | 4.107983180E−02 |
| A8= | −7.275186596E−01 | 1.065968617E−01 | 1.158935885E−01 | −9.636664063E−03 |
| A10= | 1.404342172E+00 | −4.007797242E−01 | −2.805738913E−01 | −4.571801309E−03 |
| A12= | −1.950215926E+00 | 8.269762514E−01 | 3.691562451E−01 | 4.753223971E−03 |
| A14= | 1.943886102E+00 | −1.141119558E+00 | −3.229330658E−01 | −2.023585318E−03 |
| A16= | −1.385504244E+00 | 1.111446639E+00 | 1.991774263E−01 | 5.381441202E−04 |
| A18= | 6.978221483E−01 | −7.797778912E−01 | −8.852482913E−02 | −9.800687896E−05 |
| A20= | −2.420331942E−01 | 3.956305681E−01 | 2.847038627E−02 | 1.261681766E−05 |
| A22= | 5.492602857E−02 | −1.437940680E−01 | −6.561258791E−03 | −1.156225900E−06 |
| A24= | −7.334541870E−03 | 3.648793265E−02 | 1.055467510E−03 | 7.455803283E−08 |
| A26= | 4.365777733E−04 | −6.136563370E−03 | −1.124390386E−04 | −3.256916796E−09 |
| A28= | — | 6.144770654E−04 | 7.121384988E−06 | 8.767354833E−11 |
| A30= | — | −2.772475691E−05 | −2.027979009E−07 | −1.109156657E−12 |

| Surface # | 12 | 13 |
|---|---|---|
| k= | −7.45588E+00 | −1.87138E+00 |
| A4= | −1.288968864E−02 | −2.101754055E−02 |
| A6= | −2.316033040E−02 | −7.770915850E−03 |
| A8= | 2.357582630E−02 | 6.544992027E−03 |
| A10= | −1.211237285E−02 | −2.204359650E−03 |
| A12= | 3.944114147E−03 | 4.346429528E−04 |
| A14= | −8.715110419E−04 | −5.323767572E−05 |
| A16= | 1.347343215E−04 | 3.828607285E−06 |
| A18= | −1.479810544E−05 | −1.007730991E−07 |
| A20= | 1.159762147E−06 | −8.704494020E−09 |
| A22= | −6.437501234E−08 | 1.094023945E−09 |
| A24= | 2.471595040E−09 | −5.743291942E−11 |
| A26= | −6.241982801E−11 | 1.701124520E−12 |
| A28= | 9.328055693E−13 | −2.771638281E−14 |
| A30= | −6.249188410E−15 | 1.941599590E−16 |

In the 8th embodiment, the equation of the aspheric surface profiles of the aforementioned lens elements is the same as the equation of the 1st embodiment. Also, the definitions of these parameters shown in Table 8C are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Schematic Parameters

| | | | |
|---|---|---|---|
| f [mm] | 4.46 | ΣAT/f | 0.95 |
| Fno | 2.34 | ΣCT/f | 1.16 |
| HFOV [deg.] | 56.2 | f23/f56 | −0.08 |
| V2 + V3 | 112.0 | f2/f3 | 1.23 |
| (CT1 + CT2)/(CT3 + CT4) | 1.46 | f/f23 | 1.37 |
| CT5/(T45 + T56) | 0.41 | \|f/f56\| | 0.10 |
| (CT5 + CT6)/(T45 + T56) | 1.21 | f × tan(HFOV)/f23 | 2.04 |
| (CT4 + CT5 + CT6)/ | 1.41 | f × sin(HFOV)/ImgH | 0.59 |
| (T45 + T56) | | | |
| \|f3/R5\| | 0.58 | f/ImgH | 0.71 |
| Dr5r8/f3 | 0.26 | TL/ImgH | 1.75 |
| f2/CT2 | 5.46 | TL/f | 2.46 |

### 9th Embodiment

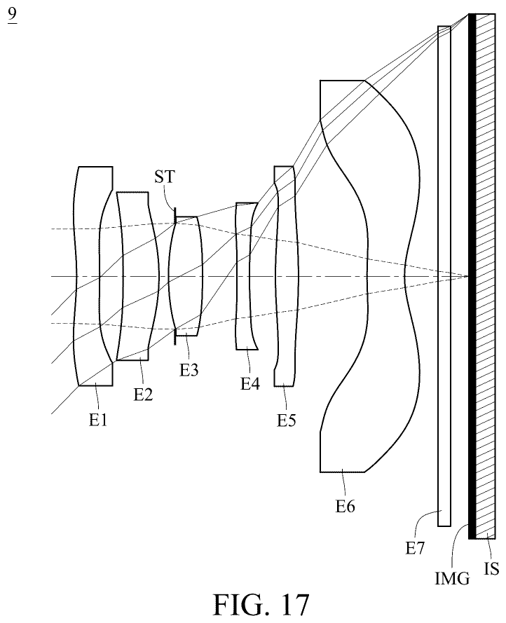

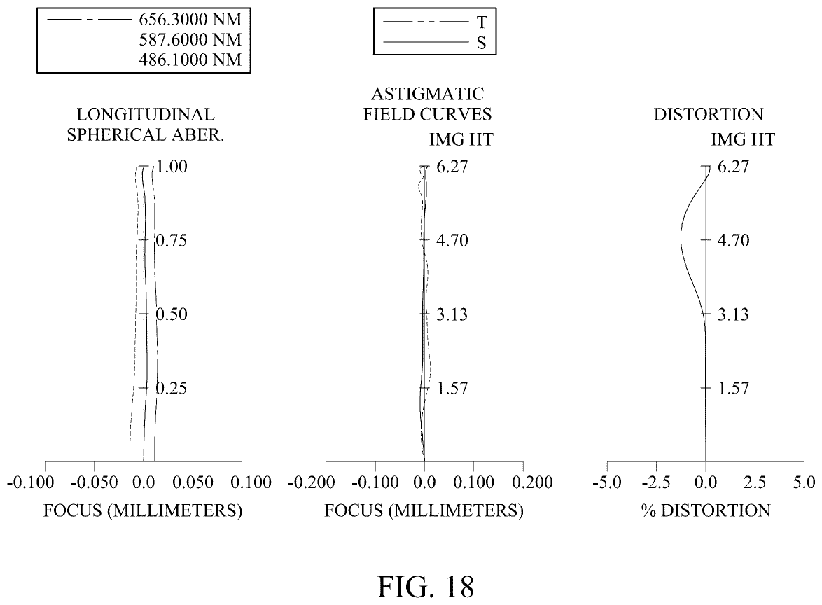

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The image-side surface of the first lens element E1 has one inflection point. The object-side surface of the first lens element E1 has one critical point in an off-axis region thereof. The image-side surface of the first lens element E1 has one critical point in an off-axis region thereof.

The second lens element E2 with positive refractive power has an object-side surface being concave in a paraxial region thereof and an image-side surface being convex in a paraxial region thereof. The second lens element E2 is made of glass material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has two inflection points. The object-side surface of the fourth lens element E4 has two critical points in an off-axis region thereof.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has one critical point in an off-axis region thereof. The image-side surface of the fifth lens element E5 has two critical points in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection points. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 9th embodiment are shown in Table 9A and the aspheric surface data are shown in Table 9B below.

TABLE 9A
9th Embodiment
f = 6.06 mm, Fno = 2.68, HFOV = 45.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −6.5305 | (ASP) | 0.550 | Plastic | 1.545 | 56.1 | −21.34 |
| 2 | | −15.3394 | (ASP) | 0.562 | | | | |
| 3 | Lens 2 | −23.7284 | (ASP) | 0.856 | Glass | 1.497 | 81.6 | 11.66 |
| 4 | | −4.7134 | (ASP) | 0.383 | | | | |
| 5 | Ape. Stop | Plano | | −0.156 | | | | |
| 6 | Lens 3 | 5.2454 | (ASP) | 0.812 | Glass | 1.497 | 81.6 | 8.17 |
| 7 | | −17.0350 | (ASP) | 0.820 | | | | |
| 8 | Lens 4 | 32.8355 | (ASP) | 0.300 | Plastic | 1.669 | 19.5 | −14.79 |
| 9 | | 7.5743 | (ASP) | 0.623 | | | | |
| 10 | Lens 5 | 9.6828 | (ASP) | 0.550 | Plastic | 1.566 | 37.4 | 10.03 |
| 11 | | −13.4540 | (ASP) | 1.639 | | | | |
| 12 | Lens 6 | 7.6780 | (ASP) | 0.895 | Plastic | 1.534 | 56.0 | −6.27 |
| 13 | | 2.2369 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.436 | | | | |
| 16 | Image | Plano | — | | | | |

Note:
Reference wavelength is 587.6 nm (d-line).

TABLE 9B
Aspheric Coefficients

| Surface # | 1 | 2 | 3 | 4 |
|---|---|---|---|---|
| k= | −9.00000E+01 | 4.05819E+01 | −8.82845E+00 | 4.20382E+00 |
| A4= | −1.445260703E−02 | 3.459982340E−02 | −1.204154922E−02 | −1.785117462E−03 |
| A6= | 3.036648346E−02 | −8.767132605E−03 | 1.996467895E−03 | 1.392703281E−02 |
| A8= | −2.677682210E−02 | 1.962051644E−02 | 1.323130831E−04 | −8.421058020E−03 |
| A10= | 1.782518889E−02 | −3.437330154E−02 | 2.200147671E−05 | 4.479382514E−03 |
| A12= | −8.958720473E−03 | 4.165818966E−02 | 7.232893076E−06 | −1.526808524E−03 |
| A14= | 3.347602498E−03 | −3.541700518E−02 | −2.400104968E−05 | 2.996904867E−04 |
| A16= | −9.224682581E−04 | 2.141010768E−02 | 5.406747361E−06 | −2.385559903E−05 |
| A18= | 1.857466506E−04 | −9.242490461E−03 | −2.015506704E−07 | — |
| A20= | −2.689426659E−05 | 2.827894986E−03 | — | — |
| A22= | 2.718298485E−06 | −5.989490283E−04 | — | — |
| A24= | −1.815643988E−07 | 8.349120107E−05 | — | — |
| A26= | 7.183700282E−09 | −6.887689003E−06 | — | — |
| A28= | −1.272075031E−10 | 2.547180027E−07 | — | — |
| Surface # | 6 | 7 | 8 | 9 |
| k= | 1.60767E+00 | 4.14086E+01 | 7.16676E+01 | 0.00000E+00 |
| A4= | −2.209557835E−03 | −2.449122627E−02 | −6.660534074E−02 | −7.051994514E−02 |
| A6= | 6.226094076E−03 | 4.357157288E−04 | 4.935773467E−02 | 6.353761870E−02 |
| A8= | 4.005977298E−02 | 2.456152101E−02 | −2.873461794E−02 | −6.583073376E−02 |
| A10= | −1.964204642E−01 | −7.188426064E−02 | 1.446516196E−02 | 8.731264221E−02 |
| A12= | 4.966352115E−01 | 1.286863379E−01 | 3.586363573E−03 | −9.560233208E−02 |
| A14= | −8.094518063E−01 | −1.519745219E−01 | −1.234226784E−02 | 7.972112552E−02 |
| A16= | 8.917124520E−01 | 1.199100896E−01 | 9.370333927E−03 | −4.877640312E−02 |
| A18= | −6.703227025E−01 | −6.253290547E−02 | −3.829362630E−03 | 2.120018388E−02 |
| A20= | 3.386921262E−01 | 2.068123954E−02 | 9.180294892E−04 | −6.324549725E−03 |
| A22= | −1.098983397E−01 | −3.927381933E−03 | −1.219071670E−04 | 1.227892958E−03 |
| A24= | 2.065328875E−02 | 3.259018462E−04 | 6.931691546E−06 | −1.395726368E−04 |
| A26= | −1.705237412E−03 | — | — | 7.042080386E−06 |

| Surface # | 10 | 11 | 12 | 13 |
|---|---|---|---|---|
| k= | −3.32713E+01 | 9.60301E+00 | −1.00000E+00 | −4.96947E+00 |
| A4= | −1.379672848E−02 | −2.980975485E−03 | −6.507794478E−02 | −3.329953398E−02 |
| A6= | 9.239187045E−03 | 1.139798928E−02 | 1.474671014E−02 | 9.195319557E−03 |
| A8= | −8.972775433E−03 | −1.355056186E−02 | −2.744413198E−03 | −1.982294223E−03 |
| A10= | 7.883621069E−03 | 1.332841521E−02 | 3.698547534E−04 | 2.942014345E−04 |
| A12= | −5.856648968E−03 | −9.770032988E−03 | −3.827016106E−05 | −2.485347569E−05 |
| A14= | 3.311156025E−03 | 5.060175908E−03 | 4.131269261E−06 | −1.156739028E−07 |
| A16= | −1.302717619E−03 | −1.820128689E−03 | −4.216609375E−07 | 3.351052027E−07 |
| A18= | 3.415917072E−04 | 4.542806985E−04 | 2.874946407E−08 | −4.701618873E−08 |
| A20= | −5.804070650E−05 | −7.841412301E−05 | −1.063858823E−09 | 3.619222879E−09 |
| A22= | 6.102972840E−06 | 9.192342215E−06 | 1.616203807E−11 | −1.742513576E−10 |
| A24= | −3.604248791E−07 | −6.991284116E−07 | — | 5.229115626E−12 |
| A26= | 9.233014058E−09 | 3.113513129E−08 | — | −8.973532128E−14 |
| A28= | — | −6.165124281E−10 | — | 6.737078387E−16 |

In the 9th embodiment, the equation of the aspheric surface profiles of the aforementioned lens elements is the same as the equation of the 1st embodiment. Also, the definitions of these parameters shown in Table 9C are the same as those stated in the 1st embodiment with corresponding values for the 9th embodiment, so an explanation in this regard will not be provided again.

Moreover, these parameters can be calculated from Table 9A and Table 9B as the following values and satisfy the following conditions:

TABLE 9C
Schematic Parameters

| | | | |
|---|---|---|---|
| f [mm] | 6.06 | ΣAT/f | 0.64 |
| Fno | 2.68 | ΣCT/f | 0.65 |
| HFOV [deg.] | 45.9 | f23/f56 | −0.08 |
| V2 + V3 | 163.1 | f2/f3 | 1.43 |
| (CT1 + CT2)/(CT3 + CT4) | 1.26 | f/f23 | 1.25 |
| CT5/(T45 + T56) | 0.24 | \|f/f56\| | 0.10 |
| (CT5 + CT6)/(T45 + T56) | 0.64 | f × tan(HFOV)/f23 | 1.29 |
| (CT4 + CT5 + CT6)/ | 0.77 | f × sin(HFOV)/ImgH | 0.69 |
| (T45 + T56) | | | |
| \|f3/R5\| | 1.56 | f/ImgH | 0.97 |
| Dr5r8/f3 | 0.24 | TL/ImgH | 1.49 |
| f2/CT2 | 13.62 | TL/f | 1.55 |

### 10th Embodiment

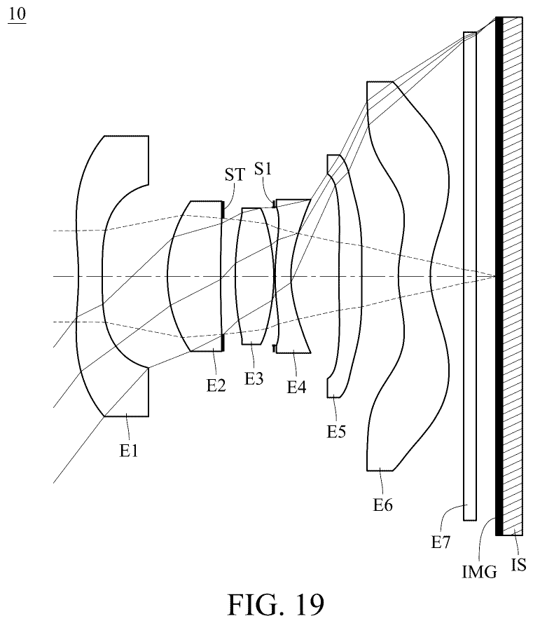

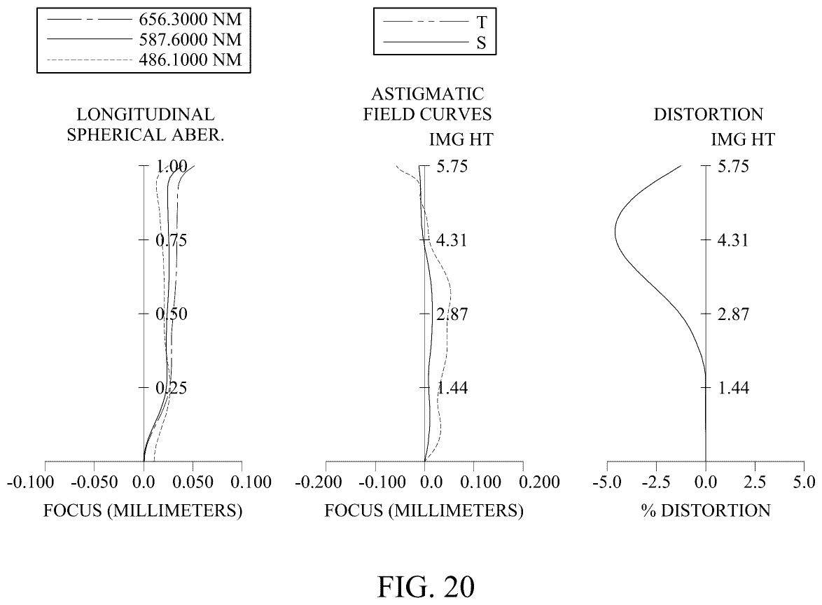

FIG. 19 is a schematic view of an image capturing unit according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit 10 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a stop S1, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The object-side surface of the first lens element E1 has one critical point in an off-axis region thereof.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The object-side surface of the fourth lens element E4 has one critical point in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has three inflection points. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 10th embodiment are shown in Table 10A and the aspheric surface data are shown in Table 10B below.

TABLE 10A
10th Embodiment
f = 4.67 mm, Fno = 2.14, HFOV = 52.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −6.4248 | (ASP) | 0.565 | Glass | 1.693 | 53.2 | −7.28 |
| 2 | | 24.3844 | (ASP) | 1.558 | | | | |
| 3 | Lens 2 | 3.1763 | (SPH) | 1.272 | Glass | 1.603 | 60.6 | 5.72 |
| 4 | | 34.2325 | (SPH) | 0.069 | | | | |
| 5 | Ape. Stop | Plano | | 0.282 | | | | |
| 6 | Lens 3 | 7.3979 | (ASP) | 0.923 | Plastic | 1.544 | 56.0 | 4.59 |
| 7 | | −3.6033 | (ASP) | −0.001 | | | | |
| 8 | Stop | Plano | | 0.031 | | | | |
| 9 | Lens 4 | 5.4428 | (ASP) | 0.377 | Plastic | 1.686 | 18.4 | −6.90 |
| 10 | | 2.4597 | (ASP) | 1.146 | | | | |
| 11 | Lens 5 | 16.5613 | (ASP) | 0.550 | Plastic | 1.544 | 56.0 | 39.06 |
| 12 | | 74.1840 | (ASP) | 0.872 | | | | |
| 13 | Lens 6 | 2.8193 | (ASP) | 0.764 | Plastic | 1.544 | 56.0 | −18.98 |
| 14 | | 2.0031 | (ASP) | 0.800 | | | | |

| | | | | | | | |
|---|---|---|---|---|---|---|---|
| 15 | Filter | Plano | 0.300 | Glass | 1.517 | 64.2 | — |
| 16 | | Plano | 0.470 | | | | |
| 17 | Image | Plano | — | | | | |

Note:
Reference wavelength is 587.6 nm (d-line).
An effective radius of the stop S1 (Surface 8) is 1.650 mm.

TABLE 10B
Aspheric Coefficients

| Surface # | 1 | 2 | 6 | 7 |
|---|---|---|---|---|
| k= | −9.00000E+01 | −3.68039E+01 | −1.59468E+00 | −5.16853E+00 |
| A4= | −2.098083033E−03 | 5.133493982E−02 | 2.702193224E−03 | 9.419573418E−02 |
| A6= | 2.241295820E−02 | −4.444588652E−02 | 2.237941073E−02 | −3.382131204E−01 |
| A8= | −2.052888166E−02 | 9.735592967E−02 | −9.892510248E−02 | 9.088090322E−01 |
| A10= | 1.239189256E−02 | −1.441916486E−01 | 2.597714012E−01 | −1.825505237E+00 |
| A12= | −5.397731911E−03 | 1.380712257E−01 | −4.439605721E−01 | 2.730986150E+00 |
| A14= | 1.734511350E−03 | −8.607055248E−02 | 5.001978996E−01 | −3.075340576E+00 |
| A16= | −4.140634603E−04 | 3.356171984E−02 | −3.569005071E−01 | 2.626641309E+00 |
| A18= | 7.341694755E−05 | −6.521776674E−03 | 1.304958164E−01 | −1.702339681E+00 |
| A20= | −9.600989306E−06 | −5.844372424E−04 | 1.573934920E−02 | 8.303934833E−01 |
| A22= | 9.112811461E−07 | 7.588449981E−04 | −4.596750390E−02 | −2.992934371E−01 |
| A24= | −6.092083160E−08 | −2.247890313E−04 | 2.540134518E−02 | 7.712831222E−02 |
| A26= | 2.715174682E−09 | 3.527464876E−05 | −7.359245041E−03 | −1.341556175E−02 |
| A28= | −7.232708945E−11 | −2.985638701E−06 | 1.147333502E−03 | 1.408814436E−03 |
| A30= | 8.702248477E−13 | 1.077270102E−07 | −7.621622697E−05 | −6.738141537E−05 |

| Surface # | 9 | 10 | 11 | 12 |
|---|---|---|---|---|
| k= | 1.11265E+00 | −1.07150E+00 | 6.34089E+00 | −9.00000E+01 |
| A4= | 2.786530300E−02 | −5.020361230E−02 | −1.761911923E−02 | −3.648902065E−02 |
| A6= | −2.088783224E−01 | 5.440758127E−02 | −2.345568288E−03 | 2.008712242E−02 |
| A8= | 4.972746880E−01 | −1.153249926E−01 | 1.959512701E−02 | −1.457348541E−02 |
| A10= | −7.995650887E−01 | 2.231774454E−01 | −3.054255306E−02 | 9.764619874E−03 |
| A12= | 8.736003327E−01 | −3.153400952E−01 | 2.733386528E−02 | −5.191011262E−03 |
| A14= | −6.433941782E−01 | 3.149127410E−01 | −1.606790713E−02 | 2.040217262E−03 |
| A16= | 3.038614676E−01 | −2.227673749E−01 | 6.442483112E−03 | −5.817635213E−04 |
| A18= | −7.521042009E−02 | 1.119014789E−01 | −1.760172034E−03 | 1.213122408E−04 |
| A20= | −3.690625474E−03 | −3.962809018E−02 | 3.156917598E−04 | −1.861125368E−05 |
| A22= | 9.607870093E−03 | 9.667917586E−03 | −3.291971434E−05 | 2.081690379E−06 |
| A24= | −3.246176904E−03 | −1.546151280E−03 | 9.988569712E−07 | −1.648108622E−07 |
| A26= | 5.097073571E−04 | 1.458923756E−04 | 1.888519621E−07 | 8.715075022E−09 |
| A28= | −3.251021898E−05 | −6.156493616E−06 | −2.336212636E−08 | −2.748627135E−10 |
| A30= | — | — | 8.453812487E−10 | 3.894643927E−12 |

| Surface # | 13 | 14 |
|---|---|---|
| k= | −1.27236E+01 | −3.39850E+00 |
| A4= | −4.241411685E−03 | −1.854836514E−02 |
| A6= | −2.359486853E−02 | −3.594967228E−03 |
| A8= | 1.085437078E−02 | 2.365048156E−03 |
| A10= | −2.548613964E−03 | −4.829326098E−04 |
| A12= | 2.521507131E−04 | 1.969219338E−05 |
| A14= | 2.720847182E−05 | 1.193742489E−05 |
| A16= | −1.265907983E−05 | −3.171761809E−06 |
| A18= | 2.004260333E−06 | 4.241054601E−07 |
| A20= | −1.893242855E−07 | −3.618584121E−08 |
| A22= | 1.174151159E−08 | 2.078037602E−09 |
| A24= | −4.847414033E−10 | −8.031075770E−11 |
| A26= | 1.288968833E−11 | 2.008573065E−12 |
| A28= | −2.003838972E−13 | −2.941957081E−14 |
| A30= | 1.386711424E−15 | 1.918837644E−16 |

In the 10th embodiment, the equation of the aspheric surface profiles of the aforementioned lens elements is the same as the equation of the 1st embodiment. Also, the definitions of these parameters shown in Table 10C are the same as those stated in the 1st embodiment with corresponding values for the 10th embodiment, so an explanation in this regard will not be provided again.

Moreover, these parameters can be calculated from Table 10A and Table 10B as the following values and satisfy the following conditions:

TABLE 10C
Schematic Parameters

| | | | |
|---|---|---|---|
| f [mm] | 4.67 | ΣAT/f | 0.85 |
| Fno | 2.14 | ΣCT/f | 0.95 |
| HFOV [deg.] | 52.7 | f23/f56 | −0.07 |
| V2 + V3 | 116.6 | f2/f3 | 1.25 |
| (CT1 + CT2)/(CT3 + CT4) | 1.41 | f/f23 | 1.55 |
| CT5/(T45 + T56) | 0.27 | \|f/f56\| | 0.10 |
| (CT5 + CT6)/(T45 + T56) | 0.65 | f × tan(HFOV)/f23 | 2.03 |
| (CT4 + CT5 + CT6)/ | 0.84 | f × sin(HFOV)/ImgH | 0.60 |
| (T45 + T56) | | | |
| \|f3/R5\| | 0.62 | f/ImgH | 0.76 |
| Dr5r8/f3 | 0.29 | TL/ImgH | 1.62 |
| f2/CT2 | 4.49 | TL/f | 2.14 |

### 11th Embodiment

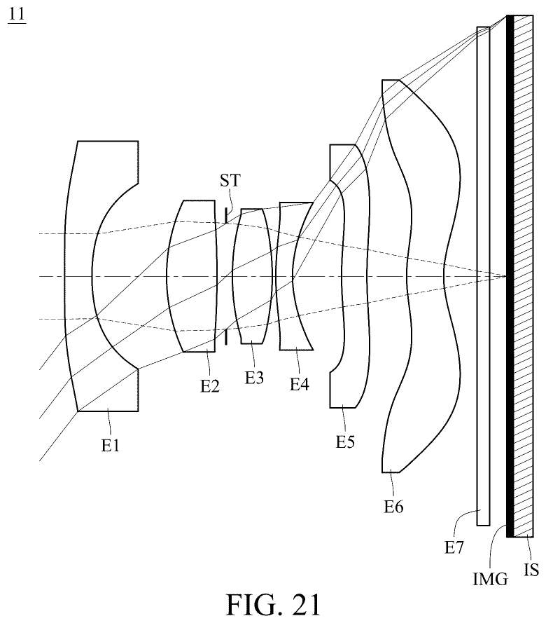

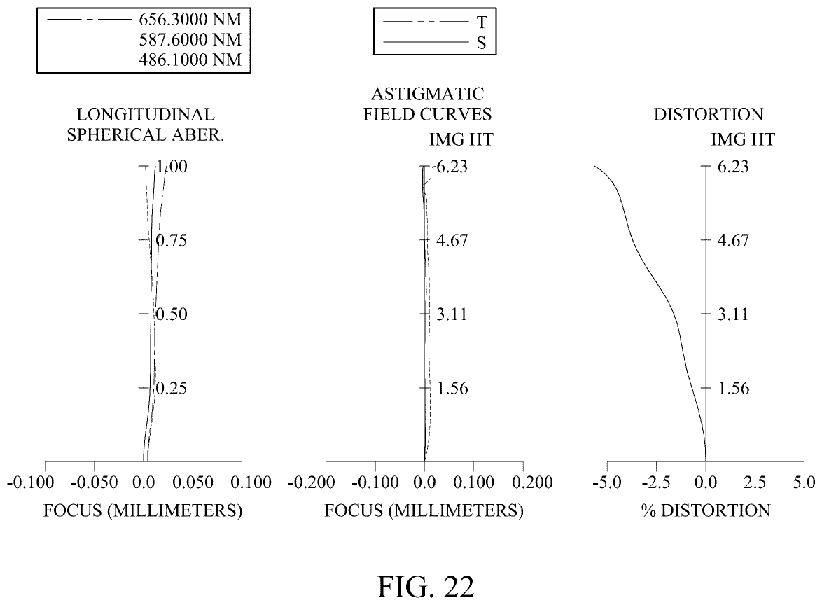

FIG. 21 is a schematic view of an image capturing unit according to the 11th embodiment of the present disclosure. FIG. 22 shows, in order from left to right, spherical aberration curves, astigmatic field curves and a distortion curve of the image capturing unit according to the 11th embodiment. In FIG. 21, the image capturing unit 11 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The object-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 11th embodiment are shown in Table 11A and the aspheric surface data are shown in Table 11B below.

TABLE 11A
11th Embodiment
f = 5.08 mm, Fno = 2.49, HFOV = 52.4 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −200.0000 | (ASP) | 0.655 | Plastic | 1.545 | 56.1 | −7.99 |
| 2 | | 4.4538 | (ASP) | 1.784 | | | | |
| 3 | Lens 2 | 4.2585 | (SPH) | 1.207 | Glass | 1.593 | 68.3 | 6.06 |
| 4 | | −20.6278 | (SPH) | 0.218 | | | | |
| 5 | Ape. Stop | Plano | | 0.150 | | | | |
| 6 | Lens 3 | 5.6242 | (ASP) | 0.954 | Plastic | 1.544 | 56.0 | 5.25 |
| 7 | | −5.4591 | (ASP) | 0.084 | | | | |
| 8 | Lens 4 | 5.6682 | (ASP) | 0.400 | Plastic | 1.669 | 19.5 | −7.84 |
| 9 | | 2.6470 | (ASP) | 1.174 | | | | |
| 10 | Lens 5 | 7.4688 | (ASP) | 0.605 | Plastic | 1.544 | 56.0 | 125.59 |
| 11 | | 8.1461 | (ASP) | 0.950 | | | | |
| 12 | Lens 6 | 3.3984 | (ASP) | 0.886 | Plastic | 1.534 | 56.0 | −18.06 |
| 13 | | 2.2850 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.410 | | | | |
| 16 | Image | Plano | — | | | | |

Note:
Reference wavelength is 587.6 nm (d-line).

TABLE 11B
Aspheric Coefficients

| Surface # | 1 | 2 | 6 | 7 |
|---|---|---|---|---|
| k= | −9.00000E+01 | −7.18609E+00 | 2.13326E+00 | −1.04767E+00 |
| A4= | 1.106162433E−02 | 3.058282365E−02 | 1.846135200E−03 | −9.399635515E−03 |
| A6= | −1.119025408E−03 | −4.697865405E−03 | 8.480148618E−03 | 5.831928985E−02 |
| A8= | −7.870680028E−04 | 1.071900399E−02 | −5.450643293E−02 | −1.274904405E−01 |
| A10= | 8.210557601E−04 | −2.276680315E−02 | 2.045082961E−01 | 2.065111876E−01 |
| A12= | −4.605144644E−04 | 3.128903036E−02 | −5.036099642E−01 | −2.785482591E−01 |
| A14= | 1.752720017E−04 | −2.883224340E−02 | 8.511580292E−01 | 3.145718437E−01 |
| A16= | −4.735293526E−05 | 1.852002483E−02 | −1.015663308E+00 | −2.924265276E−01 |
| A18= | 9.224196385E−06 | −8.463687749E−03 | 8.679884336E−01 | 2.181093390E−01 |
| A20= | −1.298676280E−06 | 2.769659378E−03 | −5.325142892E−01 | −1.267469841E−01 |
| A22= | 1.308570825E−07 | −6.444004112E−04 | 2.320837778E−01 | 5.546210645E−02 |
| A24= | −9.196414031E−09 | 1.040743051E−04 | −6.990480250E−02 | −1.749019914E−02 |
| A26= | 4.279272016E−10 | −1.109037101E−05 | 1.377012168E−02 | 3.724221495E−03 |
| A28= | −1.184339791E−11 | 7.011053736E−07 | −1.584858803E−03 | −4.765460267E−04 |
| A30= | 1.475356842E−13 | −1.991166555E−08 | 7.988720263E−05 | 2.754771927E−05 |

| Surface # | 8 | 9 | 10 | 11 |
|---|---|---|---|---|
| k= | 5.84505E+00 | −3.76933E−01 | −6.33855E+01 | −5.29985E+01 |
| A4= | −5.453854994E−02 | −4.673796088E−02 | −6.828116556E−03 | −2.250976874E−02 |
| A6= | 8.815570496E−02 | 3.950557505E−02 | 2.641060868E−03 | 2.114867248E−02 |
| A8= | −1.775624251E−01 | −2.720790833E−02 | 2.610414371E−03 | −1.677031254E−02 |
| A10= | 3.169229724E−01 | −5.933339572E−03 | −1.588396991E−02 | 1.000299456E−02 |
| A12= | −4.702840712E−01 | 6.218121084E−02 | 2.465208752E−02 | −4.666999765E−03 |
| A14= | 5.407854228E−01 | −1.159305804E−01 | −2.255833557E−02 | 1.683981122E−03 |
| A16= | −4.658740221E−01 | 1.304800277E−01 | 1.388478375E−02 | −4.604483069E−04 |
| A18= | 2.952002672E−01 | −9.992650779E−02 | −6.005009461E−03 | 9.403175580E−05 |
| A20= | −1.352366161E−01 | 5.369898179E−02 | 1.849749548E−03 | −1.416378340E−05 |
| A22= | 4.365095207E−02 | −2.027363725E−02 | −4.038879917E−04 | 1.546194200E−06 |
| A24= | −9.488301692E−03 | 5.269240465E−03 | 6.106338415E−05 | −1.187103953E−07 |
| A26= | 1.275221469E−03 | −8.978980474E−04 | −6.074239623E−06 | 6.070183681E−09 |
| A28= | −8.793389444E−05 | 9.031245168E−05 | 3.571452339E−07 | −1.854341371E−10 |
| A30= | 1.701138484E−06 | −4.064297425E−06 | −9.387305754E−09 | 2.558548142E−12 |

| Surface # | 12 | 13 |
|---|---|---|
| k= | −5.84807E+00 | −2.00280E+00 |
| A4= | −4.872051668E−02 | −5.293766842E−02 |
| A6= | 1.380631494E−02 | 1.621832865E−02 |
| A8= | −4.596868800E−03 | −4.554070839E−03 |
| A10= | 1.530723174E−03 | 1.095542706E−03 |
| A12= | −4.254839788E−04 | −2.161318478E−04 |
| A14= | 8.736332084E−05 | 3.370408416E−05 |
| A16= | −1.268484895E−05 | −4.068993771E−06 |
| A18= | 1.300079740E−06 | 3.745297051E−07 |
| A20= | −9.451198902E−08 | −2.583984175E−08 |
| A22= | 4.855904764E−09 | 1.305631867E−09 |
| A24= | −1.728348452E−10 | −4.664925259E−11 |
| A26= | 4.064054389E−12 | 1.111784072E−12 |
| A28= | −5.690879263E−14 | −1.581087678E−14 |
| A30= | 3.600596471E−16 | 1.012615926E−16 |

In the 11th embodiment, the equation of the aspheric surface profiles of the aforementioned lens elements is the same as the equation of the 1st embodiment. Also, the definitions of these parameters shown in Table 11C are the same as those stated in the 1st embodiment with corresponding values for the 11th embodiment, so an explanation in this regard will not be provided again.

Moreover, these parameters can be calculated from Table 11A and Table 11B as the following values and satisfy the following conditions:

TABLE 11C
Schematic Parameters

| | | | |
|---|---|---|---|
| f [mm] | 5.08 | ΣAT/f | 0.86 |
| Fno | 2.49 | ΣCT/f | 0.93 |
| HFOV [deg.] | 52.4 | f23/f56 | −0.14 |
| V2 + V3 | 124.3 | f2/f3 | 1.15 |
| (CT1 + CT2)/(CT3 + CT4) | 1.38 | f/f23 | 1.59 |
| CT5/(T45 + T56) | 0.28 | \|f/f56\| | 0.23 |
| (CT5 + CT6)/(T45 + T56) | 0.70 | f × tan(HFOV)/f23 | 2.07 |
| (CT4 + CT5 + CT6)/ | 0.89 | f × sin(HFOV)/ImgH | 0.65 |
| (T45 + T56) | | | |
| \|f3/R5\| | 0.93 | f/ImgH | 0.82 |
| Dr5r8/f3 | 0.27 | TL/ImgH | 1.70 |
| f2/CT2 | 5.02 | TL/f | 2.08 |

### 12th Embodiment

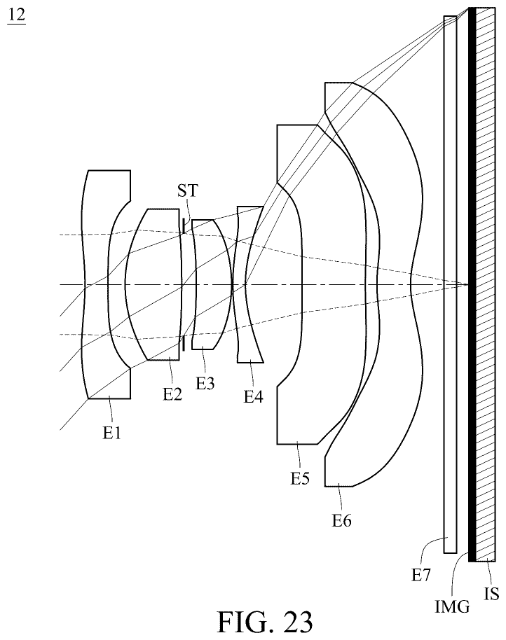

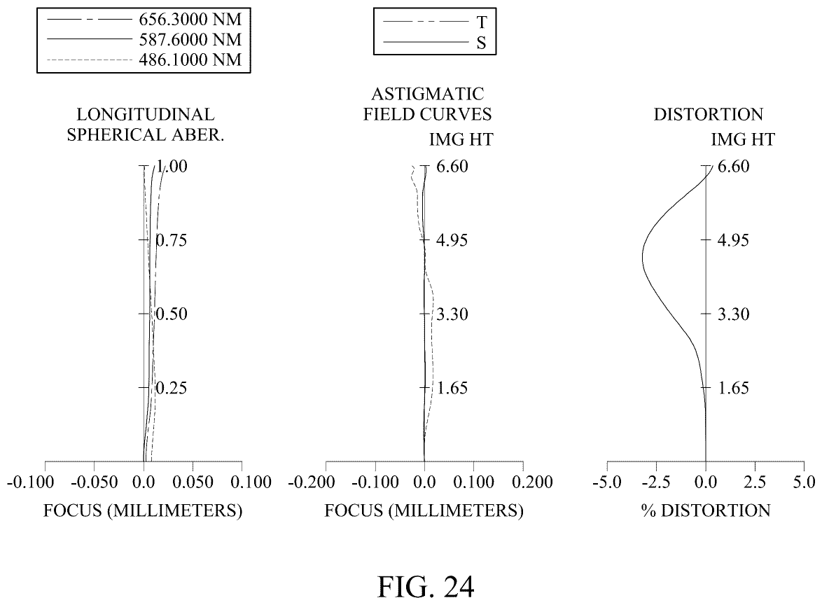

FIG. 23 is a schematic view of an image capturing unit according to the 12th embodiment of the present disclosure. FIG. 24 shows, in order from left to right, spherical aberration curves, astigmatic field curves and a distortion curve of the image capturing unit according to the 12th embodiment. In FIG. 23, the image capturing unit 12 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of glass material and has the object-side surface and the image-side surface being both aspheric.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has three inflection points. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has five inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 12th embodiment are shown in Table 12A and the aspheric surface data are shown in Table 12B below.

TABLE 12A
12th Embodiment
f = 5.93 mm, Fno = 2.48, HFOV = 47.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −6.0069 | (ASP) | 0.550 | Plastic | 1.545 | 56.1 | −10.23 |
| 2 | | 80.0929 | (ASP) | 0.408 | | | | |
| 3 | Lens 2 | 3.0184 | (ASP) | 1.352 | Glass | 1.589 | 61.2 | 4.67 |
| 4 | | −25.9368 | (ASP) | 0.045 | | | | |
| 5 | Ape. Stop | Plano | | 0.302 | | | | |
| 6 | Lens 3 | −15.3528 | (ASP) | 0.845 | Plastic | 1.544 | 56.0 | 7.08 |
| 7 | | −3.1376 | (ASP) | 0.030 | | | | |
| 8 | Lens 4 | 4.7041 | (ASP) | 0.300 | Plastic | 1.686 | 18.4 | −11.31 |
| 9 | | 2.8522 | (ASP) | 1.351 | | | | |
| 10 | Lens 5 | 81.9167 | (ASP) | 1.513 | Plastic | 1.686 | 18.4 | −18.53 |
| 11 | | 10.9223 | (ASP) | 0.278 | | | | |
| 12 | Lens 6 | 3.3722 | (ASP) | 0.803 | Plastic | 1.566 | 37.4 | −16.01 |
| 13 | | 2.2462 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.293 | | | | |
| 16 | Image | Plano | — | | | | |

Note:
Reference wavelength is 587.6 nm (d-line).

TABLE 12B
Aspheric Coefficients

| Surface # | 1 | 2 | 3 | 4 |
|---|---|---|---|---|
| k= | −9.00000E+01 | −9.00000E+01 | 0.00000E+00 | 0.00000E+00 |
| A4= | −1.786829422E−02 | 3.870580003E−02 | −4.044971798E−03 | −8.937413333E−03 |
| A6= | 4.045019983E−02 | −2.244573411E−02 | −1.120601217E−04 | 1.155791453E−03 |
| A8= | −4.172946863E−02 | 6.075718430E−02 | −9.755324461E−04 | 2.075625684E−04 |
| A10= | 3.174865099E−02 | −1.292664091E−01 | 7.447444967E−04 | −4.574341249E−04 |
| A12= | −1.809214261E−02 | 1.888455981E−01 | −2.727913570E−04 | 2.601503846E−04 |
| A14= | 7.709510730E−03 | −1.924086823E−01 | 3.842423355E−05 | −3.860792358E−05 |
| A16= | −2.454501515E−03 | 1.396615438E−01 | — | — |
| A18= | 5.822941362E−04 | −7.306812628E−02 | — | — |
| A20= | −1.021450407E−04 | 2.759461449E−02 | — | — |
| A22= | 1.303571243E−05 | −7.446613218E−03 | — | — |
| A24= | −1.174383270E−06 | 1.399138441E−03 | — | — |
| A26= | 7.068426848E−08 | −1.737348252E−04 | — | — |
| A28= | −2.547658645E−09 | 1.280615002E−05 | — | — |
| A30= | 4.154472288E−11 | −4.239855586E−07 | — | — |
| Surface # | 6 | 7 | 8 | 9 |
| k= | 8.72346E+01 | 4.61236E−01 | 1.39624E+00 | 0.00000E+00 |
| A4= | −8.460266399E−03 | 2.324546013E−02 | −2.914817497E−02 | −5.561465443E−02 |
| A6= | 1.937301940E−02 | −1.626779416E−02 | 2.079290918E−02 | 5.039322853E−02 |
| A8= | −1.245501307E−01 | −6.112978024E−02 | −2.989029782E−02 | −5.098857855E−02 |
| A10= | 4.784642755E−01 | 3.068597675E−01 | 2.803080627E−02 | 3.935236435E−02 |
| A12= | −1.202244708E+00 | −8.056206394E−01 | −2.046854152E−02 | −2.242853847E−02 |
| A14= | 2.075621137E+00 | 1.399074989E+00 | 1.229461619E−02 | 9.155671911E−03 |
| A16= | −2.539681116E+00 | −1.701322589E+00 | −6.157789705E−03 | −2.567061024E−03 |
| A18= | 2.237182655E+00 | 1.482851037E+00 | 2.415036166E−03 | 4.657641227E−04 |
| A20= | −1.423575884E+00 | −9.326324634E−01 | −6.617919061E−04 | −4.907754428E−05 |
| A22= | 6.483977861E−01 | 4.201415992E−01 | 1.085816340E−04 | 2.275171749E−06 |
| A24= | −2.060971464E−01 | −1.322880636E−01 | −7.904784302E−06 | — |
| A26= | 4.341187060E−02 | 2.765639156E−02 | — | — |
| A28= | −5.444802185E−03 | −3.449833725E−03 | — | — |
| A30= | 3.077797687E−04 | 1.943324548E−04 | — | — |
| Surface # | 10 | 11 | 12 | 13 |
| k= | −9.00000E+01 | 5.85585E+00 | −1.00000E+00 | −2.57061E+00 |
| A4= | −1.147630868E−02 | −5.194010315E−02 | −1.234951335E−01 | −7.525621050E−02 |
| A6= | 4.364156820E−04 | 3.811447328E−02 | 5.083556818E−02 | 3.097303557E−02 |
| A8= | 3.919832639E−03 | −2.089177289E−02 | −1.561929030E−02 | −1.041783844E−02 |
| A10= | −1.073456340E−02 | 8.039524905E−03 | 3.231150277E−03 | 2.784409868E−03 |
| A12= | 1.267610685E−02 | −2.278463668E−03 | −4.511484458E−04 | −5.823319637E−04 |
| A14= | −9.225888423E−03 | 4.832714452E−04 | 4.407569717E−05 | 9.290795562E−05 |
| A16= | 4.535600332E−03 | −7.696444022E−05 | −3.112267482E−06 | −1.108954720E−05 |
| A18= | −1.560319590E−03 | 9.187858874E−06 | 1.611133193E−07 | 9.787710868E−07 |
| A20= | 3.796472976E−04 | −8.169814757E−07 | −6.031369450E−09 | −6.322469707E−08 |
| A22= | −6.495339282E−05 | 5.336282321E−08 | 1.551055516E−10 | 2.942280119E−09 |
| A24= | 7.636519140E−06 | −2.492364754E−09 | −2.447727439E−12 | −9.587255777E−11 |
| A26= | −5.875843441E−07 | 7.907482935E−11 | 1.781854576E−14 | 2.074055764E−12 |
| A28= | 2.671373993E−08 | −1.532742161E−12 | — | −2.674924391E−14 |
| A30= | −5.475080749E−10 | 1.374098138E−14 | — | 1.556335549E−16 |

In the 12th embodiment, the equation of the aspheric surface profiles of the aforementioned lens elements is the same as the equation of the 1st embodiment. Also, the definitions of these parameters shown in Table 12C are the same as those stated in the 1st embodiment with corresponding values for the 12th embodiment, so an explanation in this regard will not be provided again.

Moreover, these parameters can be calculated from Table 12A and Table 1B as the following values and satisfy the following conditions:

TABLE 12C
Schematic Parameters

| | | | |
|---|---|---|---|
| f [mm] | 5.93 | ΣAT/f | 0.41 |
| Fno | 2.48 | ΣCT/f | 0.90 |
| HFOV [deg.] | 47.9 | f23/f56 | −0.41 |
| V2 + V3 | 117.2 | f2/f3 | 0.66 |
| (CT1 + CT2)/(CT3 + CT4) | 1.66 | f/f23 | 1.79 |
| CT5/(T45 + T56) | 0.93 | \|f/f56\| | 0.74 |
| (CT5 + CT6)/(T45 + T56) | 1.42 | f × tan(HFOV)/f23 | 1.98 |
| (CT4 + CT5 + CT6)/ | 1.61 | f × sin(HFOV)/ImgH | 0.67 |
| (T45 + T56) | | | |
| \|f3/R5\| | 0.46 | f/ImgH | 0.90 |
| Dr5r8/f3 | 0.17 | TL/ImgH | 1.39 |
| f2/CT2 | 3.45 | TL/f | 1.55 |

### 13th Embodiment

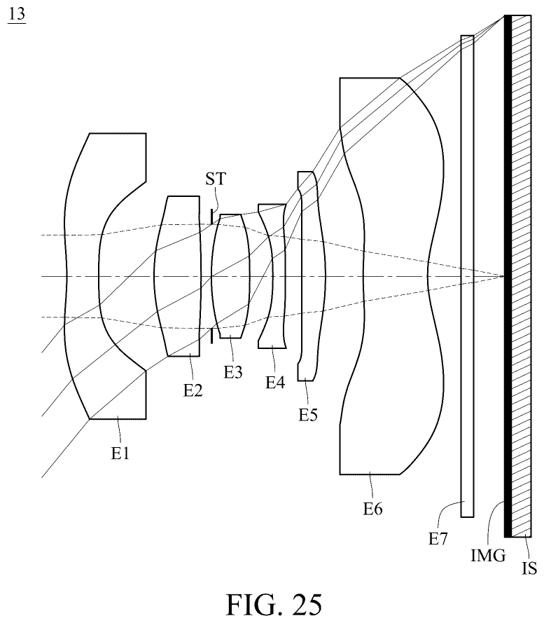

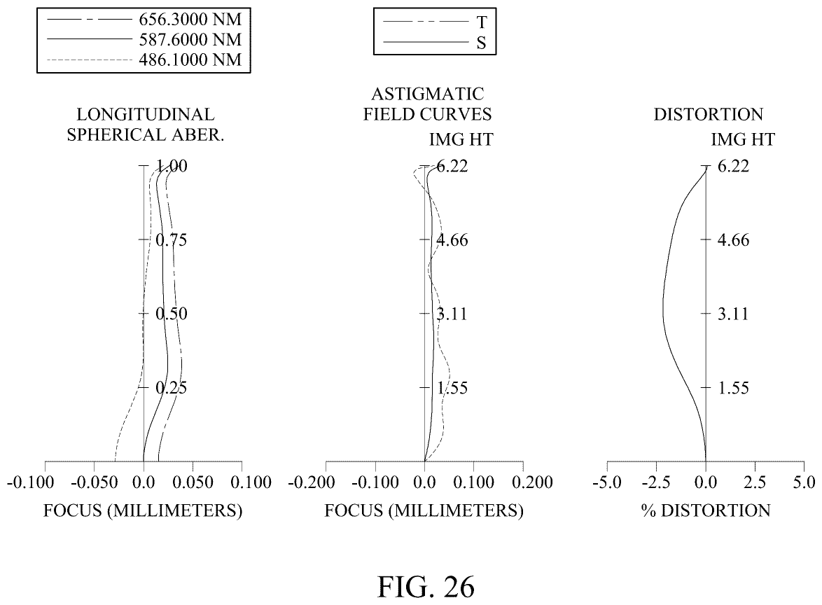

FIG. 25 is a schematic view of an image capturing unit according to the 13th embodiment of the present disclosure. FIG. 26 shows, in order from left to right, spherical aberration curves, astigmatic field curves and a distortion curve of the image capturing unit according to the 13th embodiment. In FIG. 25, the image capturing unit 13 includes the optical photographing system (its reference numeral is omitted) of the present disclosure and an image sensor IS. The optical photographing system includes, in order from an object side to an image side along an optical axis, a first lens element E1, a second lens element E2, an aperture stop ST, a third lens element E3, a fourth lens element E4, a fifth lens element E5, a sixth lens element E6, a filter E7 and an image surface IMG. The optical photographing system includes six lens elements (E1, E2, E3, E4, E5 and E6) with no additional lens element disposed between each of the adjacent six lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The image-side surface of the first lens element E1 has one inflection point. The object-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has two inflection points. The image-side surface of the second lens element E2 has one inflection point. The image-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The image-side surface of the fourth lens element E4 has one inflection point. The image-side surface of the fourth lens element E4 has one critical point in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has two critical points in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the optical photographing system. The image sensor IS is disposed on or near the image surface IMG of the optical photographing system.

The detailed optical data of the 13th embodiment are shown in Table 13A and the aspheric surface data are shown in Table 13B below.

TABLE 13A
13th Embodiment
f = 5.08 mm, Fno = 2.59, HFOV = 50.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −5.8005 | (ASP) | 0.763 | Plastic | 1.545 | 56.1 | −8.03 |
| 2 | | 18.6392 | (ASP) | 1.323 | | | | |
| 3 | Lens 2 | 4.3110 | (ASP) | 1.125 | Plastic | 1.544 | 56.0 | 6.63 |
| 4 | | −19.9974 | (ASP) | 0.254 | | | | |
| 5 | Ape. Stop | Plano | | −0.007 | | | | |
| 6 | Lens 3 | 5.4519 | (ASP) | 0.917 | Plastic | 1.544 | 56.0 | 7.01 |
| 7 | | −11.9423 | (ASP) | 0.553 | | | | |
| 8 | Lens 4 | −7.6284 | (ASP) | 0.300 | Plastic | 1.686 | 18.4 | −13.34 |
| 9 | | −46.5649 | (ASP) | 0.390 | | | | |
| 10 | Lens 5 | −83.1618 | (ASP) | 0.568 | Plastic | 1.544 | 56.0 | 12.32 |
| 11 | | −6.2193 | (ASP) | 0.901 | | | | |
| 12 | Lens 6 | 7.2393 | (ASP) | 1.540 | Plastic | 1.534 | 56.0 | −9.00 |
| 13 | | 2.6751 | (ASP) | 0.800 | | | | |

| | | | | | | | |
|---|---|---|---|---|---|---|---|
| 14 | Filter | Plano | 0.300 | Glass | 1.517 | 64.2 | — |
| 15 | | Plano | 0.745 | | | | |
| 16 | Image | Plano | — | | | | |

Note:
Reference wavelength is 587.6 nm (d-line).

TABLE 13B
Aspheric Coefficients

| Surface # | 1 | 2 | 3 | 4 |
|---|---|---|---|---|
| k= | −7.15165E+01 | 2.64143E+00 | −1.72375E+00 | 7.47705E+01 |
| A4= | 6.276385936E−03 | 7.226117425E−02 | 4.679688906E−03 | 7.228590432E−03 |
| A6= | 1.350700252E−02 | −7.416955529E−02 | −6.498482402E−03 | −1.216191506E−02 |
| A8= | −1.132979751E−02 | 1.787468812E−01 | 9.238073091E−03 | 2.301763320E−02 |
| A10= | 5.700679511E−03 | −3.074201499E−01 | −1.385659774E−02 | −3.809485217E−02 |
| A12= | −2.011259073E−03 | 3.623124345E−01 | 1.268754471E−02 | 4.241749485E−02 |
| A14= | 5.144729148E−04 | −2.998834203E−01 | −7.435630865E−03 | −3.045434309E−02 |
| A16= | −9.633889954E−05 | 1.779620194E−01 | 2.780088063E−03 | 1.398331230E−02 |
| A18= | 1.317544998E−05 | −7.652241860E−02 | −6.427001235E−04 | −3.904226280E−03 |
| A20= | −1.298362375E−06 | 2.384983995E−02 | 8.420299603E−05 | 5.901727122E−04 |
| A22= | 8.960815440E−08 | −5.328656497E−03 | −4.784447942E−06 | −3.458833382E−05 |
| A24= | −4.104380405E−09 | 8.310919668E−04 | — | — |
| A26= | 1.119499117E−10 | −8.586031039E−05 | — | — |
| A28= | −1.375114397E−12 | 5.276986514E−06 | — | — |
| A30= | — | −1.460052618E−07 | — | — |

| Surface # | 6 | 7 | 8 | 9 |
|---|---|---|---|---|
| k= | 1.44029E+00 | 3.33731E+01 | 0.00000E+00 | 0.00000E+00 |
| A4= | 1.135765842E−02 | −2.557348502E−02 | −5.510543452E−02 | −2.099868125E−02 |
| A6= | −2.204931815E−02 | 9.971584219E−04 | −2.235940444E−02 | −2.540563533E−02 |
| A8= | 1.410867242E−01 | −4.510943414E−02 | 4.705727714E−02 | 5.608452776E−02 |
| A10= | −6.954214713E−01 | 2.334328000E−01 | −6.443072271E−02 | −5.998958735E−02 |
| A12= | 2.211985658E+00 | −7.282178534E−01 | 9.620306496E−02 | 4.912466941E−02 |
| A14= | −4.734091569E+00 | 1.503490535E+00 | −1.205766740E−01 | −2.721268853E−02 |
| A16= | 7.060017590E+00 | −2.135552372E+00 | 1.164207278E−01 | 9.613597238E−03 |
| A18= | −7.481272735E+00 | 2.136597513E+00 | −8.069467912E−02 | −2.089343863E−03 |
| A20= | 5.668336515E+00 | −1.518892185E+00 | 3.770208407E−02 | 2.562912407E−04 |
| A22= | −3.048659863E+00 | 7.629014196E−01 | −1.115880784E−02 | −1.365350170E−05 |
| A24= | 1.136252848E+00 | −2.645512372E−01 | 1.885158375E−03 | — |
| A26= | −2.788995402E−01 | 6.022655670E−02 | −1.385155526E−04 | — |
| A28= | 4.053036273E−02 | −8.093803536E−03 | — | — |
| A30= | −2.640305669E−03 | 4.861300845E−04 | — | — |

| Surface # | 10 | 11 | 12 | 13 |
|---|---|---|---|---|
| k= | 2.76008E+01 | 2.89304E+00 | −1.00000E+00 | −4.28995E+00 |
| A4= | 9.131165003E−03 | −2.862086383E−03 | −4.979484616E−02 | −2.612635439E−02 |
| A6= | −1.195068367E−02 | 7.448660333E−03 | 1.157061537E−02 | 5.665485115E−03 |
| A8= | 1.891760214E−02 | −4.693325692E−04 | −2.978895686E−03 | −7.388039553E−04 |
| A10= | −2.285432581E−02 | −8.975138252E−04 | 9.297659217E−04 | −3.186209246E−05 |
| A12= | 1.848031226E−02 | 1.360605730E−04 | −2.816335094E−04 | 3.819859227E−05 |
| A14= | −9.987189564E−03 | 2.436246785E−04 | 6.551565454E−05 | −8.943116924E−06 |
| A16= | 3.655408491E−03 | −1.471055845E−04 | −1.052857070E−05 | 1.226193136E−06 |
| A18= | −9.003907681E−04 | 3.813967169E−05 | 1.139632665E−06 | −1.119963697E−07 |
| A20= | 1.430374070E−04 | −5.292879143E−06 | −8.191570170E−08 | 7.049062755E−09 |
| A22= | −1.321801582E−05 | 3.861828691E−07 | 3.767082677E−09 | −3.053713192E−10 |
| A24= | 5.379553498E−07 | −1.171314696E−08 | −1.007973851E−10 | 8.851765112E−12 |
| A26= | — | — | 1.198392395E−12 | −1.609112890E−13 |
| A28= | — | — | — | 1.597991889E−15 |
| A30= | — | — | — | −6.050842021E−18 |

In the 13th embodiment, the equation of the aspheric surface profiles of the aforementioned lens elements is the same as the equation of the 1st embodiment. Also, the definitions of these parameters shown in Table 13C are the same as those stated in the 1st embodiment with corresponding values for the 13th embodiment, so an explanation in this regard will not be provided again.

Moreover, these parameters can be calculated from Table 13A and Table 13B as the following values and satisfy the following conditions:

TABLE 13C
Schematic Parameters

| | | | |
|---|---|---|---|
| f [mm] | 5.08 | ΣAT/f | 0.67 |
| Fno | 2.59 | ΣCT/f | 1.03 |
| HFOV [deg.] | 50.7 | f23/f56 | −0.02 |
| V2 + V3 | 112.0 | f2/f3 | 0.95 |
| (CT1 + CT2)/(CT3 + CT4) | 1.55 | f/f23 | 1.38 |
| CT5/(T45 + T56) | 0.44 | \|f/f56\| | 0.03 |
| (CT5 + CT6)/(T45 + T56) | 1.63 | f × tan(HFOV)/f23 | 1.68 |
| (CT4 + CT5 + CT6)/ | 1.87 | f × sin(HFOV)/ImgH | 0.63 |
| (T45 + T56) | | | |
| \|f3/R5\| | 1.29 | f/ImgH | 0.82 |
| Dr5r8/f3 | 0.25 | TL/ImgH | 1.68 |
| f2/CT2 | 5.89 | TL/f | 2.06 |

### 14th Embodiment

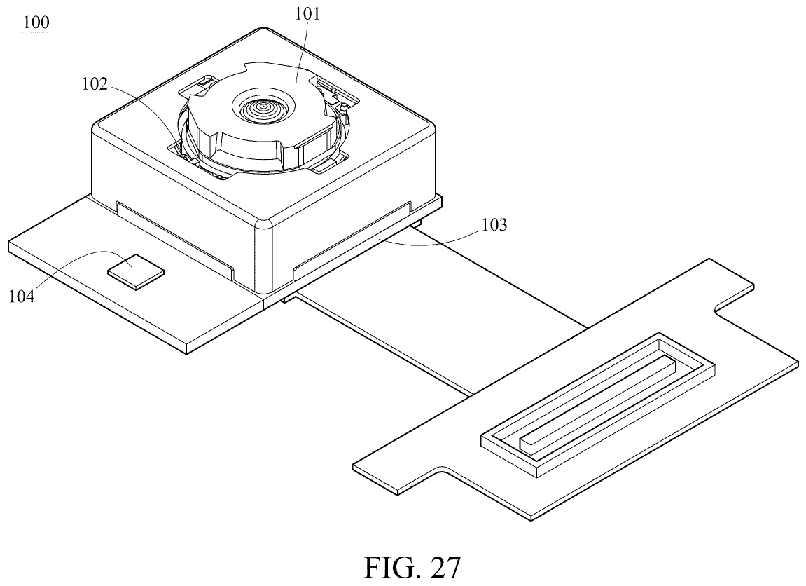

FIG. 27 is a perspective view of an image capturing unit according to the 14th embodiment of the present disclosure. In this embodiment, an image capturing unit 100 is a camera module including a lens unit 101, a driving device 102, an image sensor 103 and an image stabilizer 104. The lens unit 101 includes the optical photographing system disclosed in the 1st embodiment, a barrel and a holder member (their reference numerals are omitted) for holding the optical photographing system. However, the lens unit 101 may alternatively be provided with the optical photographing system disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems, or shape memory alloy materials. The driving device 102 is favorable for obtaining a better imaging position of the lens unit 101 or the image sensor, so that a clear image of the imaged object can be captured by the lens unit 101 with different object distances. The image sensor 103 (for example, CCD or CMOS), which can feature high photosensitivity and low noise, is disposed on the image surface of the optical photographing system to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 or the image sensor to reduce blurring associated with motion during exposure. In some cases, the compensation can be provided by electronic image stabilization (EIS) with image processing software, thereby improving image quality while in motion or low-light conditions.

### 15th Embodiment

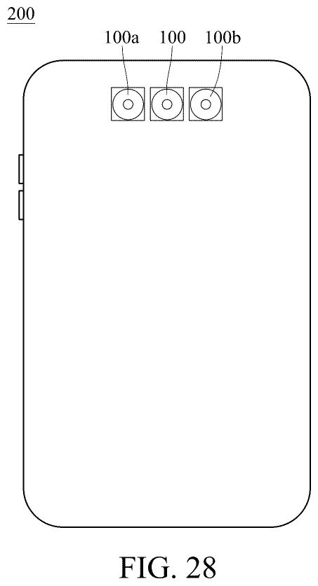

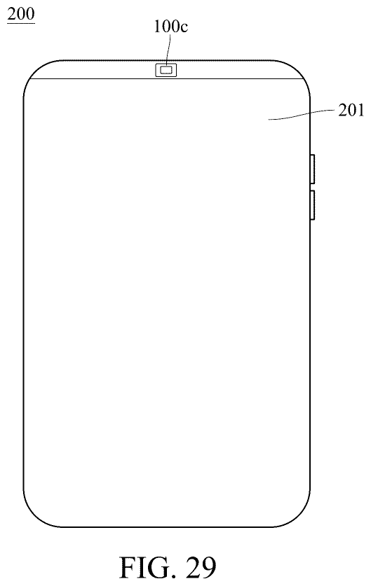

FIG. 28 is a perspective view of an electronic device according to the 15th embodiment of the present disclosure. FIG. 29 is another perspective view of the electronic device in FIG. 28.

In this embodiment, an electronic device 200 is a smartphone including the image capturing unit 100 disclosed in the 14th embodiment, an image capturing unit 100a, an image capturing unit 100b, an image capturing unit 100c and a display module 201. As shown in FIG. 28, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 29, the image capturing unit 100c and the display module 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the optical photographing system of the present disclosure and can have a configuration similar to that of the image capturing unit 100. In detail, each of the image capturing units 100a, 100b and 100c can include a lens unit, a driving device, an image sensor and an image stabilizer, and each of the lens unit can include an optical lens assembly such as the optical photographing system of the present disclosure, a barrel and a holder member for holding the optical lens assembly.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 29, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display module 201 with respect to the electronic device 200, reducing the thickness of the electronic device 200, and achieving miniaturization of the overall module. In this embodiment, the electronic device 200 includes multiple image capturing units 100, 100a, 100b and 100c, but the present disclosure is not limited to the number and arrangement of image capturing units.

### 16th Embodiment

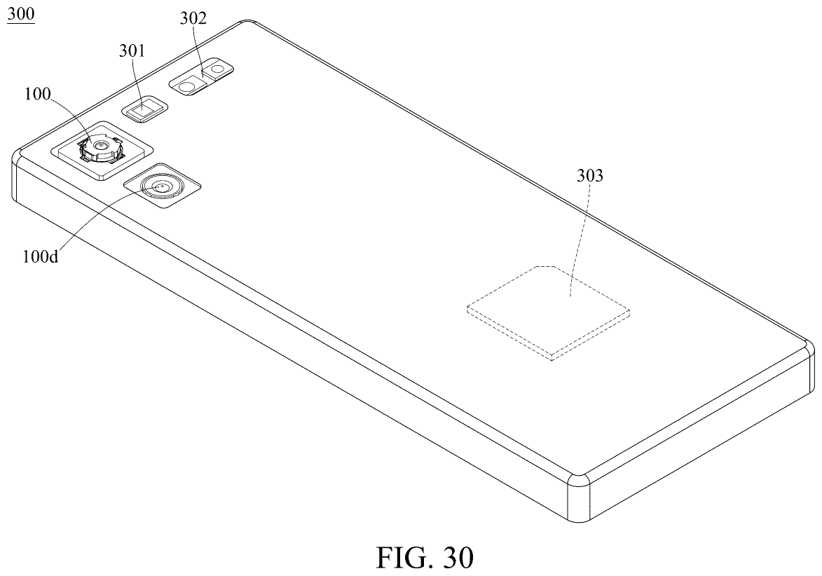

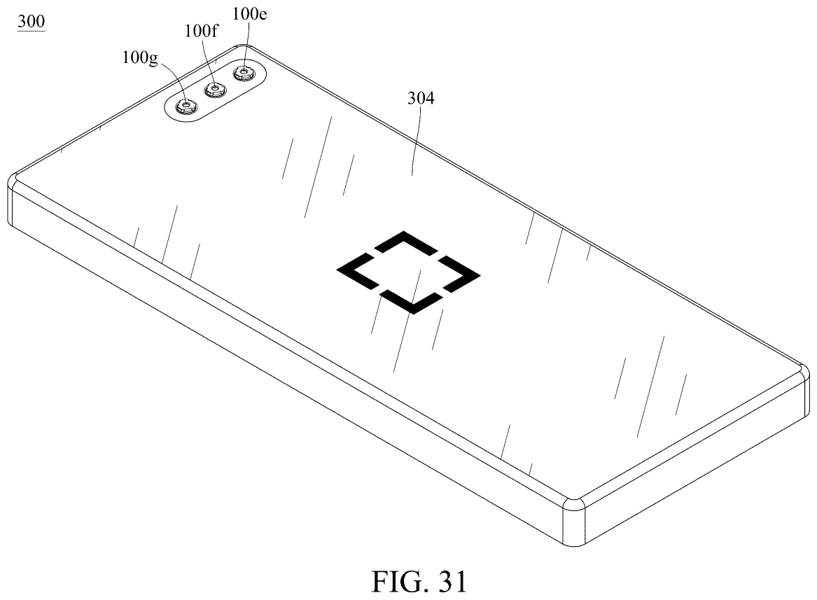

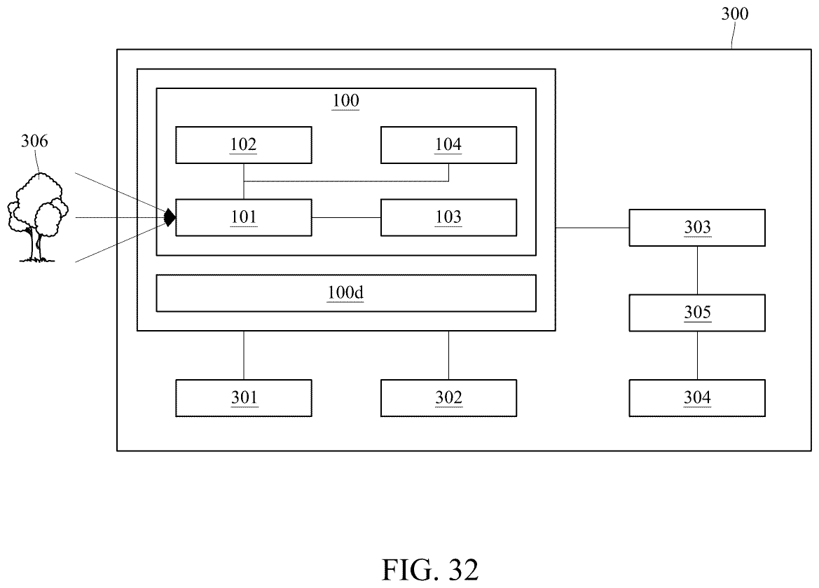

FIG. 30 is a perspective view of an electronic device according to the 16th embodiment of the present disclosure. FIG. 31 is another perspective view of the electronic device in FIG. 30. FIG. 32 is a block diagram of the electronic device in FIG. 30.

In this embodiment, an electronic device 300 is a smartphone including the image capturing unit 100 disclosed in the 14th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, the image capturing unit 100f, the image capturing unit 100g and the display module 304 are disposed on the opposite side of the electronic device 300, and the display module 304 can be a user interface, such that the image capturing units 100e, 100f, 100g can be front-facing cameras of the electronic device 300 for taking selfies, but the present disclosure is not limited thereto. Furthermore, each of the image capturing units 100d, 100e, 100f and 100g can include the optical photographing system of the present disclosure and can have a configuration similar to that of the image capturing unit 100. In detail, each of the image capturing units 100d, 100e, 100f and 100g can include a lens unit, a driving device, an image sensor and an image stabilizer, and each of the lens unit can include an optical lens assembly such as the optical photographing system of the present disclosure, a barrel and a holder member for holding the optical lens assembly.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can determine depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 17th Embodiment

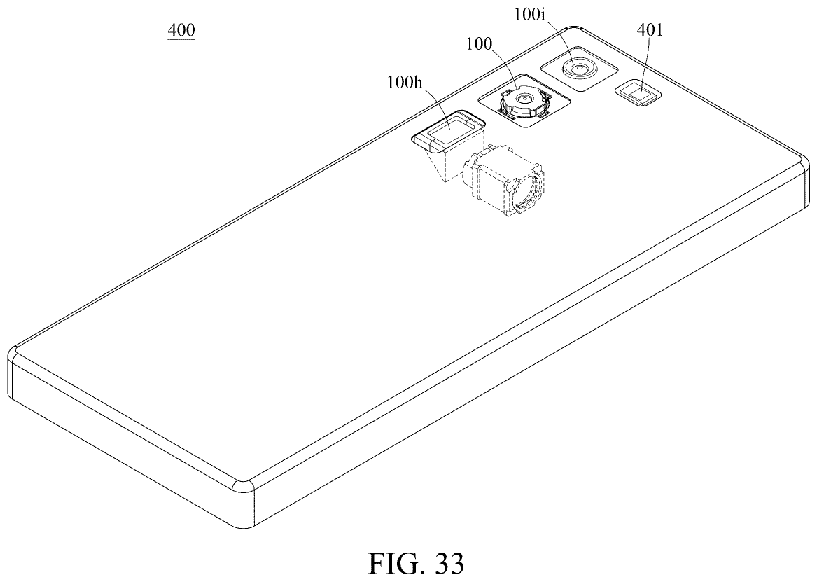

FIG. 33 is a perspective view of an electronic device according to the 17th embodiment of the present disclosure.

In this embodiment, an electronic device 400 is a smartphone including the image capturing unit 100 disclosed in the 14th embodiment, an image capturing unit 100h, an image capturing unit 100i, a flash module 401, a focus assist module, an image signal processor, a display module and an image software processor (not shown). The image capturing unit 100, the image capturing unit 100h and the image capturing unit 100i are disposed on the same side of the electronic device 400, while the display module is disposed on the opposite side of the electronic device 400. Furthermore, each of the image capturing units 100h and 100i can include the optical photographing system of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. Moreover, the image capturing unit 100h can be a telephoto image capturing unit having a light-folding element configuration, such that the total track length of the image capturing unit 100h is not limited by the thickness of the electronic device 400. Moreover, the light-folding element configuration of the image capturing unit 100h can be similar to, for example, one of the structures shown in FIG. 48 to FIG. 50, which can be referred to foregoing descriptions corresponding to FIG. 48 to FIG. 50, and the details in this regard will not be provided again. In this embodiment, the electronic device 400 includes multiple image capturing units 100, 100h and 100i, but the present disclosure is not limited to the number and arrangement of image capturing units. When a user captures images of an object, light rays converge in the image capturing unit 100, 100h or 100i to generate images, and the flash module 401 is activated for light supplement. Further, the subsequent processes are performed in a manner similar to the abovementioned embodiment, so the details in this regard will not be provided again.

### 18th Embodiment

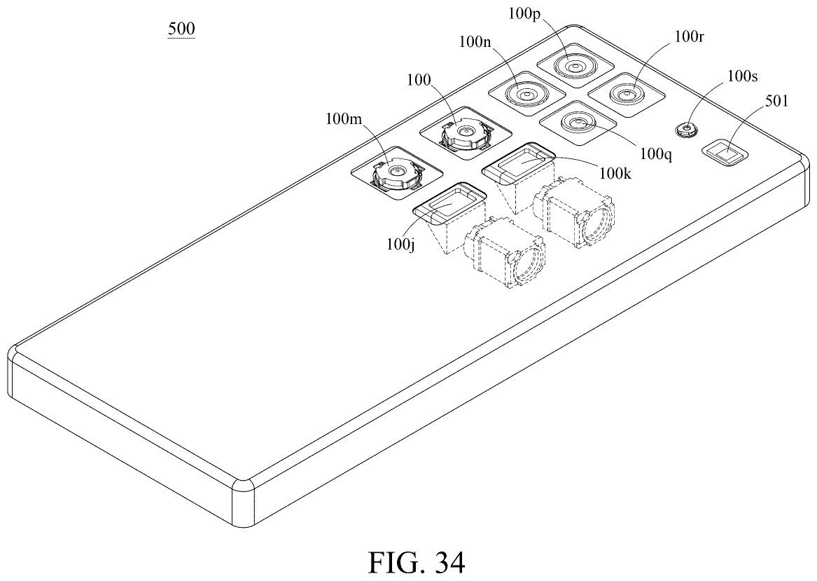

FIG. 34 is a perspective view of an electronic device according to the 18th embodiment of the present disclosure.

In this embodiment, an electronic device 500 is a smartphone including the image capturing unit 100 disclosed in the 14th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the optical photographing system of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. Moreover, each of the image capturing units 100j and 100k can be a telephoto image capturing unit having a light-folding element configuration. Moreover, the light-folding element configuration of each of the image capturing unit 100j and 100k can be similar to, for example, one of the structures shown in FIG. 48 to FIG. 50, which can be referred to foregoing descriptions corresponding to FIG. 48 to FIG. 50, and the details in this regard will not be provided again. In addition, the image capturing unit 100s can determine depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

### 19th Embodiment

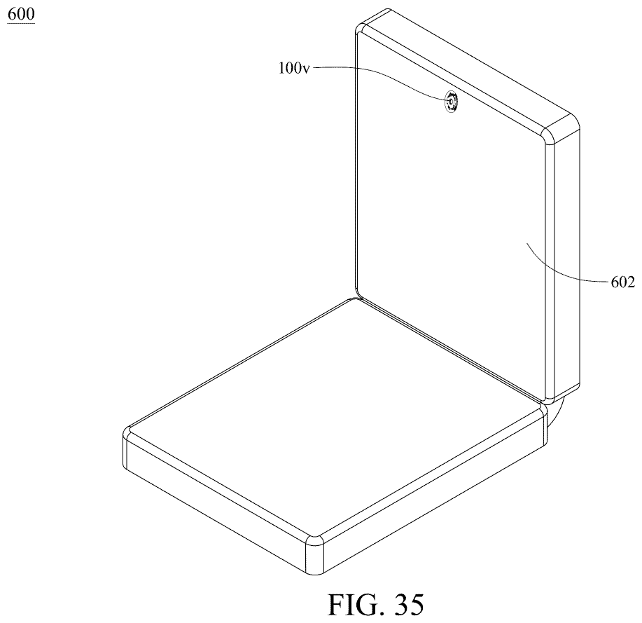

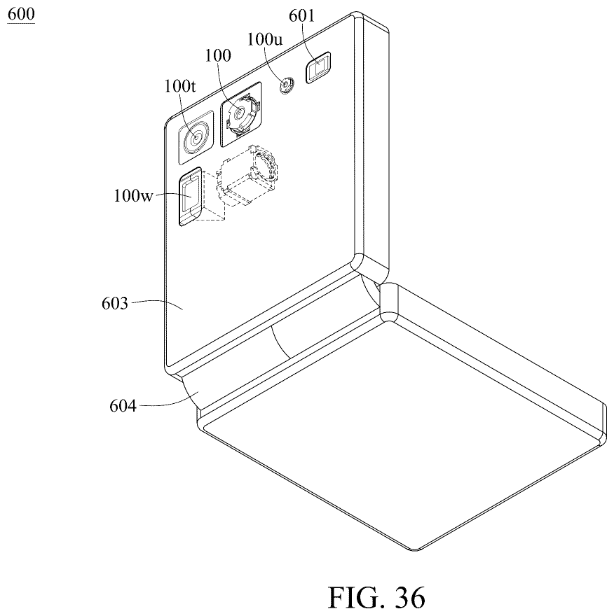

FIG. 35 is a perspective view of an electronic device according to the 19th embodiment of the present disclosure, and FIG. 36 is another perspective view of the electronic device in FIG. 35.

In this embodiment, the electronic device 600 is a foldable phone including the image capturing unit 100 as disclosed in the 14th embodiment, an image capturing unit 100t, an image capturing unit 100u, an image capturing unit 100v, an image capturing unit 100w, a flash module 601, a display module 602, a display module 603 and a hinge mechanism 604. The display module 602 can include, for example, a flexible screen with an organic light-emitting diode (OLED) display, and the electronic device 600 can be unfolded or folded via the hinge mechanism 604. In this embodiment, the electronic device 600 includes two oppositely arranged display modules 602 and 603 as examples, but the present disclosure is not limited to the number and arrangement of display modules. In other embodiments, the number of display module of an electronic device may be only one, and the only one display module can, for example, include a flexible screen.

As shown in FIG. 35, the image capturing unit 100v and the display module 602 are disposed on the same side of the electronic device 600. As shown in FIG. 36, the image capturing unit 100, the image capturing unit 100t, the image capturing unit 100u, the image capturing unit 100w, the flash module 601 and the display module 603 are disposed on the opposite side of the electronic device 600. The image capturing unit 100v can be a front-facing camera of the electronic device 600 for taking selfies, but the present disclosure is not limited thereto. Furthermore, each of the image capturing units 100t, 100u, 100v and 100w can include the optical photographing system of the present disclosure and can have a configuration similar to that of the image capturing unit 100, and the details in this regard will not be provided again.

The image capturing unit 100 is a wide-angle image capturing unit, the image capturing unit 100w is a telephoto image capturing unit with optical path folding function, the image capturing unit 100t is an ultra-wide-angle image capturing unit, the image capturing unit 100u is a ToF image capturing unit, and the image capturing unit 100v is a wide-angle image capturing unit. In this embodiment, the image capturing units 100, 100t and 100w have different fields of view, such that the electronic device 600 can have various magnification ratios so as to meet the requirement of optical zoom functionality. Moreover, the light-folding configuration of the image capturing unit 100w can be similar to, for example, one of the structures shown in FIG. 48 to FIG. 50, which can be referred to foregoing descriptions corresponding to FIG. 48 to FIG. 50, and the details in this regard will not be provided again. In this embodiment, the electronic device 600 includes multiple image capturing units 100, 100t, 100u, 100v and 100w, but the present disclosure is not limited to the number and arrangement of image capturing units. When a user captures images of an object, the light rays converge in the image capturing unit 100, 100t, 100u or 100w to generate images, and the flash module 601 is activated for light supplement. Further, the subsequent processes are performed in a manner similar to the abovementioned embodiments, and the details in this regard will not be provided again.

### 20th Embodiment

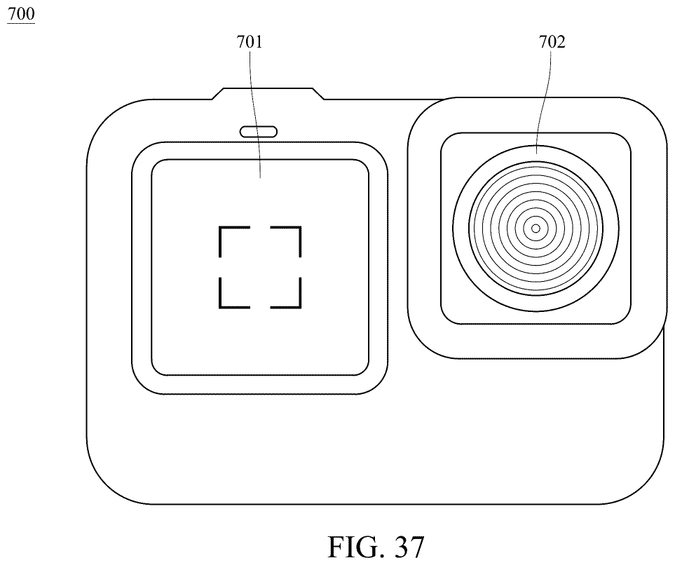

FIG. 37 is a schematic view of an electronic device according to the 20th embodiment of the present disclosure.

In this embodiment, an electronic device 700 may be a small-size camera, such as an action camera. The electronic device 700 includes a display unit 701 and an image capturing unit 702. The image capturing unit 702 is electrically connected to the display unit 701. The image capturing unit 702 includes the optical photographing system disclosed in the 1st embodiment. The image capturing unit 702 can be a wide-angle image capturing unit. The image capturing unit 702, which is similar to the image capturing unit 100, can further include a barrel, a holder member or a combination thereof. The electronic device 700 captures an image by the image capturing unit 702. Preferably, the electronic device may further include a control unit, a display unit, a storage unit, a random access memory unit (RAM) or a combination thereof.

### 21st Embodiment

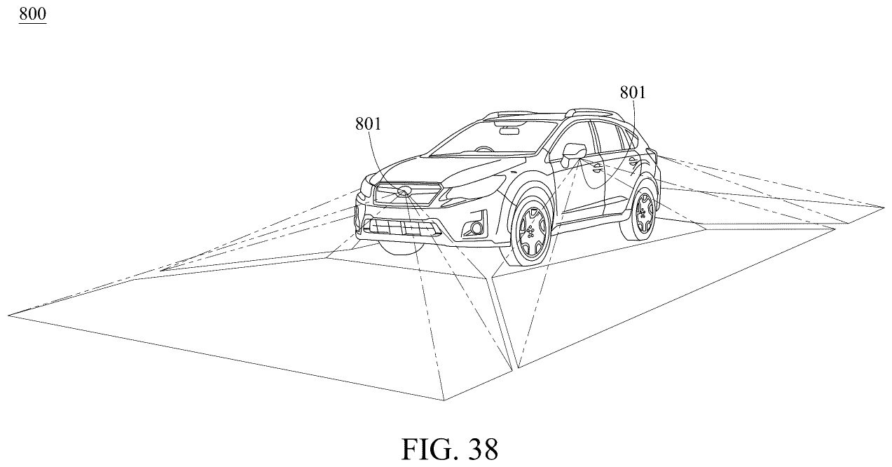

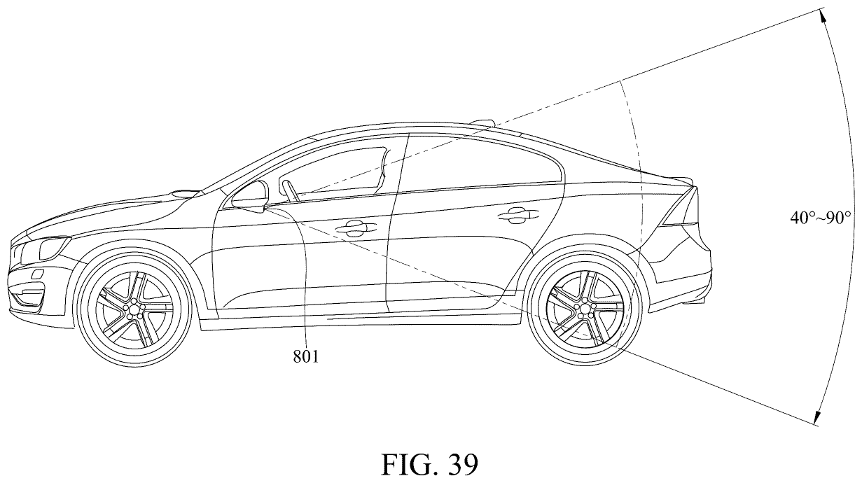

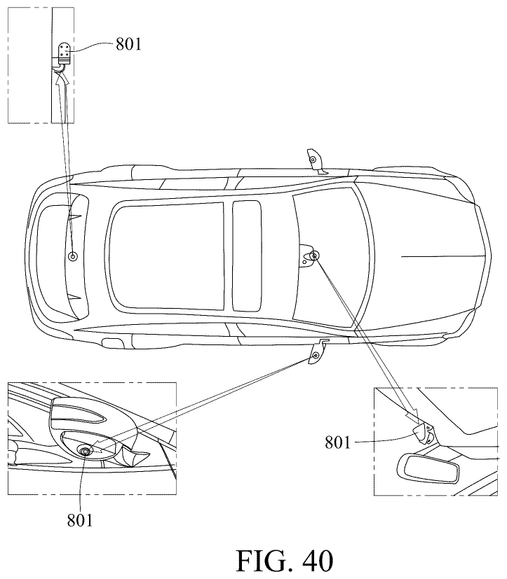

FIG. 38 is a perspective view of an electronic device according to the 21st embodiment of the present disclosure. FIG. 39 is a side view of the electronic device in FIG. 38. FIG. 40 is a top view of the electronic device in FIG. 38.

In this embodiment, an electronic device 800 is a mobile vehicle, such as a car. The electronic device 800 includes a plurality of image capturing units 801, and each of the image capturing units 801 includes, for example, the optical photographing system of the present disclosure. The image capturing units 801 can be served as, for example, panoramic view car cameras, dashboard cameras and vehicle backup cameras. The image capturing units 801 can be wide-angle image capturing units.

As shown in FIG. 38 to FIG. 40, the image capturing units 801 are, for example, disposed at the front side, the rear side, the lateral sides, inner side or on the backmirror of the car to capture peripheral images of the car, which is favorable for obtaining external traffic information so as to achieve an advanced driver-assistance function. In addition, the image software processor may stitch the peripheral images into one panoramic view image for the driver's checking every corner surrounding the car, thereby assisting in parking and driving.

As shown in FIG. 39, the image capturing units 801 are, for example, disposed on the lower portion of the side mirrors for capturing image information of the left and right lanes. As shown in FIG. 40, the image capturing units 801 can also be, for example, disposed on the lower portion of the side mirrors and inside the front and rear windshields for providing external information to the driver, and also providing more viewing angles so as to reduce blind spots, thereby improving driving safety. Please be noted the arrangement of the image capturing units 801 in the drawings is only exemplary, and the number, the positions and the image capturing directions of the image capturing units 801 can be adjusted according to actual requirements.

### 22nd Embodiment

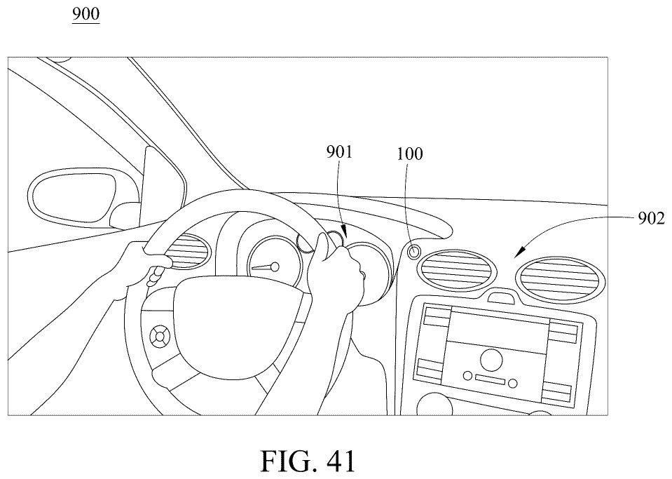

FIG. 41 is a partial view of an inner side of a vehicle device according to the 22nd embodiment of the present disclosure.

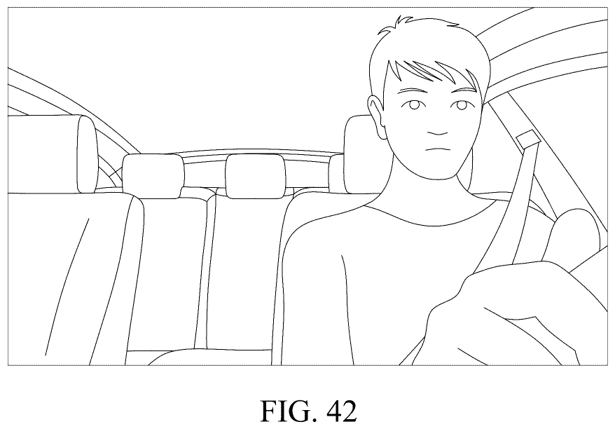

In this embodiment, the vehicle device 900 is an automobile. The vehicle device 900 includes the image capturing unit 100 disclosed in the 14th embodiment. The image capturing unit 100 is disposed adjacent to the dashboard 901 or center console 902 of the vehicle device 900, but the present disclosure is not limited thereto. The image capturing unit 100 can be used as a sensing lens towards the driver for being applied in a driver monitoring system, thereby detecting the driver's sobriety by determining the driver's gaze and blink or checking the driver's yawn and head position through the infrared lens. The image detected by the image capturing unit 100 can refer to FIG. 42, which is a schematic view showing the image captured by the image capturing unit of the vehicle device in FIG. 41 when processing its detection function. Therefore, it is favorable for detecting whether the driver is distracted, tired, dozing off or other dangerous driving, thereby sending a signal to the reminder or alarm (not shown) in the vehicle device 900 or a management system (not shown) in communication connection with the vehicle device 900.

### 23rd Embodiment

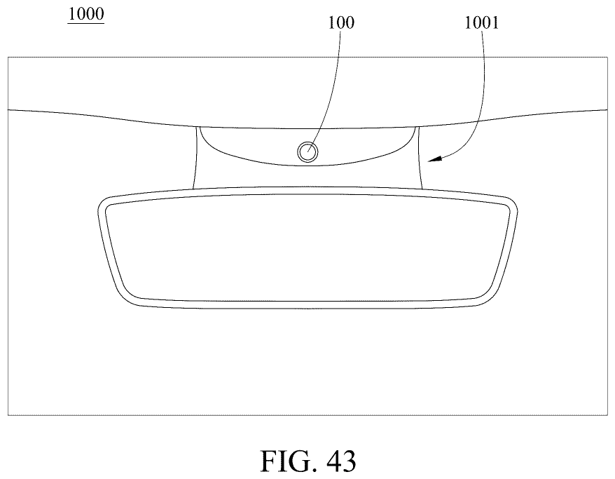

FIG. 43 is a partial view of an inner side of a vehicle device according to the 23rd embodiment of the present disclosure.

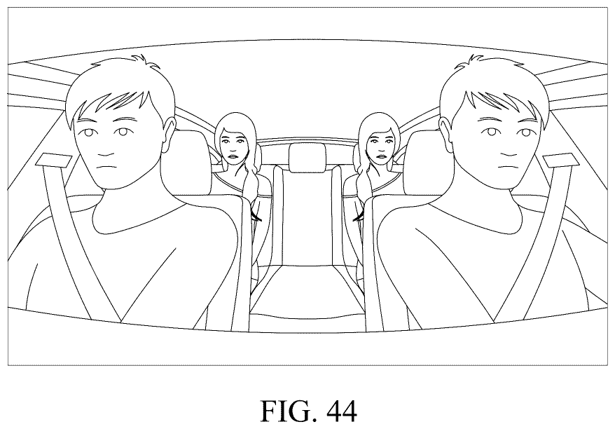

In this embodiment, the vehicle device 1000 is an automobile. The vehicle device 1000 includes the image capturing unit 100 disclosed in the 14th embodiment. The image capturing unit 100 is disposed adjacent to the rear-view mirror 1001 or center console (not shown) of the vehicle device 1000, but the present disclosure is not limited thereto. The image capturing unit 100 can be used as a sensing lens towards the inner side of the vehicle device 1000 so as to be applied to an occupancy monitoring system (OMS) for determining passenger's situations (especially child's behavior) at back seats based on images, thereby ensuring driving safety. The image determination for passenger's situation can be processed by using visible light in bright environment or infrared light in dark environment. The image capturing unit 100 can also be designed to determine people or objects in the vehicle device 1000, such as children, mobile phones or luggage after the car door is opened. By doing so, the management system (not shown) in communication connection with the vehicle device 1000 can be informed or the car windows of the vehicle device 1000 can be rolled down when the image capturing unit 100 determines only a child is stayed in the vehicle device 1000, thereby preventing the risk of heat stroke for the child. Or, the management system in communication connection with the vehicle device 1000 can be informed when the image capturing unit 100 determines lost items or luggage in the vehicle device 1000, thereby reducing time cost of the owner for finding the list items or luggage. The image detected by the image capturing unit 100 can refer to FIG. 44, which is a schematic view showing the image captured by the image capturing unit of the vehicle device in FIG. 43 when processing its detection function. Therefore, it is favorable for detecting the states of the people (may include the driver and passengers) or the objects in the vehicle device 1000, such as the driver's sobriety, the passenger's gender, whether the seat belt is fastened, whether a child is stayed in the vehicle device 1000, whether conflict is happened between the driver and passengers, other situation affecting normal driving, or whether lost items or luggage are left in the vehicle device 1000, thereby sending a signal to the storage device (not shown) in the vehicle device 1000 or the management system (not shown) in communication connection with the vehicle device 1000.

Furthermore, the electronic device or the vehicle device according to the present disclosure can further include a temperature sensor (not shown) disposed adjacent to the image capturing unit for adjusting the focus of the lens based on the ambient temperature. Alternatively, the electronic device or the vehicle device according to the present disclosure can further include a heat dissipation mechanism disposed on the image capturing unit for preventing poor image quality due to the overheated image capturing unit. Note that the abovementioned heat dissipation mechanism can be a coating layer of high heat dissipation material such as diamond like carbon or graphene, and the abovementioned heat dissipation mechanism can also be designed to have microstructure with a high heat dissipation area so as to effectively enhance the heat dissipation effect.

### 24th Embodiment

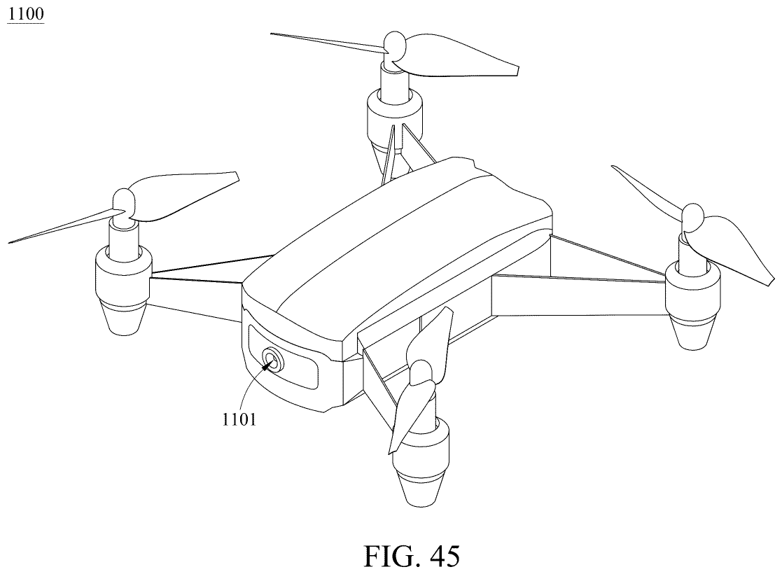

FIG. 45 is a schematic view of an electronic device according to the 24th embodiment of the present disclosure.

In this embodiment, an electronic device 1100 may be a lightweight unmanned aerial vehicle, such as a drone camera. The electronic device 1100 includes an image capturing unit 1101. The image capturing unit 1101 includes the optical photographing system disclosed in the 1st embodiment. The image capturing unit 1101 can be a wide-angle image capturing unit. The image capturing unit 1101, which is similar to the image capturing unit 100, can further include a barrel, a holder member or a combination thereof. The electronic device 1100 captures an image by the image capturing unit 1101. Preferably, the electronic device may further include a control unit, a display unit, a storage unit, a random access memory unit (RAM) or a combination thereof.

### 25th Embodiment

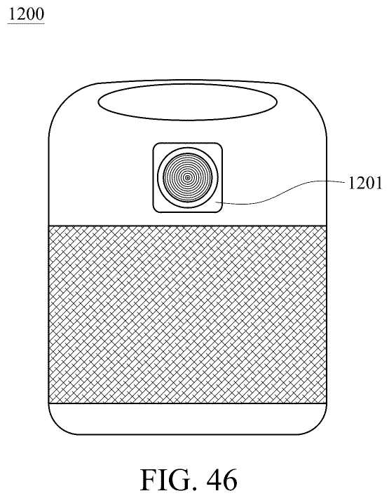

FIG. 46 is a schematic view of an electronic device according to the 25th embodiment of the present disclosure.

In this embodiment, an electronic device 1200 may be a sound box, such as a smart speaker. The electronic device 1200 includes an image capturing unit 1201. The image capturing unit 1201 includes the optical photographing system disclosed in the 1st embodiment. The image capturing unit 1201 can be a wide-angle image capturing unit. The image capturing unit 1201, which is similar to the image capturing unit 100, can further include a barrel, a holder member or a combination thereof. The electronic device 1200 captures an image by the image capturing unit 1201. Preferably, the electronic device may further include a control unit, a display unit, a storage unit, a random access memory unit (RAM) or a combination thereof.

The smartphone, camera, mobile vehicle, vehicle device, unmanned aerial vehicle and sound box in several embodiments are only exemplary for showing the image capturing unit of the present disclosure installed in an electronic device, and the present disclosure is not limited thereto. The image capturing unit can be optionally applied to optical systems with a movable focus. Furthermore, the optical photographing system of the image capturing unit features good capability in aberration corrections and high image quality, and can be applied to 3D (three-dimensional) image capturing applications, in products such as digital cameras, mobile devices, digital tablets, smart televisions, network surveillance devices, motion sensing input devices, dashboard cameras, vehicle backup cameras, multi-camera devices, image recognition systems, robots, notebook computers, 3D webcameras, action cameras, wearable devices, drone cameras and other electronic imaging devices.

The foregoing description, for the purpose of explanation, has been described with reference to specific embodiments. It is to be noted that TABLES 1A-13C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical photographing system comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has negative refractive power, the second lens element has positive refractive power, the third lens element has positive refractive power, the fourth lens element has negative refractive power, the object-side surface of the sixth lens element is convex in a paraxial region thereof, the image-side surface of the sixth lens element is concave in a paraxial region thereof, at least one of the object-side surface and the image-side surface of the fourth lens element has at least one inflection point, the object-side surface of the sixth lens element has at least one inflection point, and the image-side surface of the sixth lens element has at least one critical point in an off-axis region thereof;
wherein a central thickness of the first lens element is CT1, a central thickness of the second lens element is CT2, a central thickness of the third lens element is CT3, a central thickness of the fourth lens element is CT4, a central thickness of the fifth lens element is CT5, an axial distance between the fourth lens element and the fifth lens element is T45, an axial distance between the fifth lens element and the sixth lens element is T56, a focal length of the optical photographing system is f, half of a maximum field of view of the optical photographing system is HFOV, a composite focal length of the second lens element and the third lens element is f23, and the following conditions are satisfied:
1.20<(CT1+CT2)/(CT3+CT4)<2.00;
0.10<CT5/(T45+T56)<0.45; and
0.50<f×tan(HFOV)/f23<2.50.

2. The optical photographing system of claim 1, wherein the composite focal length of the second lens element and the third lens element is f23, a composite focal length of the fifth lens element and the sixth lens element is f56, and the following condition is satisfied:
−0.35<f23/f56<0.35.

3. The optical photographing system of claim 1, wherein the focal length of the optical photographing system is f, half of the maximum field of view of the optical photographing system is HFOV, a maximum image height of the optical photographing system is ImgH, and the following condition is satisfied:
0.50<f×sin(HFOV)/ImgH<0.75.

4. The optical photographing system of claim 1, wherein the focal length of the optical photographing system is f, the composite focal length of the second lens element and the third lens element is f23, and the following condition is satisfied:
1.20<f/f23<1.90.

5. The optical photographing system of claim 1, wherein the focal length of the optical photographing system is f, a composite focal length of the fifth lens element and the sixth lens element is f56, and the following condition is satisfied:

|f/f56|<0.80.

6. The optical photographing system of claim 1, wherein an axial distance between the object-side surface of the third lens element and the image-side surface of the fourth lens element is Dr5r8, a focal length of the third lens element is f3, and the following condition is satisfied:
0.01<Dr5r8/f3<0.40.

7. The optical photographing system of claim 1, wherein the object-side surface of the first lens element is concave in a paraxial region thereof, the image-side surface of the first lens element is concave in a paraxial region thereof, the object-side surface of the fourth lens element is convex in a paraxial region thereof, and the image-side surface of the fourth lens element is concave in a paraxial region thereof.

8. The optical photographing system of claim 1, wherein the object-side surface of the second lens element is convex in a paraxial region thereof, the image-side surface of the second lens element is convex in a paraxial region thereof, the object-side surface of the third lens element is convex in a paraxial region thereof, and the image-side surface of the third lens element is convex in a paraxial region thereof.

9. The optical photographing system of claim 1, further comprising an aperture stop disposed between the second lens element and the third lens element.

10. The optical photographing system of claim 1, wherein refractive power of the fifth lens element has a different sign from refractive power of the sixth lens element.

11. The optical photographing system of claim 1, wherein half of the maximum field of view of the optical photographing system is HFOV, and the following condition is satisfied:
42.5 degrees<HFOV<57.5 degrees.

12. An image capturing unit comprising:
the optical photographing system of claim 1; and
an image sensor disposed on an image surface of the optical photographing system.

13. An optical photographing system comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has negative refractive power, the second lens element has positive refractive power, the third lens element has positive refractive power, the fourth lens element has negative refractive power, the object-side surface of the sixth lens element is convex in a paraxial region thereof, the image-side surface of the sixth lens element is concave in a paraxial region thereof, at least one of the object-side surface and the image-side surface of the fourth lens element has at least one inflection point, the object-side surface of the sixth lens element has at least one inflection point, and the image-side surface of the sixth lens element has at least one critical point in an off-axis region thereof;
wherein a central thickness of the first lens element is CT1, a central thickness of the second lens element is CT2, a central thickness of the third lens element is CT3, a central thickness of the fourth lens element is CT4, a central thickness of the fifth lens element is CT5, a central thickness of the sixth lens element is CT6, an axial distance between the fourth lens element and the fifth lens element is T45, an axial distance between the fifth lens element and the sixth lens element is T56, a focal length of the optical photographing system is f, half of a maximum field of view of the optical photographing system is HFOV, a composite focal length of the second lens element and the third lens element is f23, an Abbe number of the second lens element is V2, an Abbe number of the third lens element is V3, and the following conditions are satisfied:
1.20<(CT1+CT2)/(CT3+CT4)<2.00;
0.50<(CT4+CT5+CT6)/(T45+T56)<1.95;
0.80<f×tan(HFOV)/f23<2.50; and
100.0<V2+V3<165.0.

14. The optical photographing system of claim 13, wherein the axial distance between the fifth lens element and the sixth lens element is greater than the central thickness of the fifth lens element.

15. The optical photographing system of claim 13, wherein refractive power of the fifth lens element has a same sign as refractive power of the sixth lens element.

16. The optical photographing system of claim 13, wherein the focal length of the optical photographing system is f, a maximum image height of the optical photographing system is ImgH, and the following condition is satisfied:
0.70<f/ImgH<1.00.

17. The optical photographing system of claim 13, wherein an axial distance between the object-side surface of the first lens element and an image surface is TL, a maximum image height of the optical photographing system is ImgH, the focal length of the optical photographing system is f, and the following conditions are satisfied:
1.30<TL/ImgH<2.20; and
1.20<TL/f<2.30.

18. The optical photographing system of claim 13, wherein at least one of the first lens element, the second lens element and the third lens element is made of glass material.

19. The optical photographing system of claim 13, wherein the central thickness of the first lens element is CT1, the central thickness of the second lens element is CT2, the central thickness of the third lens element is CT3, the central thickness of the fourth lens element is CT4, the central thickness of the fifth lens element is CT5, the central thickness of the sixth lens element is CT6, the axial distance between the fourth lens element and the fifth lens element is T45, the axial distance between the fifth lens element and the sixth lens element is T56, the focal length of the optical photographing system is f, a focal length of the second lens element is f2, a focal length of the third lens element is f3, the composite focal length of the second lens element and the third lens element is f23, half of the maximum field of view of the optical photographing system is HFOV, the Abbe number of the second lens element is V2, the Abbe number of the third lens element is V3, a sum of axial distances between each of all adjacent lens elements of the optical photographing system is ΣAT, and at least one of the following conditions is satisfied:
1.30<(CT1+CT2)/(CT3+CT4)<1.80;
0.20<CT5/(T45+T56)<0.45;
1.00<f×tan(HFOV)/f23<2.30;
0.70<(CT4+CT5+CT6)/(T45+T56)<1.70;
110.0<V2+V3<130.0;
0.60<(CT5+CT6)/(T45+T56)<1.50;
0.50<f2/f3<1.30; and
0.50<Σ/f<1.00.

20. An optical photographing system comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has negative refractive power, the second lens element has positive refractive power, the third lens element has positive refractive power, the fourth lens element has negative refractive power, the image-side surface of the fourth lens element is concave in a paraxial region thereof, the object-side surface of the sixth lens element is convex in a paraxial region thereof, the image-side surface of the sixth lens element is concave in a paraxial region thereof, at least one of the object-side surface and the image-side surface of the fourth lens element has at least one inflection point, the object-side surface of the sixth lens element has at least one inflection point, and the image-side surface of the sixth lens element has at least one critical point in an off-axis region thereof;
wherein a central thickness of the first lens element is CT1, a central thickness of the second lens element is CT2, a central thickness of the third lens element is CT3, a central thickness of the fourth lens element is CT4, a central thickness of the fifth lens element is CT5, a central thickness of the sixth lens element is CT6, an axial distance between the fourth lens element and the fifth lens element is T45, an axial distance between the fifth lens element and the sixth lens element is T56, a focal length of the optical photographing system is f, a focal length of the second lens element is f2, a focal length of the third lens element is f3, a sum of axial distances between each of all adjacent lens elements of the optical photographing system is ΣAT, and the following conditions are satisfied:
1.05<(CT1+CT2)/(CT3+CT4)<2.00;
0.63<(CT5+CT6)/(T45+T56)<1.80;
0.10<f2/f3<2.30; and
0.45<ΣAT/f<1.05.

21. The optical photographing system of claim 20, wherein an axial distance between the first lens element and the second lens element is greater than the central thickness of the second lens element.

22. The optical photographing system of claim 20, wherein the focal length of the second lens element is f2, the central thickness of the second lens element is CT2, and the following condition is satisfied:
2.80<f2/CT2<6.00.

23. The optical photographing system of claim 20, wherein a sum of central thicknesses of all lens elements of the optical photographing system is ΣCT, the focal length of the optical photographing system is f, and the following condition is satisfied:
0.80<ΣCT/f<1.40.

24. The optical photographing system of claim 20, the focal length of the optical photographing system is f, the focal length of the third lens element is f3, a composite focal length of the second lens element and the third lens element is f23, a curvature radius of the object-side surface of the third lens element is R5, and the following conditions are satisfied:

|f3/R5|<3.00; and
1.30<f/f23<1.80.

25. An electronic device comprising:
an image capturing unit comprising:
the optical photographing system of claim 20; and
an image sensor disposed on an image surface of the optical photographing system.

26. The optical photographing system of claim 20, wherein the central thickness of the first lens element is CT1, the central thickness of the second lens element is CT2, the central thickness of the third lens element is CT3, the central thickness of the fourth lens element is CT4, the central thickness of the fifth lens element is CT5, the central thickness of the sixth lens element is CT6, the axial distance between the fourth lens element and the fifth lens element is T45, the axial distance between the fifth lens element and the sixth lens element is T56, the focal length of the optical photographing system is f, the focal length of the second lens element is f2, the focal length of the third lens element is f3, a composite focal length of the second lens element and the third lens element is f23, half of a maximum field of view of the optical photographing system is HFOV, an Abbe number of the second lens element is V2, an Abbe number of the third lens element is V3, the sum of axial distances between each of all adjacent lens elements of the optical photographing system is ΣAT, and the following conditions are satisfied:
1.13≤(CT1+CT2)/(CT3+CT4)≤1.89;
0.24≤CT5/(T45+T56)≤0.82;
1.29≤f×tan(HFOV)/f23≤2.13;
0.77≤(CT4+CT5+CT6)/(T45+T56)≤1.89;
112.0≤V2+V3≤163.1;
0.64≤(CT5+CT6)/(T45+T56)≤1.66;
0.19≤f2/f3≤1.68; and
0.51≤ΣAT/f≤0.95.
